(19) United States
(12) Patent Application Publication
(10) Pub. No.: US 2014/0296181 A1
(43) Pub. Date: Oct. 2, 2014

(54) METHODS OF MODULATING ONCOGENIC FUSION PROTEINS

(71) Applicants: Lee Daniel Arnold, Mount Sinai, NY (US); Kenneth W. Foreman, Syosset, NY (US)

(72) Inventors: Lee Daniel Arnold, Mount Sinai, NY (US); Kenneth W. Foreman, Syosset, NY (US)

(73) Assignee: Coferon, Inc., New York, NY (US)

(21) Appl. No.: 14/110,293

(22) PCT Filed: Apr. 9, 2012
(86) PCT No.: PCT/US12/32811

§ 371 Date: May 15, 2014

Related U.S. Application Data
(60) Provisional application No. 61/473,074, filed on Apr. 7, 2011.

(51) Int. Cl. C07F 5/02; C07F 7/02

(52) U.S. Cl. CPC C07F 5/025; C07F 7/02
USPC 514/63; 530/410; 435/188; 514/64; 530/409

(57) ABSTRACT

Described herein, at least in part, are methods of modulating oncogenic fusion proteins.

### CROSS-REFERENCE TO RELATED APPLICATIONS

This application claims priority to U.S. Provisional Application No. 61/473,074, filed Apr. 7, 2011, which is hereby incorporated by reference in its entirety.

### BACKGROUND

Current drug design and drug therapies have not addressed the urgent need for therapies that interact with extended areas or multiple domains of biomolecules such as proteins. As an example, there is an urgent need for therapies that are capable of, modulating protein-protein interactions by modulating, simultaneously, two separate domains, be it both on a single protein or on separate proteins. There is also an urgent need for such therapies that modulate fusion proteins, such as those that occur in cancer.

Chromosomal translocations are a major genetic aberration in cancers such as leukemias, lymphomas, and sarcomas, and are also being found with increasing frequency in carcinomas. Such translocations encode long sequences which generate a unique fusion protein, that typically features meaningful tertiary structures. Such fusion proteins are heterogenous in sequence and structure, may contain only a few dispersed domains that are usually preserved in translocation, and contain long uncharacterized regions. Such fusion proteins, while losing significant portions of each of the original proteins can acquire new oncogenic functions either through combination of the activities of the remaining domains or loss of function or regulation from the deletion of domains.

Disorder in such fusion proteins typically is significantly higher in the vicinity of the breakpoint, and the disorder in oncogenic fusion proteins may play a pivotal role in the acquired oncogenic function, by e.g., bringing distant/disparate fusion segments together, enabling new or novel intra- and/or inter-molecular interactions. For example, the BRD4-NUT fusion oncogene protein (Genebank Accession #AAO22237.1) has been identified as occurring in patients with highly lethal midline carcinoma.

Current drug design and drug therapy approaches do not address the urgent need for drugs that are capable of modulating such oncogenic fusion proteins. Previous attempts to link, e.g., two pharmacophores that each interact with different protein domains have focused on large covalently linked compounds typically generated in organic solvents. These assemblies typically have a molecular weight too large for oral administration or effective cellular and tissue permeation. Antibodies may have potential for such therapy but are typically too large to be taken orally or to enter cells. There is an urgent need for therapies that target oncogenic protein fusions that can be administered to patients suffering from cancers caused by such genetic anomolies.

For example, there is a specific need for molecules containing boron or ¹⁰B, that are capable of binding to a oncogenic fusion protein or other protein associated with e.g. cancer, for use in boron neutron capture therapy (BNCT), an experimental form of radiotherapy that uses a neutron beam that interacts with compounds which contain boron-10 and which were administered to a patient. BNCT depends on the interaction of slow neutrons with ¹⁰B to produce alpha particles and lithium nuclei, without producing other types of ionizing radiation. While passing through the tissue of the patient, the neutrons are slowed by collisions and become low energy thermal neutrons, and the thermal neutrons undergo reaction with a boron-10 nuclei present in the patient, forming a compound nucleus (excited ¹¹boron) which then promptly disintegrates to ⁷Li and an alpha particle. Both the alpha particle and the lithium ion produce closely spaced ionizations in the immediate vicinity of the reaction, with a range of approximately 5-9 micrometres, or roughly the thickness of one cell diameter. Thus radiation damage occurs over a short range and normal tissues can be largely spared.

### SUMMARY

Provided herein, in an embodiment, is a method of modulating a fusion gene product (e.g. a fusion protein) having a first segment, a second segment, and, if a fusion protein, an interface segment, the method comprising contacting an aqueous composition comprising said fusion gene product with a first monomer capable of binding to the first segment (e.g. a first protein domain in said first segment); and a second monomer capable of binding to the second segment (e.g. a second protein domain in said second segment), or capable of binding to the interface segment; wherein said first monomer and second monomer form a multimer that binds to said fusion gene product.

In an embodiment, methods are provided herein for treating a solid tumor cancer or hematologic cancers in a patient in need thereof, comprising administering disclosed monomers.

Also provided herein is a method of treating a patient having a cancer treatable by boron neutron capture therapy comprising administering to said patient a first monomer and a second monomer, wherein the first monomer is represented by X₁—Y₁—Z₁ (Formula I) and pharmaceutically acceptable salts, stereoisomers, metabolites and hydrates thereof, wherein
X₁ is a first non-peptidyl pharmacophore capable of binding to a first biomolecule segment (e.g. a target protein segment);
Y₁ is absent or is a connector moiety covalently bound to X₁ and Z₁;
Z₁ is a first linker capable of binding to a second monomer; and the second monomer is represented by:

X₂—Y₂—Z₂ (Formula II)
wherein
X₂ is a second non-peptidyl pharmacophore capable of binding to a second biomolecule segment (e.g., a target protein domain);
Y₂ is absent or is a connector moiety covalently bound to X₂ and Z₂
Z₂ is a first linker is a boronic acid or oxaborole moiety having a ¹⁰B isotope, and capable of binding with the Z₁ moiety of Formula I; wherein upon administration, said first monomer and said second monomer forms a multimer in vivo that binds to the first biomolecule segment (e.g. the first protein domain) and the second biomolecule segment (e.g. second protein domain); and administering a neutron beam to the patient thereby interacting a thermal neutron with the ¹⁰B isotope.

### DETAILED DESCRIPTION

A method of modulating a fusion protein, e.g., an oncongene fusion protein having a first segment, a second segment, and an interface segment is provided comprising: contacting an aqueous composition comprising said fusion protein (e.g. an aqueous composition with a physiological pH) with: a first monomer capable of binding a first protein domain in said first segment; and a second monomer capable of binding a second protein domain in said second segment or capable of binding to the interface segment; wherein said first monomer and second monomer (together or with other monomers) form a multimer that binds to said fusion protein. Such method may further include contacting the aqueous composition with a plurality of monomers each capable of binding to a protein domain in the first segment or second segment, or to the interface segment in the fusion protein, and wherein the plurality of monomers form a multimer that binds to two, three, or more segments of said fusion protein. It will be appreciated that the first segment and second segment may be, in some embodiments, on two different protein sequences that form the fusion protein, in other embodiments, the first or second segment may both be on one sequence that forms the fusion protein.

In some embodiments, a contemplated first monomer having a linker that is e.g., capable of binding to another monomer with a different linker (e.g., to form a heterodimer or heteromultimer), or capable of binding to another monomer with the same linker (e.g., to form a homodimer or a homomultimer) can be represented by:

X₁—Y₁—Z₁ (Formula I)
and pharmaceutically acceptable salts, stereoisomers, metabolites and hydrates thereof, wherein
X₁ is a first non-peptidyl or peptidyl pharmacophore capable of binding to the first segment;
Y₁ is absent or is a connector moiety covalently bound to X₁ and Z₁;
Z₁ is a first linker capable of binding to the second monomer. For example, the second monomer can be represented by:

X₂—Y₂—Z₂ (Formula II)
wherein
X₂ is a second non-peptidyl or peptidyl pharmacophore capable of binding to the second segment;
Y₂ is absent or is a connector moiety covalently bound to X₂ and Z₂.
Z₂ is a first linker capable of binding to the first monomer through Z₁;

wherein upon contact with the aqueous composition, said first monomer and said second monomer both form an equilibrium with a multimer and binds to the fusion protein.

In an embodiment, Z₁ and Z₂ are the same. In another embodiment, Z₁ and Z₂ are different. In an embodiment, Y₁ and Y₂ are the same. In another embodiment, Y₁ and Y₂ are different. In an embodiment, X₁ and X₂ are the same. In another embodiment, X₁ and X₂ are different.

Also contemplated herein are 1 to 4 first monomers, 1 to 4 second monomers and a bridge monomer capable of forming a biologically useful multimer having at least three segments when the first monomer is in contact with the bridge monomer and when the bridge monomer is in contact with the second monomer in an aqueous media, wherein the first monomer is represented by:

X₁—Y₁—Z₁ (Formula I′)
and pharmaceutically acceptable salts, stereoisomers, metabolites and hydrates thereof, wherein
X₁ is a first non-peptidyl or peptidyl pharmacophore;
Y₁ is absent or is a connector moiety covalently bound to X₁ and Z₁;
Z₁ is a first linker capable of binding to the bridge monomer;
   the bridge monomer is represented by:

W₁—Y₃—W₂ (Formula II′)
wherein
W₁ is a second linker capable of binding to the first monomer through the Z₁ segment;
Y₃ is absent or is a connector moiety covalently bound to W₁ and W₂.
W₂ is a third linker capable of binding to the second monomer; and
   the second monomer is represented by:

X₂—Y₂—Z₂ (Formula III′)
wherein
X₂ is a second non-peptidyl pharmacophore;
Y₂ is absent or is a connector moiety covalently bound to X₂ and Z₂.
Z₂ is a fourth linker capable of binding to the bride monomer through W₂; and

wherein upon contact with the aqueous composition, said first monomer, second monomer and bridge monomer together form a multimer and bind to a target fusion gene product, e.g. a fusion protein.

Also provided herein are such “bridge” multimers formed from the monomers formed from Formula III′. For example, X₁ of formula I′ may bind to a first biomolecule segment (e.g. a domain on a fusion protein) and X₂ of formula II′ may bind to a second biomolecule segment (e.g. a domain on a fusion protein).

For example, described herein are monomers capable of forming a biologically useful multimer when in contact with one, two, three or more other monomers in an aqueous media. In one aspect, such monomers may be capable of binding to another monomer in an aqueous media (e.g. in vivo) to form a multimer, (e.g., a dimer). Contemplated monomers may include a functional element (e.g., a ligand or pharmacophore moiety), a linker element, and a connector element that joins the functional element and the linker element. In an aqueous media (e.g at a physiological pH), such contemplated monomers may join together via each linker element and may thus be capable of modulating one or more biomolecules substantially simultaneously, e.g., modulate two or more binding domains on a protein or on different proteins. For example, contemplated monomers may be separate or separatable in a solid or in an aqueous media under one set of conditions, and when placed in an aqueous media that includes one or more biomolecules, with another monomer (and/or e.g., under a different set of conditions), can 1) form a multimer through the linker on each monomer; and either: 2a) bind to the biomolecule (e.g. a protein fusion) in two or more locations (e.g. protein domains) through each functional element of the respective monomer or 2b) bind to two or more biomolecules through each functional element of the respective monomer. In an exemplary embodiment, disclosed monomers may interact with another appropriate monomer (i.e. a monomeric pair) in an aqueous media (e.g., in vivo) to form a multimer (e.g. a dimer) that can bind to two separate biomolecular domains (e.g. protein domains).

Contemplated methods herein include methods of modulating a fusion gene product or fusion protein such as an oncology fusion protein, e.g., an oncogenic fusion protein having a first segment that may have first protein domain, a second segment that may have a second protein domain, and an interface segment (which may in some embodiments, include a significantly disordered portion). For example, such oncology fusion proteins may be expressed by a fused gene from a chromosomal translocation, inversion, or interstitial deletion.

For example, contemplated herein are methods of modulating an oncology fusion protein that comprises a tyrosine kinase domain, e.g. comprising one or more steps described above. A contemplated oncology fusion protein may include, for example, a phosphorylation motif, a tyrosine kinase domain, and a disordered region, or for example, a dimerization domain, a tyrosine kinase domain, and a disordered region. In some embodiments, a method is provided for modulating an oncology fusion protein that comprises a DNA binding element, and a transactivator domain.

For example, in some embodiments, the X₁ moiety of a first monomer, as in e.g., Formula I, is capable of binding (or binds) to a tyrosine kinase protein domain in a protein selected from the group consisting of ABL1, ABL2, ALK, hepatocyte growth factor receptor, JAK2, JAK3, JAK1, ROS1, PDGFR, NTRK, SYK, BRAF, RET, and fibroblast growth factor receptor, and/or the X₂ moiety of Formula II may be capable of binding to (or binds to) a dimerization domain in a protein selected from the group consisting of BCR, NPM, EML4, TPR, TEL, AFT1, EWS, FLI1, MLL, CBP, p300, ENL, FGFR1OP2, ETS, BIRC3, MALT1, FOXO1a, GOPC, PAX, ECPT1, NCOA1, FUS, NUP98, RARA, BRD, AML1, AF9, AF4, ETO, NUT, CEP1, TFE3, WT1, PRCC, CCDC6, KIAA14549, HOX, PML, and RUNX1.

Methods of modulating oncology fusion proteins include methods of modulation oncology fusion proteins selected, e.g., from the group consisting of BCR-ABL, NPM-ALK, EML4-ALK, TRP-MET, TFG-ALK, TEL-JAK2, EWS-ATF1, MLL-CBP, MLL-ENL, IRC3-MALT1, CD74-ROS1, EWS-ETS, TEL-NTRK3, TEL-RUNX1, FGFR1-ZNF198, FOXO1A-PAX3, GOPC-ROS1, CEP1-FGFR1, NCOA1-PAX3, MLL-p300, MLL-AF9, MLL-AF4, EWS-FLI1, FUS-ATF1, FUS-ERG, BRD-NUT, TFE3-PRCC, AML1-ETO, EWS-WT1, CCDC6-RET, BRAF-KIAA1549, NUP98-HOX, and RARA-PML.

For example, a method is provided for modulating BCR-ABL, wherein X₁ binds to, for example, a Tyr-kinase phosphorylation motif of BCR, and X₂ binds to, for example, a tyr kinase domain of ABL. In another embodiment, a method is provided for modulating an oncology fusion protein selected from the group consisting of TFG-ALK, TPR-MET, TEL-JAK2, NPM-ALK, and EML4-ALK, wherein X₁ of Formula I binds to a dimerization domain motif of the N-terminal portion of the fusion protein, and X₂ of Formual II binds to a tyr kinase domain of the C-terminal portion of the fusion protein.

In another embodiment, a method is provided for modulating EML4-ALK, and X₁ of Formula I for example binds to a HELP or WD domain of EML4, and X₂ of Formula II for example binds to a tyr kinase domain of ALK. Alternatively, a method for modulating EWS-ATF, is provided wherein X₁ binds to for example an EWS activation domain of EWS, and X₂ for example binds to a DNA binding region of ATF.

In some embodiments, the oncology fusion protein is a MLL fusion product, for example, MLL-CBP, MLL-CBL, MLL-AF9, or MLL-AF4. For example, X₁ may bind in some embodiments to a DNA-binding domain, an AT-hook motif, or a DNA methyl transferase homology region of MLL.

In an embodiment, the first or second component of the oncology fusion gene may be selected from the group consisting of ABL1, ABL2, ACSL3, ADRBK2, AF15Q14, AF1Q, AF3p21, AF5q31, AKAP9, AKT1, AKT2, ALDH2, ALK, ALO17, APC, ARHGEF12, ARHH, ARID1A, ARNT, ASPSCR1, ASXL1, ATF1, ATIC, ATM, ATRX, BAP1, BCL10, BCL11A, BCL11B, BCL2, BCL3, BCL5, BCL6, BCL7A, BCL9, BCR, BHD, BIRC3, BLM, BMPR1A, BRAF, BRCA1, BRCA2, BRD3, BRD4, BRIP1, BTG1, BUB1B, C11orf95, C12orf9, C15orf21, C15orf55, C16orf75, CAMTA1, CANT1, CARD11, CARS, CBFA2T1, CBFA2T3, CBFB, CBL, CBLB, CBLC, CCNB11P1, CCND1, CCND2, CCND3, CD273, CD274, CD74, CD79A, CD79B, CDH1, CDH11, CDK4, CDK6, CDKN2A-p16(INK4a), CDKN2A-p14ARF, CDKN2C, CDX2, CEBPA, CEP1, CEP110, CHCHD7, CHEK2, CHIC2, CHN1, CIC, CIITA, CLTC, CLTCL1, CMKOR1, COL1A1, COPEB, COX6C, CREB1, CREB3L1, CREB3L2, CREBBP, CRLF2, CRTC3, CTNNB1, CYLD, D10S170, DAXX, DDB2, DDIT3, DDX10, DDX5, DDX6, DEK, DICER1, DNMT3A, DUX4, EBF1, EGFR, EIF4A2, ELF4, ELK4, ELKS, ELL, ELN, EML4, EP300, EPS15, ERBB2, ERCC2, ERCC3, ERCC4, ERCC5, ERG, ETV1, ETV2, ETV4, ETV5, ETV6, EVI1, EWSR1, EXT1, EXT2, EZH2, FACL6, FAM22, FANCA, FANCC, FANCD2, FANCE, FANCF, FANCG, FBXW7, FCGR2B, FEV, FGFR1, FGFR10P, FGFR2, FGFR3, FH, FHIT, FIP1L1, FKHR, FLI1, FLJ27352, FLT3, FNBP1, FOXL2, FOXO1A, FOXO3A, FOXP1, FSTL3, FUS, FVT1, FWS-CHOP, GAS7, GATA1, GATA2, GATA3, GMPS, GNA11, GNAQ, GNAS, GOLGA5, GOPC, GPC3, GPHN, GRAF, GSDNB, HCMOGT-1, HEAB, HEI10, HERPUD1, HIP1, HIST1H4I, HLF, HLXB9, HMGA1, HMGA2, HNRNPA2B1, HOOK3, HOXA11, HOXA13, HOXA9, HOXC11, HOXC13, HOXD11, HOXD13, HRAS, HRPT2, HSPCA, HSPCB, IDH1, IDH2, IGH@, IGK@, IGL@, IKZF1, IKZF3, IL2, IL21R, IL6ST, IRF4, IRTA1, ITK, JAK1, JAK2, JAK3, JARIDA1, JAZF1, JUN, KCNMA1, KDM5A, KDM5C, KDM6A, KDR, KIAA1524, KIAA1549, KIF5B, KIT, KLK2, KRAS, KTN1, LAF4, LASP1, LCK, LCP1, LCX, LHFP, LIFR, LMO1, LMO2, LPP, LYL1, MADH4, MAF, MAFB, MALT1, MAML2, MAP2K4, MDM2, MDM4, MDS1, MDS2, MECT1, MEN1, MET, MGEA5, MHC2TA, MITF, MKL1, MKL2, MLF1, MLH1, MLL, MLL2, MLL3, MLLT1, MLLT10, MLLT2, MLLT3, MLLT4, MLLT6, MLLT7, MN1, MPL, MSF, MSH2, MSH6, MSI2, MSN, MTCP1, MUC1, MUTYH, MYB, MYC, MYCL1, MYCN, MYD88, MYH11, MYH9, MYST4, NACA, NBS1, NCOA1, NCOA2, NCOA4, NF1, NF2, NFE2L2, NFIB, NFKB2, NIN, NKX2-1, NONO, NOTCH1, NOTCH2, NPM1, NR4A3, NRAS, NSD1, NTRK1, NTRK3, NUMA1, NUP214, NUP98, NUT, OLIG2, OMD, P2RY8, PAFAH1B2, PALB2, PAX3, PAX5, PAX7, PAX8, PBRM1, PBX1, PCM1, PCSK7, PDE4DIP, PDGFB, PDGFRA, PDGFRB, PER1, PHOX2B, PICALM, PIK3CA, PIK3R1, PIM1, PLAG1, PLZF, PML, PMS1, PMS2, PMX1, PNUTL1, POU2AF1, POU5F1, PPARG, PPP2R1A, PRCC, PRDM1, PRDM16, PRF1, PRKAR1A, PRO1073, PSIP2, PTCH, PTEN, PTPN11, RAB5EP, RAD51L1, RAF1, RALGDS, RANBP17, RAP1GDS1, RARA, RB1, RBM15, RECQL4, REL, RET, ROS1, RPL22, RPN1, RUNDC2A, RUNX1, RUNXBP2, SBDS, SDH5, SDHB, SDHC, SDHD, SEPT2, SEPT5, SEPT6, SEPT9, SEPT11, SET, SETD2, SFPQ, SFRS3, SFRS14, SH3GL1, SIL, SLC45A3, SMARCA4, SMARCA5, SMARCB1, SMO, SOCS1, SOX2, SRGAP3, SS18, SS18L1, SSH3BP1, SSX1, SSX2, SSX4, STK11, STL, SUFU, SUZ12, SYK, SYT, TAF15, TAL1, TAL2, TATDN1, TCEA1, TCF1, TCF7L2, TCF12, TCF3, TCL1A, TCL6, TET2, TFE3, TFEB, TFG, TFPT, TFRC, TGFBR3, THRAP3, TIF1, TLS, TLX1, TLX3, TMPRSS2, TNFAIP3, TNFRSF14, TNFRSF17, TNFRSF6, TOP1, TP53, TPM3, TPM4, TPR, TRA@, TRB@, TRD@, TRIM27, TRIM33, TRIP11, TSC1, TSC2, TSHR, TTL, USP6, USP42, VAPB, VHL, VTI1A, WAS, WHSC1, WHSC1L1, WIF1, WRN, WT1, WTX, WWC1, WWTR1, XPA, XPC, YWHAE, ZNF145, ZNF198, ZNF278, ZNF331, ZNF384, ZNF521, ZNF9, or ZNFN1A1, where the “@” represents the promoter to the listed gene.

For example, methods of modulating the resulting protein of an oncogene fusion protein is provided, wherein the resultant fusion protein is derived from the group of fusion genes consisting of BL1-BCR, BL1-ETV6, BL1-NUP214; ABL2-ETV6; ACSL3-ETV1; AF15Q14-MLL; AF1Q-MLL; AF3p21-MLL; AF5q31-MLL; AKAP9-BRAF; ALDH2-HMGA2; ALK-NPM1, ALK-TPM3, ALK-TFG, ALK-TPM4, ALK-ATIC, ALK-CLTC, ALK-MSN, ALK-ALO17, ALK-CARS, ALK-EML4; ALO17-ALK; ARHGEF12-MLL; ARHH-BCL6; ARNT-ETV6; ASPSCR1-TFE3; ATF1-EWSR1, ATF1-FUS; ATIC-ALK; BCL10-IGH@; BCL11A-IGH@; BCL11B-TLX3; BCL2-IGH@; BCL3-IGH@; BCL5-MYC; BCL6-IG loci, BCL6-ZNFN1A1, BCL6-LCP1, BCL6-PIM1, BCL6-TFRC, BCL6-MHC2TA, BCL6-NACA, BCL6-HSPCB, BCL6-HSPCA, BCL6-HIST1H4I, BCL6-IL21R, BCL6-POU2AF1, BCL6-ARHH, BCL6-EIF4A2, BCL6-SFRS3; BCL7A-MYC; BCL9-IGH@, IGL@; BCR-ABL1, FGFR1, JAK2; BIRC3-MALT1; BRAF-AKAP9, KIAA1549; BRD3-NUT, C15orf55; BRD4-NUT, C15orf55; BTG1-MYC; C12orf9-LPP; C15orf21-ETV1; C15orf55-BRD3, BRD4; C16orf75-CIITA; CANT1-ETV4; CARS-ALK; CBFA2T1-MLL, RUNX1; CBFA2T3-RUNX1; CBFB-MYH11; CBL-MLL; CCNB11P1-HMGA2; CCND1-IGH@, FSTL3; CCND2-IGL@; CCND3-IGH@; CD273-CIITA; CD274-CIITA; CD74-ROS1; CDH11-USP6; CDK6-MLLT10; CDX2-ETV6; CEP1-FGFR1; CHCHD7-PLAG1; CHIC2-ETV6; CHN1-TAF15; CIC-DUX4; CIITA-FLJ27352, CD274, CD273, RALGDS, RUNDC2A, C16orf75; CLTC-ALK, TFE3; CMKOR1-HMGA2; COL1A1-PDGFB, USP6; COX6C-HMGA2; CREB1-EWSR1; CREB3L1-FUS; CREB3L2-FUS; CREBBP-MLL, MORF, RUNXBP2; CRLF2-P2RY8, IGH@; CRTC3-MAML2; CTNNB 1-PLAG1; D10S170-RET, PDGFRB; DDIT3-FUS; DDX10-NUP98; DDX5-ETV4; DDX6-IGH@; DEK-NUP214; DUX4-CIC; EBF1-HMGA2; EIF4A2-BCL6; ELF4-ERG; ELK4-SLC45A3; ELKS-RET; ELL-MLL; ELN-PAX5; EML4-ALK; EP300-MLL, RUNXBP2; EPS15-MLL; ERG-EWSR1, TMPRSS2, ELF4, FUS, HERPUD1; ETV1-EWSR1, TMPRSS2, SLC45A3, C15orf21, HNRNPA2B1ACSL3; ETV4-EWSR1, TMPRSS2, DDX5, KLK2, CANT1; ETV5-TMPRSS2, SCL45A3; ETV6-NTRK3, RUNX1, PDGFRB, ABL1, MN1, ABL2, FACL6, CHIC2, ARNT, JAK2, EVI1, CDX2, STL, HLXB9, MDS2, PER1, SYK, TTL, FGFR3, PAX5; EVI1-RUNX1, ETV6, PRDM16, RPN1; EWSR1-FLI1, ERG, ZNF278, NR4A3, FEV, ATF1, ETV1, ETV4, WT1, ZNF384, CREB1, POU5F1, PBX1; FACL6-ETV6; FEV-EWSR1, FUS; FGFR1-BCR, FOP, ZNF198, CEP1; FGFR10P-FGFR1; FGFR3-IGH@, ETV6; FHIT-HMGA2; FIP1L1-PDGFRA; FLI1-EWSR1; FLJ27352-CIITA; FNBP1-MLL; FOXO1A-PAX3; FOXO3A-MLL; FOXP1-PAX5; FSTL3-CCND1; FUS-DDIT3, ERG, FEV, ATF1, CREB3L2, CREB3L1; FVT1-IGK@; GAS7-MLL; GMPS-MLL; GOLGA5-RET; GOPC-ROS1; GPHN-MLL; GRAF-MLL; HCMOGT-1-PDGFRB; HEAB-MLL; HEI10-HMGA2; HERPUD1-ERG; HIP1-PDGFRB; HIST1H4I-BCL6; HLF-TCF3; HLXB9-ETV6; HMGA2-LHFP, RAD51L1, LPP, HEI10, COX6C, CMKOR1, NFIB, ALDH2, CCNB11P1, EBF1, WIF1, FHIT; HNRNPA2B1-ETV1; HOOK3-RET; HOXA11-NUP98; HOXA13-NUP98; HOXA9-NUP98, MSI2; HOXC11-NUP98; HOXC13-NUP98; HOXD11-NUP98; HOXD13-NUP98; HSPCA-BCL6; HSPCB-BCL6; IGH@-MYC, FGFR3, PAX5, IRTA1, IRF4, CCND1, BCL9, BCL8, BCL6, BCL2, BCL3, BCL10, BCL11A. LHX4, DDX6, NFKB2, PAFAH1B2, PCSK7, CRLF2; IGK@-MYC, FVT1; IGL@-BCL9, MYC, CCND2; IL2-TNFRSF17; IL21R-BCL6; IRF4-IGH@; IRTA1-IGH@; ITK-SYK; JAK2-ETV6, PCM1, BCR; JAZF1-SUZ12; KDM5A-NUP98; KIAA1549-BRAF; KLK2-ETV4; KTN1-RET; LAF4-MLL, RUNX1; LASP1-MLL; LCK-TRB @; LCP1-BCL6; LCX-MLL; LHFP-HMGA2; LIFR-PLAG1; LMβ1-TRD @; LMO2-TRD@; LPP-HMGA2, MLL, C12orf9; LYL1-TRB@; MAF-IGH@; MAFB-IGH@; MALT1-BIRC3; MAML2-MECT1, CRTC3; MDS1-RUNX1; MDS2-ETV6; MECT1-MAML2; MHC2TA-BCL6; MKL1-RBM15; MLF1-NPM1; MLL-MLL, MLLT1, MLLT2, MLLT3, MLLT4, MLLT7, MLLT10, MLLT6, ELL, EPS15, AF1Q, CREBBP, SH3GL1, FNBP1, PNUTL1, MSF, GPHN, GMPS, SSH3BP1, ARHGEF12, GAS7, FOXO3A, LAF4, LCX, SEPT6, LPP, CBFA2T1, GRAF, EP300, PICALM, HEAB; MLLT1-MLL; MLLT10-MLL, PICALM, CDK6; MLLT2-MLL; MLLT3-MLL; MLLT4-MLL; MLLT6-MLL; MLLT7-MLL; MN1-ETV6; MSF-MLL; MSI2-HOXA9; MSN-ALK; MTCP1-TRA@; MUC1-IGH@; MYB-NFIB; MYC-IGK@, BCL5, BCL7A, BTG1, TRA@, IGH@; MYH11-CBFB; MYH9-ALK; MYST4-CREBBP; NACA-BCL6; NCOA1-PAX3; NCOA2-RUNXBP2; NCOA4-RET; NFIB-MYB, HGMA2; NFKB2-IGH@; NIN-PDGFRB; NONO-TFE3; NOTCH1-TRB@; NPM1-ALK, RARA, MLF1; NR4A3-EWSR1; NSD1-NUP98; NTRK1-TPM3, TPR, TFG; NTRK3-ETV6; NUMA1-RARA; NUP214-DEK, SET, ABL1; NUP98-HOXA9, NSD1, WHSC1L1, DDX10, TOP1, HOXD13, PMX1, HOXA13, HOXD11, HOXA11, RAP1GDS1, HOXC11; NUT-BRD4, BRD3; OLIG2-TRA@; OMD-USP6; P2RY8-CRLF2; PAFAH1B2-IGH@; PAX3-FOXO1A, NCOA1; PAX5-IGH@, ETV6, PML, FOXP1, ZNF521, ELN; PAX7-FOXO1A; PAX8-PPARG; PBX1-TCF3, EWSR1; PCM1-RET, JAK2; PCSK7-IGH@; PDE4DIP-PDGFRB; PDGFB-COL1A1; PDGFRA-FIP1L1; PDGFRB-ETV6, TRIP11, HIP1, RAB5EP, H4, NIN, HCMOGT-1, PDE4DIP; PER1-ETV6; PICALM-MLLT10, MLL; PIM1-BCL6; PLAG1-TCEA1, LIFR, CTNNB1, CHCHD7; PML-RARA, PAX5; PMX1-NUP98; PNUTL1-MLL; POU2AF1-BCL6; POU5F1-EWSR1; PPARG-PAX8; PRCC-TFE3; PRDM16-EVI1; PRKAR1A-RET; PRO1073-TFEB; PSIP2-NUP98; RAB5EP-PDGFRB; RAD51L1-HMGA2; RAF1-SRGAP3; RALGDS-CIITA; RANBP17-TRD@; RAP1GDS1-NUP98; RARA-PML, ZNF145, TIF1, NUMA1, NPM1; RBM15-MKL1; RET-H4, PRKAR1A, NCOA4, PCM1, GOLGA5, TRIM33, KTN1, TRIM27, HOOK3; ROS1-GOPC, ROS1; RPL22-RUNX1; RPN1-EVI1; RUNDC2A-CIITA; RUNX1-RPL22, MDS1, EVI1, CBFA2T3, CBFA2T1, ETV6, LAF4; RUNXBP2-CREBBP, NCOA2, EP300; SEPT6-MLL; SET-NUP214; SFPQ-TFE3; SFRS3-BCL6; SH3GL1-MLL; SIL-TAL1; SLC45A3-ETV1, ETV5, ELK4, ERG; SRGAP3-RAF1; SS18-SSX1, SSX2; SS18L1-SSX1; SSH3BP1-MLL; SSX1-SS18; SSX2-SS18; SSX4-SS18; STL-ETV6; SUZ12-JAZF1; SYK-ETV6, ITK; TAF15-TEC, CHN1, ZNF384; TAL1-TRD@, SIL; TAL2-TRB@; TCEA1-PLAG1; TCF12-TEC; TCF3-PBX1, HLF, TFPT; TCL1A-TRA@; TCL6-TRA@; TFE3-SFPQ, ASPSCR1, PRCC, NONO, CLTC; TFEB-ALPHA; TFG-NTRK1, ALK; TFPT-TCF3; TFRC-BCL6; THRAP3-USP6; TIF1-RARA; TLX1-TRB@, TRD@; TLX3-BCL11B; TMPRSS2-ERG, ETV1, ETV4, ETV5; TNFRSF17-IL2; TOP1-NUP98; TPM3-NTRK1, ALK; TPM4-ALK; TPR-NTRK1; TRA@-ATL, OLIG2, MYC, TCL1A, TCL6, MTCP1, TCL6; TRB@-HOX11, LCK, NOTCH1, TAL2, LYL1; TRD@-TAL1, HOX11, TLX1, LMO1, LMO2, RANBP17; TRIM27-RET; TRIM33-RET; TRIP11-PDGFRB; TTL-ETV6; USP6-COL1A1, CDH11, ZNF9, OMD; WHSC1-IGH@; WHSC1L1-NUP98; WIF1-HMGA2; WT1-EWSR1; ZNF145-RARA; ZNF198-FGFR1; ZNF278-EWSR1; ZNF384-EWSR1, TAF15; ZNF521-PAX5; ZNF9-USP6; and ZNFN1A1-BCL6 (wherein commas delineate alternate fusion parners for the first protein listed in the fusion pair given by the names separated by a dash).

For example, a method of modulating a fusion protein provided, wherein the fusion protein is selected from the group consisting of FIP1L1-PDGFR, CSB-PGBD3, or BRD-NUT.

Table I provides further specific embodiments of oncogenic fusion proteins that may be modulated using the disclosed methods. Further, as described below, this disclosure provides for methods of treating a specific cancer e.g. as indicated in Table 1 using a disclosed method that includes e.g. administering a monomer of Formula I and a monomer of Formula II to modulate the implicated oncogene fusion protein.

TABLE 1

| | Translocation | Tumor Types | |
|---|---|---|---|
| Symbol | Partner | (Somatic Mutations) | Cancer Syndrome |
| ABL1 | BCR, ETV6, | CML, ALL, T-ALL | |
| | NUP214 | | |
| ABL2 | ETV6 | AML | |
| ACSL3 | ETV1 | prostate | |
| AF15Q14 | MLL | AML | |
| AF1Q | MLL | ALL | |
| AF3p21 | MLL | ALL | |
| AF5q31 | MLL | ALL | |
| AKAP9 | BRAF | papillary thyroid | |
| AKT1 | | breast, colorectal, | |
| | | ovarian, NSCLC | |
| AKT2 | | ovarian, pancreatic | |
| ALDH2 | HMGA2 | leiomyoma | |
| ALK | NPM1, TPM3, | ALCL, NSCLC, | Familial |
| | TFG, TPM4, | Neuroblastoma | neuroblastoma |
| | ATIC, CLTC, | | |
| | MSN, ALO17, | | |
| | CARS, EML4 | | |
| ALO17 | ALK | ALCL | |
| APC | | colorectal, | Adenomatous |
| | | pancreatic, desmoid, | polyposis coli; |
| | | hepatoblastoma, | Turcot syndrome |
| | | glioma, other CNS | |
| ARHGEF12 | MLL | AML | |
| ARHH | BCL6 | NHL | |
| ARID1A | | clear cell ovarian | |
| | | carcinoma, RCC | |
| ARNT | ETV6 | AML | |
| ASPSCR1 | TFE3 | alveolar soft part | |
| | | sarcoma | |
| ASXL1 | | MDS, CMML | |
| ATF1 | EWSR1, FUS | malignant melanoma | |
| | | of soft parts, | |
| | | angiomatoid fibrous | |
| | | histiocytoma | |
| ATIC | ALK | ALCL | |
| ATM | | T-PLL | Ataxia-telangiectasia |
| ATRX | | Pancreatic | |
| | | neuroendocrine | |
| | | tumors | |
| BAP1 | | uveal melanoma, | |
| | | breast, NSCLC | |
| BCL10 | IGH @ | MALT | |
| BCL11A | IGH @ | B-CLL | |
| BCL11B | TLX3 | T-ALL | |
| BCL2 | IGH @ | NHL, CLL | |
| BCL3 | IGH @ | CLL | |
| BCL5 | MYC | CLL | |
| BCL6 | IG loci, | | |
| | ZNFN1A1, | | |
| | LCP1, PIM1, | | |
| | TFRC, | | |
| | MHC2TA, | | |
| | NACA, HSPCB, | | |
| | HSPCA, | | |
| | HIST1H4I, | | |
| | IL21R, | | |
| | POU2AF1, | | |
| | ARHH, EIF4A2, | | |
| | SFRS3 | NHL, CLL | |
| BCL7A | MYC | BNHL | |
| BCL9 | IGH @, IGL @ | B-ALL | |
| BCR | ABL1, FGFR1, | CML, ALL, AML | |
| | JAK2 | | |
| BHD | | | Birt-Hogg-Dube |
| | | | syndrome |
| BIRC3 | MALT1 | MALT | |
| BLM | | | Bloom Syndrome |
| BMPR1A | | | Juvenile polyposis |
| BRAF | AKAP9, | melanoma, | |
| | KIAA1549 | colorectal, papillary | |
| | | thyroid, borderline | |
| | | ov, Non small-cell | |
| | | lung cancer | |
| | | (NSCLC), | |
| | | cholangiocarcinoma, | |
| | | pilocytic | |
| | | astrocytoma | |
| BRCA1 | | ovarian | Hereditary |
| | | | breast/ovarian cancer |
| BRCA2 | | breast, ovarian, | Hereditary |
| | | pancreatic | breast/ovarian cancer |
| BRD3 | NUT, C15orf55 | lethal midline | |
| | | carcinoma of young | |
| | | people | |
| BRD4 | NUT, C15orf55 | lethal midline | |
| | | carcinoma of young | |
| | | people | |
| BRIP1 | | | Fanconi anaemia J, |
| | | | breast cancer |
| | | | susceptiblity |
| BTG1 | MYC | BCLL | |
| BUB1B | | | Mosaic variegated |
| | | | aneuploidy |
| C12orf9 | LPP | lipoma | |
| C15orf21 | ETV1 | prostate | |
| C15orf55 | BRD3, BRD4 | lethal midline | |
| | | carcinoma | |
| C16orf75 | CIITA | PMBL, Hodgkin | |
| | | Lymphona, | |
| CANT1 | ETV4 | prostate | |
| CARD11 | | DLBCL | |
| CARS | ALK | ALCL | |
| CBFA2T1 | MLL, RUNX1 | AML | |
| CBFA2T3 | RUNX1 | AML | |
| CBFB | MYH11 | AML | |
| CBL | MLL | AML, JMML, MDS | |
| CBLB | | AML | |
| CBLC | | AML | |
| CCNB1IP1 | HMGA2 | leiomyoma | |
| CCND1 | IGH @, FSTL3 | CLL, B-ALL, breast | |
| CCND2 | IGL @ | NHL,CLL | |
| CCND3 | IGH @ | MM | |
| CD273 | CIITA | PMBL, Hodgkin | |
| | | Lymphona, | |
| CD274 | CIITA | PMBL, Hodgkin | |
| | | Lymphona, | |
| CD74 | ROS1 | NSCLC | |
| CD79A | | DLBCL | |
| CD79B | | DLBCL | |
| CDH1 | | lobular breast, | Familial gastric |
| | | gastric | carcinoma |
| CDH11 | USP6 | aneurysmal bone | |
| | | cysts | |
| CDK4 | | | Familial malignant |
| | | | melanoma |
| CDK6 | MLLT10 | ALL | |
| CDKN2A- | | melanoma, multiple | Familial malignant |
| p16(INK4a) | | other tumour types | melanoma |
| CDKN2A-p14ARF | | melanoma, multiple | Familial malignant |
| | | other tumour types | melanoma |
| CDKN2C | | glioma, MM | |
| CDX2 | ETV6 | AML | |
| CEBPA | | AML, MDS | |
| CEP1 | FGFR1 | MPD, NHL | |
| CHCHD7 | PLAG1 | salivary adenoma | |
| CHEK2 | | | familial breast cancer |
| CHIC2 | ETV6 | AML | |
| CHN1 | TAF15 | extraskeletal myxoid | |
| | | chondrosarcoma | |
| CIC | DUX4 | soft tissue sarcoma | |
| CIITA | FLJ27352, | PMBL, Hodgkin | |
| | CD274, CD273, | Lymphona, | |
| | RALGDS, | | |
| | RUNDC2A, | | |
| | C16orf75 | | |
| CLTC | ALK, TFE3 | ALCL, renal | |
| CLTCL1 | | ALCL | |
| CMKOR1 | HMGA2 | lipoma | |
| COL1A1 | PDGFB, USP6 | dermatofibrosarcoma | |
| | | protuberans, | |
| | | aneurysmal bone | |
| | | cyst | |
| COPEB | | prostate, glioma | |
| COX6C | HMGA2 | uterine leiomyoma | |
| CREB1 | EWSR1 | clear cell sarcoma, | |
| | | angiomatoid fibrous | |
| | | histiocytoma | |
| CREB3L1 | FUS | myxofibrosarcoma | |
| CREB3L2 | FUS | fibromyxoid | |
| | | sarcoma | |
| CREBBP | MLL, MORF, | ALL, AML, | |
| | RUNXBP2 | DLBCL, B-NHL | |
| CRLF2 | P2RY8, IGH @ | B-ALL, Downs | |
| | | associated ALL | |
| CRTC3 | MAML2 | salivary gland | |
| | | mucoepidermoid | |
| CTNNB1 | PLAG1 | colorectal, cvarian, | |
| | | hepatoblastoma, | |
| | | others, pleomorphic | |
| | | salivary adenoma | |
| CYLD | | cylindroma | Familial |
| | | | cylindromatosis |
| D10S170 | RET, PDGFRB | papillary thyroid, | |
| | | CML | |
| DAXX | | Pancreatic | |
| | | neuroendocrine | |
| | | tumors | |
| DDB2 | | | Xeroderma |
| | | | pigmentosum (E) |
| DDIT3 | FUS | liposarcoma | |
| DDX10 | NUP98 | AML | |
| DDX5 | ETV4 | prostate | |
| DDX6 | IGH @ | B-NHL | |
| DEK | NUP214 | AML | |
| DICER1 | | | Familial |
| | | | Pleuropulmonary |
| | | | Blastoma |
| DNMT3A | | AML | |
| DUX4 | CIC | soft tissue sarcoma | |
| EBF1 | HMGA2 | lipoma | |
| EGFR | | glioma, NSCLC | Familial lung cancer |
| EIF4A2 | BCL6 | NHL | |
| ELF4 | ERG | AML | |
| ELK4 | SLC45A3 | prostate | |
| ELKS | RET | papillary thyroid | |
| ELL | MLL | AL | |
| ELN | PAX5 | B-ALL | |
| EML4 | ALK | NSCLC | |
| EP300 | MLL, | colorectal, breast, | |
| | RUNXBP2 | pancreatic, AML, | |
| | | ALL, DLBCL | |
| EPS15 | MLL | ALL | |
| ERBB2 | | breast, ovarian, other | |
| | | tumour types, | |
| | | NSCLC, gastric | |
| ERCC2 | | | Xeroderma |
| | | | pigmentosum (D) |
| ERCC3 | | | Xeroderma |
| | | | pigmentosum (B) |
| ERCC4 | | | Xeroderma |
| | | | pigmentosum (F) |
| ERCC5 | | | Xeroderma |
| | | | pigmentosum (G) |
| ERG | EWSR1, | Ewing sarcoma, | |
| | TMPRSS2, | prostate, AML | |
| | ELF4, FUS, | | |
| | HERPUD1 | | |
| ETV1 | EWSR1, | Ewing sarcoma, | |
| | TMPRSS2, | prostate | |
| | SLC45A3, | | |
| | C15orf21, | | |
| | HNRNPA2B1, | | |
| | ACSL3 | | |
| ETV4 | EWSR1, | Ewing sarcoma, | |
| | TMPRSS2, | Prostate carcinoma | |
| | DDX5, KLK2, | | |
| | CANT1 | | |
| ETV5 | TMPRSS2, | | |
| | SCL45A3 | Prostate | |
| ETV6 | NTRK3, | congenital | |
| | RUNX1, | fibrosarcoma, | |
| | PDGFRB, | multiple leukemia | |
| | ABL1, MN1, | and lymphoma, | |
| | ABL2, FACL6, | secretory breast, | |
| | CHIC2, ARNT, | MDS, ALL | |
| | JAK2, EVI1, | | |
| | CDX2, STL, | | |
| | HLXB9, MDS2, | | |
| | PER1, SYK, | | |
| | TTL, FGFR3, | | |
| | PAX5 | | |
| EVI1 | RUNX1, ETV6, | AML, CML | |
| | PRDM16, RPN1 | | |
| EWSR1 | FLI1, ERG, | Ewing sarcoma, | |
| | ZNF278, | desmoplastic small | |
| | NR4A3, FEV, | round cell tumor, | |
| | ATF1, ETV1, | ALL, clear cell | |
| | ETV4, WT1, | sarcoma, sarcoma, | |
| | ZNF384, | myoepithelioma | |
| | CREB1, | | |
| | POU5F1, PBX1 | | |
| EXT1 | | | Multiple Exostoses |
| | | | Type 1 |
| EXT2 | | | Multiple Exostoses |
| | | | Type 2 |
| EZH2 | | DLBCL | |
| FACL6 | ETV6 | AML, AEL | |
| FANCA | | | Fanconi anaemia A |
| FANCC | | | Fanconi anaemia C |
| FANCD2 | | | Fanconi anaemia D2 |
| FANCE | | | Fanconi anaemia E |
| FANCF | | | Fanconi anaemia F |
| FANCG | | | Fanconi anaemia G |
| FBXW7 | | colorectal, | |
| | | endometrial, T-ALL | |
| FCGR2B | | ALL | |
| FEV | EWSR1, FUS | Ewing sarcoma | |
| FGFR1 | BCR, FOP, | MPD, NHL | |
| | ZNF198, CEP1 | | |
| FGFR1OP | FGFR1 | MPD, NHL | |
| FGFR2 | | Gastric, NSCLC, | |
| | | endometrial | |
| FGFR3 | IGH @, ETV6 | bladder, MM, T-cell | |
| | | lymphoma | |
| FH | | | hereditary |
| | | | leiomyomatosis and |
| | | | renal cell cancer |
| FHIT | HMGA2 | pleomorphic salivary | |
| | | gland adenoma | |
| FIP1L1 | PDGFRA | idiopathic | |
| | | hypereosinophilic | |
| | | syndrome | |
| FLI1 | EWSR1 | Ewing sarcoma | |
| FLJ27352 | CIITA | PMBL, Hodgkin | |
| | | Lymphona, | |
| FLT3 | | AML, ALL | |
| FNBP1 | MLL | AML | |
| FOXL2 | | granulosa-cell | |
| | | tumour of the ovary | |
| FOXO1A | PAX3 | alveolar | |
| | | rhabdomyosarcomas | |
| FOXO3A | MLL | AL | |
| FOXP1 | PAX5 | ALL | |
| FSTL3 | CCND1 | B-CLL | |
| FUS | DDIT3, ERG, | liposarcoma, AML, | |
| | FEV, ATF1, | Ewing sarcoma, | |
| | CREB3L2, | angiomatoid fibrous | |
| | CREB3L1 | histiocytoma, | |
| | | fibromyxoid | |
| | | sarcoma | |
| FVT1 | IGK @ | B-NHL | |
| GAS7 | MLL | AML | |
| GATA1 | | megakaryoblastic | |
| | | leukemia of Downs | |
| | | Syndrome | |
| GATA2 | | AML(CML blast | |
| | | transformation) | |
| GATA3 | | breast | |
| GMPS | MLL | AML | |
| GNA11 | | uveal melanoma | |
| GNAQ | | uveal melanoma | |
| GNAS | | pituitary adenoma | |
| GOLGA5 | RET | papillary thyroid | |
| GOPC | ROS1 | glioblastoma | |
| GPC3 | | | Simpson-Golabi- |
| | | | Behmel syndrome |
| GPHN | MLL | AL | |
| GRAF | MLL | AML, MDS | |
| HCMOGT-1 | PDGFRB | JMML | |
| HEAB | MLL | AML | |
| HEI10 | HMGA2 | uterine leiomyoma | |
| HERPUD1 | ERG | prostate | |
| HIP1 | PDGFRB | CMML | |
| HIST1H4I | BCL6 | NHL | |
| HLF | TCF3 | ALL | |
| HLXB9 | ETV6 | AML | |
| HMGA1 | | microfollicular | |
| | | thyroid adenoma, | |
| | | various benign | |
| | | mesenchymal | |
| | | tumors, | |
| HMGA2 | LHFP, | lipoma, leiomyoma, | |
| | RAD51L1, LPP, | pleiomorphic | |
| | HEI10, COX6C, | salivary gland | |
| | CMKOR1, | adenoma | |
| | NFIB, ALDH2, | | |
| | CCNB1IP1, | | |
| | EBF1, WIF1, | | |
| | FHIT | | |
| HNRNPA2B1 | ETV1 | prostate | |
| HOOK3 | RET | papillary thyroid | |
| HOXA11 | NUP98 | CML | |
| HOXA13 | NUP98 | AML | |
| HOXA9 | NUP98, MSI2 | AML | |
| HOXC11 | NUP98 | AML | |
| HOXC13 | NUP98 | AML | |
| HOXD11 | NUP98 | AML | |
| HOXD13 | NUP98 | AML | |
| HRAS | | infrequent sarcomas, | Costello syndrome |
| | | rare other types | |
| HRPT2 | | parathyroid adenoma | Hyperparathyroidism- |
| | | | jaw tumor syndrome |
| HSPCA | BCL6 | NHL | |
| HSPCB | BCL6 | NHL | |
| IDH1 | | gliobastoma | |
| IDH2 | | GBM | |
| IGH @ | MYC, FGFR3, | MM, Burkitt | |
| | PAX5, IRTA1, | lymphoma, NHL, | |
| | IRF4, CCND1, | CLL, B-ALL, | |
| | BCL9, BCL8, | MALT, MLCLS | |
| | BCL6, BCL2, | | |
| | BCL3, BCL10, | | |
| | BCL11A. | | |
| | LHX4, DDX6, | | |
| | NFKB2, | | |
| | PAFAH1B2, | | |
| | PCSK7, CRLF2 | | |
| IGK @ | MYC, FVT1 | Burkitt lymphoma, | |
| | | B-NHL | |
| IGL @ | BCL9, MYC, | Burkitt lymphoma | |
| | CCND2 | | |
| IKZF1 | | ALL | |
| IL2 | TNFRSF17 | intestinal T-cell | |
| | | lymphoma | |
| IL21R | BCL6 | NHL | |
| IL6ST | | hepatocellular ca | |
| IRF4 | IGH @ | MM | |
| IRTA1 | IGH @ | B-NHL | |
| ITK | SYK | peripheral T-cell | |
| | | lymphoma | |
| JAK1 | | ALL | |
| JAK2 | ETV6, PCM1, | ALL, AML, MPD, | |
| | BCR | CML | |
| JAK3 | | acute | |
| | | megakaryocytic | |
| | | leukemia, | |
| JAZF1 | SUZ12 | endometrial stromal | |
| | | tumours | |
| JUN | | sarcoma | |
| KDM5A | NUP98 | AML | |
| KDM5C | | clear cell renal | |
| | | carcinoma | |
| KDM6A | | renal, oesophageal | |
| | | SCC, MM | |
| KDR | | NSCLC, | |
| | | angiosarcoma | |
| KIAA1549 | BRAF | pilocytic | |
| | | astrocytoma | |
| KIT | | GIST, AML, TGCT, | Familial |
| | | mastocytosis, | gastrointestinal |
| | | mucosal melanoma | stromal tumour |
| KLK2 | ETV4 | prostate | |
| | | pancreatic, | |
| | | colorectal, lung, | |
| | | thyroid, AML, | |
| KRAS | | others | |
| KTN1 | RET | papillary thryoid | |
| LAF4 | MLL, RUNX1 | ALL, T-ALL | |
| LASP1 | MLL | AML | |
| LCK | TRB @ | T-ALL | |
| LCP1 | BCL6 | NHL | |
| LCX | MLL | AML | |
| LHFP | HMGA2 | lipoma | |
| LIFR | PLAG1 | salivary adenoma | |
| LMO1 | TRD @ | T-ALL, | |
| | | neuroblastoma | |
| LMO2 | TRD @ | T-ALL | |
| LPP | HMGA2, MLL, | lipoma, leukemia | |
| | C12orf9 | | |
| LYL1 | TRB @ | T-ALL | |
| MADH4 | | colorectal, | Juvenile polyposis |
| | | pancreatic, small | |
| | | intestine | |
| MAF | IGH @ | MM | |
| MAFB | IGH @ | MM | |
| MALT1 | BIRC3 | MALT | |
| MAML2 | MECT1, | salivary gland | |
| | CRTC3 | mucoepidermoid | |
| MAP2K4 | | pancreatic, breast, | |
| | | colorectal | |
| MDM2 | | sarcoma, glioma, | |
| | | colorectal, other | |
| MDM4 | | GBM, bladder, | |
| | | retinoblastoma | |
| MDS1 | RUNX1 | MDS, AML | |
| MDS2 | ETV6 | MDS | |
| MECT1 | MAML2 | salivary gland | |
| | | mucoepidermoid | |
| MEN1 | | parathyroid tumors, | Multiple Endocrine |
| | | Pancreatic | Neoplasia Type 1 |
| | | neuroendocrine | |
| | | tumors | |
| MET | | papillary renal, head- | Familial Papillary |
| | | neck squamous cell | Renal Cancer |
| MHC2TA | BCL6 | NHL | |
| MITF | | melanoma | |
| MKL1 | RBM15 | acute | |
| | | megakaryocytic | |
| | | leukemia | |
| MLF1 | NPM1 | AML | |
| MLH1 | | colorectal, | Hereditary non- |
| | | endometrial, ovarian, | polyposis colorectal |
| | | CNS | cancer, Turcot |
| | | | syndrome |
| MLL | MLL, MLLT1, | AML, ALL | |
| | MLLT2, | | |
| | MLLT3, | | |
| | MLLT4, | | |
| | MLLT7, | | |
| | MLLT10, | | |
| | MLLT6, ELL, | | |
| | EPS15, AF1Q, | | |
| | CREBBP, | | |
| | SH3GL1, | | |
| | FNBP1, | | |
| | PNUTL1, MSF, | | |
| | GPHN, GMPS, | | |
| | SSH3BP1, | | |
| | ARHGEF12, | | |
| | GAS7, | | |
| | FOXO3A, | | |
| | LAF4, LCX, | | |
| | SEPT6, LPP, | | |
| | CBFA2T1, | | |
| | GRAF, EP300, | | |
| | PICALM, | | |
| | HEAB | | |
| MLL2 | | medulloblastoma, | |
| | | renal | |
| MLL3 | | medulloblastoma | |
| MLLT1 | MLL | AL | |
| MLLT10 | MLL, PICALM, | AL | |
| | CDK6 | | |
| MLLT2 | MLL | AL | |
| MLLT3 | MLL | ALL | |
| MLLT4 | MLL | AL | |
| MLLT6 | MLL | AL | |
| MLLT7 | MLL | AL | |
| MN1 | ETV6 | AML, meningioma | |
| MPL | | MPD | Familial essential |
| | | | thrombocythemia |
| MSF | MLL | AML | |
| MSH2 | | colorectal, | Hereditary non- |
| | | endometrial, ovarian | polyposis colorectal |
| | | | cancer |
| MSH6 | | colorectal | Hereditary non- |
| | | | polyposis colorectal |
| | | | cancer |
| MSI2 | HOXA9 | CML | |
| MSN | ALK | ALCL | |
| MTCP1 | TRA @ | T cell | |
| | | prolymphocytic | |
| | | leukemia | |
| MUC1 | IGH @ | B-NHL | |
| MUTYH | | | Adenomatous |
| | | | polyposis coli |
| MYB | NFIB | adenoid cystic | |
| | | carcinoma | |
| MYC | IGK @, BCL5, | Burkitt lymphoma, | |
| | BCL7A, BTG1, | amplified in other | |
| | TRA @, IGH @ | cancers, B-CLL | |
| MYCL1 | | small cell lung | |
| MYCN | | neuroblastoma | |
| MYD88 | | ABC-DLBCL | |
| MYH11 | CBFB | AML | |
| MYH9 | ALK | ALCL | |
| MYST4 | CREBBP | AML | |
| NACA | BCL6 | NHL | |
| NBS1 | | | Nijmegen breakage |
| | | | syndrome |
| NCOA1 | PAX3 | alveolar | |
| | | rhadomyosarcoma | |
| NCOA2 | RUNXBP2 | AML | |
| NCOA4 | RET | papillary thyroid | |
| NF1 | | neurofibroma, | Neurofibromatosis |
| | | glioma | type 1 |
| NF2 | | meningioma, | Neurofibromatosis |
| | | acoustic neuroma, | type 2 |
| | | renal | |
| NFE2L2 | | NSCLC, HNSCC | |
| NFIB | MYB, HGMA2 | adenoid cystic | |
| | | carcinoma, lipoma | |
| NFKB2 | IGH @ | B-NHL | |
| NIN | PDGFRB | MPD | |
| NKX2-1 | | NSCLC | |
| NONO | TFE3 | papillary renal | |
| | | cancer | |
| NOTCH1 | TRB @ | T-ALL | |
| NOTCH2 | | marginal zone | |
| | | lymphoma, DLBCL | |
| NPM1 | ALK, RARA, | NHL, APL, AML | |
| | MLF1 | | |
| NR4A3 | EWSR1 | extraskeletal myxoid | |
| | | chondrosarcoma | |
| NRAS | | melanoma, MM, | |
| | | AML, thyroid | |
| NSD1 | NUP98 | AML | |
| NTRK1 | TPM3, TPR, | papillary thyroid | |
| | TFG | | |
| NTRK3 | ETV6 | congenital | |
| | | fibrosarcoma, | |
| | | Secretory breast | |
| NUMA1 | RARA | APL | |
| NUP214 | DEK, SET, | AML, T-ALL | |
| | ABL1 | | |
| NUP98 | HOXA9, NSD1, | AML | |
| | WHSC1L1, | | |
| | DDX10, TOP1, | | |
| | HOXD13, | | |
| | PMX1, | | |
| | HOXA13, | | |
| | HOXD11, | | |
| | HOXA11, | | |
| | RAP1GDS1, | | |
| | HOXC11 | | |
| NUT | BRD4, BRD3 | lethal midline | |
| | | carcinoma of young | |
| | | people | |
| OLIG2 | TRA @ | T-ALL | |
| OMD | USP6 | aneurysmal bone | |
| | | cysts | |
| P2RY8 | CRLF2 | B-ALL, Downs | |
| | | associated ALL | |
| PAFAH1B2 | IGH @ | MLCLS | |
| PALB2 | | | Fanconi anaemia N, |
| | | | breast cancer |
| | | | susceptibility |
| PAX3 | FOXPO1A, | alveolar | |
| | NCOA1 | rhabdomyosarcoma | |
| PAX5 | IGH @, ETV6 | NHL, ALL, B-ALL | |
| | PML, FOXP1, | | |
| | ZNF521, ELN | | |
| PAX7 | FOXO1A | alveolar | |
| | | rhabdomyosarcoma | |
| PAX8 | PPARG | follicular thyroid | |
| PBRM1 | | clear cell renal | |
| | | carcinoma, breast | |
| PBX1 | TCF3, EWSR1 | pre B-ALL, | |
| | | myoepithelioma | |
| PCM1 | RET, JAK2 | papillary thyroid, | |
| | | CML, MPD | |
| PCSK7 | IGH @ | MLCLS | |
| PDE4DIP | PDGFRB | MPD | |
| PDGFB | COL1A1 | DFSP | |
| PDGFRA | FIP1L1 | GIST, idiopathic | |
| | | hypereosinophilic | |
| | | syndrome | |
| PDGFRB | ETV6, TRIP11, | MPD, AML, | |
| | HIP1, RAB5EP, | CMML, CML | |
| | H4, NIN, | | |
| | HCMOGT-1, | | |
| | PDE4DIP | | |
| PER1 | ETV6 | AML, CMML | |
| PHOX2B | | neuroblastoma | familial |
| | | | neuroblastoma |
| PICALM | MLLT10, MLL | TALL, AML, | |
| PIK3CA | | colorectal, gastric, | |
| | | gliobastoma, breast | |
| PIK3R1 | | gliobastoma, | |
| | | ovarian, colorectal | |
| PIM1 | BCL6 | NHL | |
| PLAG1 | TCEA1, LIFR, | salivary adenoma | |
| | CTNNB1, | | |
| | CHCHD7 | | |
| PML | RARA, PAX5 | APL, ALL | |
| PMS1 | | | Hereditary non- |
| | | | polyposis colorectal |
| | | | cancer |
| PMS2 | | | Hereditary non- |
| | | | polyposis colorectal |
| | | | cancer, Turcot |
| | | | syndrome |
| PMX1 | NUP98 | AML | |
| PNUTL1 | MLL | AML | |
| POU2AF1 | BCL6 | NHL | |
| POU5F1 | EWSR1 | sarcoma | |
| PPARG | PAX8 | follicular thyroid | |
| PPP2R1A | | clear cell ovarian | |
| | | carcinoma | |
| PRCC | TFE3 | papillary renal | |
| PRDM1 | | DLBCL | |
| PRDM16 | EVI1 | MDS, AML | |
| PRF1 | | | |
| PRKAR1A | RET | papillary thyroid | Carney complex |
| PRO1073 | TFEB | renal cell carcinoma | |
| | | (childhood | |
| | | epithelioid) | |
| PSIP2 | NUP98 | AML | |
| PTCH | | skin basal cell, | Nevoid Basal Cell |
| | | medulloblastoma | Carcinoma Syndrome |
| PTEN | | glioma, prostate, | Cowden Syndrome, |
| | | endometrial | Bannayan-Riley- |
| | | | Ruvalcaba syndrome |
| PTPN11 | | JMML, AML, MDS | |
| RAB5EP | PDGFRB | CMML | |
| RAD51L1 | HMGA2 | lipoma, uterine | |
| | | leiomyoma | |
| RAF1 | SRGAP3 | pilocytic | |
| | | astrocytoma | |
| RALGDS | CIITA | PMBL, Hodgkin | |
| | | Lymphona, | |
| RANBP17 | TRD @ | ALL | |
| RAP1GDS1 | NUP98 | T-ALL | |
| RARA | PML, ZNF145, | APL | |
| | TIF1, NUMA1, | | |
| | NPM1 | | |
| RB1 | | retinoblastoma, | |
| | | sarcoma, breast, | Familial |
| | | small cell lung | retinoblastoma |
| RBM15 | MKL1 | acute | |
| | | megakaryocytic | |
| | | leukemia | |
| RECQL4 | | | Rothmund-Thompson |
| | | | Syndrome |
| REL | | Hodgkin Lymphoma | |
| RET | H4, PRKAR1A, | medullary thyroid, | Multiple endocrine |
| | NCOA4, PCM1, | papillary thyroid, | neoplasia 2A/2B |
| | GOLGA5, | pheochromocytoma | |
| | TRIM33, KTN1, | | |
| | TRIM27, | | |
| | HOOK3 | | |
| ROS1 | GOPC, ROS1 | glioblastoma, | |
| | | NSCLC | |
| RPL22 | RUNX1 | AML, CML | |
| RPN1 | EVI1 | AML | |
| RUNDC2A | CIITA | PMBL, Hodgkin | |
| | | Lymphona, | |
| RUNX1 | RPL22, MDS1, | AML, preB-ALL, | |
| | EVI1, | T-ALL | |
| | CBFA2T3, | | |
| | CBFA2T1, | | |
| | ETV6, LAF4 | | |
| RUNXBP2 | CREBBP, | AML | |
| | NCOA2, EP300 | | |
| SBDS | | | Schwachman- |
| | | | Diamond syndrome |
| SDH5 | | | Familial |
| | | | paraganglioma |
| SDHB | | | Familial |
| | | | paraganglioma |
| SDHC | | | Familial |
| | | | paraganglioma |
| SDHD | | | Familial |
| | | | paraganglioma |
| SEPT6 | MLL | AML | |
| SET | NUP214 | AML | |
| SETD2 | | clear cell renal | |
| | | carcinoma | |
| SFPQ | TFE3 | papillary renal cell | |
| SFRS3 | BCL6 | follicular lymphoma | |
| SH3GL1 | MLL | AL | |
| SIL | TALI | T-ALL | |
| SLC45A3 | ETV1, ETV5, | prostate | |
| | ELK4, ERG | | |
| SMARCA4 | | NSCLC | |
| SMARCB1 | | malignant rhabdoid | Rhabdoid |
| | | | predisposition |
| | | | syndrome |
| SMO | | skin basal cell | |
| SOCS1 | | Hodgkin | |
| | | Lymphoma, PMBL | |
| SOX2 | | NSCLC, | |
| | | oesophageal | |
| | | squamous carcinoma | |
| SRGAP3 | RAF1 | pilocytic | |
| | | astrocytoma | |
| SS18 | SSX1, SSX2 | synovial sarcoma | |
| SS18L1 | SSX1 | synovial sarcoma | |
| SSH3BP1 | MLL | AML | |
| SSX1 | SS18 | synovial sarcoma | |
| SSX2 | SS18 | synovial sarcoma | |
| SSX4 | SS18 | synovial sarcoma | |
| STK11 | | NSCLC, pancreatic | Peutz-Jeghers |
| | | | syndrome |
| STL | ETV6 | B-ALL | |
| SUFU | | medulloblastoma | Medulloblastoma |
| | | | predisposition |
| SUZ12 | JAZF1 | endometrial stromal | |
| | | tumours | |
| SYK | ETV6, ITK | MDS, peripheral T- | |
| | | cell lymphoma | |
| TAF15 | TEC, CHN1, | extraskeletal myxoid | |
| | ZNF384 | chondrosarcomas, | |
| | | ALL | |
| TAL1 | TRD @, SIL | lymphoblastic | |
| | | leukemia/biphasic | |
| TAL2 | TRB @ | T-ALL | |
| TCEA1 | PLAG1 | salivary adenoma | |
| TCF1 | | hepatic adenoma, | Familial Hepatic |
| | | hepatocellular ca | Adenoma |
| TCF12 | TEC | extraskeletal myxoid | |
| | | chondrosarcoma | |
| TCF3 | PBX1, HLF, | pre B-ALL | |
| | TFPT | | |
| TCL1A | TRA @ | T-CLL | |
| TCL6 | TRA @ | T-ALL | |
| TET2 | | MDS | |
| TFE3 | SFPQ, | papillary renal, | |
| | ASPSCR1, | alveolar soft part | |
| | PRCC, NONO, | sarcoma, renal | |
| | CLTC | | |
| TFEB | ALPHA | renal (childhood | |
| | | epithelioid) | |
| TFG | NTRK1, ALK | papillary thyroid, | |
| | | ALCL, NSCLC | |
| TFPT | TCF3 | pre-B ALL | |
| TFRC | BCL6 | NHL | |
| THRAP3 | USP6 | aneurysmal bone | |
| | | cysts | |
| TIF1 | RARA | APL | |
| TLX1 | TRB @, TRD @ | T-ALL | |
| TLX3 | BCL11B | T-ALL | |
| TMPRSS2 | ERG, ETV1, | prostate | |
| | ETV4, ETV5 | | |
| TNFAIP3 | | marginal zone B-cell | |
| | | lymphomas, | |
| | | Hodgkin's | |
| | | lymphoma, primary | |
| | | mediastinal B cell | |
| | | lymphoma | |
| TNFRSF14 | | follicular lymphoma | |
| TNFRSF17 | IL2 | intestinal T-cell | |
| | | lymphoma | |
| TNFRSF6 | | TGCT, nasal NK/T | |
| | | lymphoma, skin | |
| | | squamous cell ca- | |
| | | burn scar-related | |
| TOP1 | NUP98 | AML | |
| TP53 | | breast, colorectal, | Li-Fraumeni |
| | | lung, sarcoma, | syndrome |
| | | adrenocortical, | |
| | | glioma, multiple | |
| | | other tumour types | |
| TPM3 | NTRK1, ALK | papillary thyroid, | |
| | | ALCL | |
| TPM4 | ALK | ALCL | |
| TPR | NTRK1 | papillary thyroid | |
| TRA @ | ATL, OLIG2, | T-ALL | |
| | MYC, TCL1A, | | |
| | TCL6, MTCP1, | | |
| | TCL6 | | |
| TRB @ | HOX11, LCK, | T-ALL | |
| | NOTCH1, | | |
| | TAL2, LYL1 | | |
| TRD @ | TALI, HOX11, | T-cell leukemia | |
| | TLX1, LMO1, | | |
| | LMO2, | | |
| | RANBP17 | | |
| TRIM27 | RET | papillary thyroid | |
| TRIM33 | RET | papillary thyroid | |
| TRIP11 | PDGFRB | AML | |
| TSC1 | | | Tuberous sclerosis 1 |
| TSC2 | | | Tuberous sclerosis 2 |
| TSHR | | toxic thyroid | |
| | | adenoma | |
| TTL | ETV6 | ALL | |
| USP6 | COL1A1, | aneurysmal bone | |
| | CDH11, ZNF9, | cysts | |
| | OMD | | |
| VHL | | renal, hemangioma, | von Hippel-Lindau |
| | | pheochromocytoma | syndrome |
| WAS | | | Wiskott-Aldrich |
| | | | syndrome |
| WHSC1 | IGH @ | MM | |
| WHSC1L1 | NUP98 | AML | |
| WIF1 | HMGA2 | pleomorphic salivary | |
| | | gland adenoma | |
| WRN | | | Werner Syndrome |
| WT1 | EWSR1 | Wilms, desmoplastic | Denys-Drash |
| | | small round cell | syndrome, Frasier |
| | | tumor | syndrome, Familial |
| | | | Wilms tumor |
| WTX | | Wilms tumour | |
| XPA | | | Xeroderma |
| | | | pigmentosum |
| XPC | | | Xeroderma |
| | | | pigmentosum |
| ZNF145 | RARA | APL | |
| ZNF198 | FGFR1 | MPD, NHL | |
| ZNF278 | EWSR1 | Ewing sarcoma | |
| ZNF331 | | follicular thyroid | |
| | | adenoma | |
| ZNF384 | EWSR1, TAF15 | ALL | |
| ZNF521 | PAX5 | ALL | |
| ZNF9 | USP6 | aneurysmal bone | |
| | | cysts | |
| ZNFN1A1 | BCL6 | ALL, DLBCL | |

Abbrevations used in Table 1 (and methods of treating patients suffering from the conditions as contemplated herein, e.g., associated with the corresponding proteins arising from fusion genes) include AEL, acute eosinophilic leukemia; AL, acute leukemia; ALCL, anaplastic large-cell lymphoma; ALL, acute lymphocytic leukemia; AML, acute myelogenous leukemia; APL, acute promyelocytic leukemia; B-ALL, B-cell acute lymphocytic leukaemia; B-CLL, B-cell Lymphocytic leukemia; B-NHL, B-cell Non-Hodgkin Lymphoma; CLL, chronic lymphatic leukemia; CML, chronic myeloid leukemia; CMML, chronic myelomonocytic leukemia; CNS, central nervous system; DFSP, dermatofibrosarcoma protuberans; GIST, gastrointestinal stromal tumour; JMML, juvenile myelomonocytic leukemia; MALT, mucosa-associated lymphoid tissue lymphoma; MDS, myelodysplastic syndrome; MLCLS, mediastinal large cell lymphoma with sclerosis; MM, multiple myeloma; MPD, Myeloproliferative disorder; NHL, non-Hodgkin lymphoma; NK/T, natural killer T cell; NSCLC, non small cell lung cancer; PMBL, primary mediastinal B-cell lymphoma; pre-B All, pre-B-cell acute lymphoblastic leukaemia; T-ALL, T-cell acute lymphoblastic leukemia; T-CLL, T-cell chronic lymphocytic leukaemia; TGCT, testicular germ cell tumour; T-PLL, T cell prolymphocytic leukaemia.

In an embodiment, described herein are monomers capable of forming a biologically useful multimer when in contact with one, two, three or more other monomers present in an aqueous media. In one aspect, such monomers may be capable of binding to another monomer in an aqueous media (e.g. in vivo) to form a multimer, (e.g. a dimer). Contemplated monomers may include a functional element, a linker element, and a connector element that joins the functional element and the linker element. In an aqueous media, such contemplated monomers may join together via each linker element and may thus be capable of modulating one or more biomolecules substantially simultaneously, e.g., modulate two or more binding domains on a protein or on different proteins. For example, contemplated monomers may be separate or separatable in a solid or in an aqueous media under one set of conditions, and when placed in an aqueous media that includes one or more biomolecules, with another monomer (e.g., under a different set of conditions), can 1) form a multimer through the linker on each monomer; and either: 2a) bind to the biomolecule in two or more locations (e.g. protein domains) through each functional element of the respective monomer or 2b) bind to two or more biomolecules through each functional element of the respective monomer. In an exemplary embodiment, disclosed monomers may interact with another appropriate monomer (i.e. a monomeric pair) in an aqueous media (e.g., in vivo) to form a multimer (e.g. a dimer) that can bind to two separate biomolecular domains (e.g. protein domains).

The functional element of a contemplated monomer, in some cases, may be a pharmacophore or a ligand moiety that is e.g., capable of binding to a biomolecule, such as for example, a protein, e.g. a particular protein domain, an enzyme active site, a component of a biological cell such as the ribosome, or a protease (such as tryptase). In some embodiments, the linker element comprises a functional group capable of forming a chemical bond with another linker element. In another aspect, a plurality of monomers, each comprising a linker element, may react to form a multimer connected by the linker elements. In some embodiments, the multimer may be formed in vivo. In some instances, the multimer may have enhanced properties relative to the monomers that form the multimer. For example, in certain embodiments, the multimer may bind to a target with greater affinity than any of the monomers that form the multimer. Also described are methods of making the compositions and methods of administering the compositions.

In some embodiments, a plurality of monomers may assemble to form a multimer. The multimer may be used for a variety of purposes. For example, in some instances, the multimer may be used to perturb a biological system. In certain embodiments, the multimer may be used as a pharmaceutical.

Advantageously, in some embodiments, the multimer may form in vivo upon administration of suitable monomers to a subject. Also advantageously, the multimer may be capable of interacting with a relatively large target site (e.g. a fusion protein) as compared to the individual monomers that form the multimer. For example, a target may comprise, in some embodiments, two protein domains separated by a distance such that a multimer, but not a monomer, may be capable of binding to both domains essentially simultaneously. In some embodiments, contemplated multimers may bind to a target with greater affinity as compared to a monomer binding affinity alone.

In some embodiments, a contemplated multimer may advantageously exhibit enhanced properties relative to the monomers that form the multimer. As discussed above, a multimer may have improved binding properties as compared to the monomers alone. It should be understood that a multimer, as used herein, may be a homomultimer (i.e., a multimer formed from two or more essentially identical monomers) or may be a heteromultimer (i.e., a multimer formed from two or more substantially different monomers). In some embodiments, a contemplated multimer may comprise 2-10 monomers, for example, a multimer may be a dimer, a trimer, a tetramer, or a pentamer.

In some cases, the pH of the aqueous fluid in which the multimer forms may be between pH 1 and 9, between pH 1 and 3, in some embodiments between pH 3 and 5, in some embodiments between pH 5 and 7, and in some embodiments between pH 7 and 9. In some embodiments, the multimer may be stable in an aqueous solution having a pH between pH 1 and 9, in some embodiments between pH 3 and 5, in some embodiments between pH 5 and 7, and in some embodiments between pH 7 and 9. In some embodiments, the aqueous solution may have a physiologically acceptable pH.

In some embodiments, a monomer may comprise a functional element, a linker element, and a connector element that associates the functional element with the linker element.

In some embodiments, the linker element of a first monomer may combine with the linker element of a second monomer. In some cases, the linker element may comprise a functional group that can react with a functional group of another linker element to form a bond linking the monomers. In some embodiments, the linker element of a first monomer may be substantially the same as the linker element of a second monomer. In some embodiments, the linker element of a first monomer may be substantially different than the linker element of a second monomer.

In some cases, the functional element may be a pharmacophore. In some embodiments, the functional element (e.g., a pharmacophore) may bind to a target molecule with a dissociation constant of less than 1 mM, in some embodiments less than 500 μM, in some embodiments less than 300 μM, in some embodiments less than 100 μM, in some embodiments less than 10 μM, in some embodiments less than 1 μM, in some embodiments less than 100 nM, in some embodiments less than 10 nM, and in some embodiments less than 1 nM.

In some embodiments, the functional element may be capable of binding to a target and at least partially disrupting a protein fusion protein. In some embodiments, the IC₅₀ of the first monomer against the first target biomolecule segment and the IC₅₀ of the second monomer against the second target biomolecule segment may be greater than the apparent IC₅₀ resulting from an equimolar combination of the monomers against both target biomolecule segments. In another embodiment, the apparent binding affinity of the first monomer against a first segment of the protein fusion and the apparent binding affinity of the second monomer against a second segment of a biomolecular target or segment may be weaker than the apparent binding affinity against either segment or against both segments resulting from the combination of the monomers (i.e. due to formation of a hetero-multimer).

For example, for disclosed monomers forming a heteromultimer, the apparent IC₅₀ resulting from an equimolar combination of monomers against the first target biomolecule and the second target biomolecule is at least about 3 to 10 fold lower, at least about 10 to 30 fold lower, at least about 30 fold lower or at least about 40 or 50 fold lower than the highest of the IC₅₀ of the second monomer against the second target biomolecule or the IC₅₀ of the first monomer against the first target biomolecule.

It will be appreciated that for monomers forming homodimers (or homo-oligomeric or homomultimeric, as described below), in aqueous solution, there may an equilibrium between the monomeric and dimeric (or oligomeric) states with higher concentrations favoring greater extent of dimer formation. As the binding of monomers to the biomolecular target increases their proximity and effectively increases their local concentration on the target, the rate and extent of dimerization (oligomerization) is promoted when geometries are favorable. As a result, the occupancy of the target by favorable monomers maybe nearly completely in the homodimeric state. In this manner the target for example, may serve as a template for the dimerization of the monomers (referred to as coferons), significantly enhancing the extent and/or rate of dimerization.

While the affinity of the multimer for its biomolecular target(s) often cannot be measured directly due to the dynamic reversible equilibrium with its monomers in an aqueous or biological milieu, it may be possible to extract an apparent multimer-target dissociation constant from a series of experimental determinations. Exploring the effects of a matrix of monomer concentrations, monomer ratios, along with changes in concentration(s) in the biomolecular target(s), coupled with determinations of multimer-monomer dissociation constants, and in some cases additional binding competition, kinetic and biophysical methods, one can extract an estimate of the affinity of the multimeric assembly for its target(s). Through such approaches, one can demonstrate that in some embodiments, the affinity of the multimer for the biomolecular target(s) are less than 1 μM, in some embodiments less than 1 nM, in some embodiments less than 1 pM, in some embodiments less than 1 fM, and in some embodiments less than 1 aM, and in some embodiments less than 1 zM.

Affinities of heterodimerizing monomers for the biomolecular target can be assessed through the testing of the respective monomers in appropriate assays for the target activity or biology because they do not typically self-associate. In contrast, the testing of homodimerizing monomers (coferons) may not, in some embodiments, afford an affinity for the monomeric or dimeric state, but rather the observed effect (e.g. IC₅₀) is a result of the monomer-dimer dynamics and equilibrium, with the apparent binding affinity (or IC₅₀) being e.g., a weighted measure of the monomer and dimeric inhibitory effects upon the target.

Also provided herein is a method of delivering compounds having the isotope ¹⁰B in a selective manner to malignant cell, for e.g. effective boron neutron capture therapy. It will be appreciated that linkers and monomers having a boron atom can be replaced with compounds enriched with the isotope ¹⁰B (e.g., so that the compounds have more ¹⁰B that occurs naturally) in the same position. It will be appreciated that the provided methods, using linkers as above that include ¹⁰B, can target oncogenic fusion proteins, e.g., potentially leading to a selective accumulation of ¹⁰B-bearing monomers and multimers in the malignant cells. Thus also provided is a method of facilitating boron neutron capture therapy (BCNT) comprising administering (e.g. orally, subcutaneously or intravenously) a monomer with Formula I and a monomer with Formula II as above, wherein Z₁ or Z₂ have a boronic acid or oxaborale linker moiety having a ¹⁰B isotope thereby binding to a fusion gene product (e.g. oncogenic fusion proteins (e.g., that are expressed in malignant tissues and further comprising administering a neutron beam that interacts with the boron in the patient. Such a method may provide a rapid response with e.g., minimal cycles of treatment and/or enhanced selectivity for malignant cells with minimal damage to surrounding normal cells. Such boron based therapy may useful in malignancies expressing oncogenic fusion proteins such as: RET/TRNK1 in papillary thyroid carcinoma; EML4/ALK or CD47/ROS 1 in NSCLC; BRD/NUT in midline carcinoma; TFE3/PRCC in renal cell carcinoma; EWSR1-FLI1 in Ewing's sarcoma; or translocation-driven ERG or ELK4 overexpression in prostate carcinoma or sarcomas. In addition, targeting transforming fusion proteins such as BCR-ABL, TEL-AML1, AML1-ETO, etc. in hematopietic malignancies using combined monomers with BCNT may also have significant therapeutic benefit. Also contemplated for use in this type method are fusion proteins such as GOPC-ROS fusion (observed in GBM); MLL/AF9 and MLL/AF49 (leukemia), KIAA1549/BRAF (astrocytomas) AND FGFR1/ZNF198 (transformer in non-hodgkin's lymphomas). Such methods may also be used to target translocation driven overexpression of proteins such as cyclinD1, BCL-6 and c-Myc. Targeting proteins such as ETV6, EGFR, PDGFRA, KIT, and/or KDR is also contemplated.

In some embodiments, a connector element may be used to connect the linker element to the functional element. In some instances, the connector element may be used to adjust spacing between the linker element and the functional element. In some cases, the connector element may be used to adjust the orientation of the linker element and the functional element. In certain embodiments, the spacing and/or orientation the linker element relative to the functional element can affect the binding affinity of the functional element (e.g., a pharmacophore) to a target.

In some embodiments, the connector element may be used for modular assembly of monomers. For example, in some instances, a connector element may comprise a functional group formed from reaction of a first and second molecule. In some cases, a series of functional elements may be provided, where each functional element comprises a common functional group that can participate in a reaction with a compatible functional group on a linker element. In some embodiments, the connector element may comprise a spacer having a first functional group that forms a bond with a functional element and a second functional group that forms a bond with a linker element.

In certain embodiments, a first monomer may be capable of forming a biologically useful multimer when in contact with a second monomer in an aqueous media, for example, when the first and second monomer are different and form e.g. a heteromultimer in aqueous media. For example, the first monomer can represented by the formula:

X₁—Y₁—Z₁ (Formula I)
and pharmaceutically acceptable salts, stereoisomers, metabolites, and hydrates thereof, wherein
X₁ is a first ligand capable of binding to a first target biomolecule segment (e.g. protein or protein domain;
Y₁ is absent or is a connector moiety covalently bound to X₁ and Z₁;
Z₁ is a first linker selected from the group consisting of:

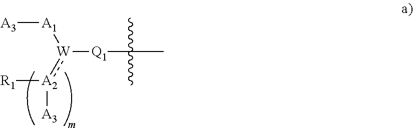

wherein
A₁ is (a) absent; or (b) selected from the group consisting of acyl, substituted or unsubstituted aliphatic, or substituted or unsubstituted heteroaliphatic;
A₂, independently for each occurrence, is (a) absent; or (b) selected from the group consisting of —N—, acyl, substituted or unsubstituted aliphatic, or substituted or unsubstituted heteroaliphatic, provided that at least one of A₁ and
A₂ is present; or
A₁ and A₂, together with the atoms to which they are attached, form a substituted or unsubstituted 4-8 membered cycloalkyl or heterocyclic ring;
A₃ is selected from the group consisting of —NHR′, —SH, or —OH;
W is CR′ or N;
R′ is selected from the group consisting of hydrogen, halogen, substituted or unsubstituted aliphatic, substituted or unsubstituted heteroaliphatic, substituted or unsubstituted aryl, substituted or unsubstituted heteroaryl, —NH₂, —NO₂, —SH, or —OH;
m is 1-6;
[symbol] represents a single or double bond; and
R₁ is (a) absent; or (b) selected from the group consisting of hydrogen, halogen, substituted or unsubstituted aliphatic, or substituted or unsubstituted heteroaliphatic, substituted or unsubstituted aryl, substituted or unsubstituted heteroaryl, —NH₂, —NO₂, —SH, or —OH;
Q₁ is (a) absent; or (b) selected from the group consisting of substituted or unsubstituted aliphatic or substituted or unsubstituted heteroaliphatic; or
R₁ and Q₁ together with the atoms to which they are attached form a substituted or unsubstituted 4-8 membered cycloalkyl or heterocyclic ring;

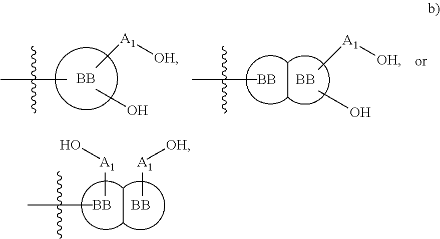

wherein
BB, independently for each occurrence, is a 4-8 membered cycloalkyl, heterocyclic, aryl, or heteroaryl moiety, wherein the cycloalkyl, heterocyclic, aryl, or heteroaryl moiety is optionally substituted with one or more groups represented by R₂, wherein the two substituents comprising —OH have a 1,2 or 1,3 configuration;
each R₂ is independently selected from hydrogen, halogen, oxo, sulfonate, —NO₂, —CN, —OH, —NH₂, —SH, —COOH, —CONHR′, substituted or unsubstituted aliphatic, substituted or unsubstituted heteroaliphatic, or two R₂ together with the atoms to which they are attached form a fused substituted or unsubstituted 4-6 membered cycloalkyl or heterocyclic bicyclic ring system;
A₁, independently for each occurrence, is (a) absent; or (b) selected from the group consisting of acyl, substituted or unsubstituted aliphatic, or substituted or unsubstituted heteroaliphatic;
R′ is selected from the group consisting of hydrogen, halogen, substituted or unsubstituted aliphatic, substituted or unsubstituted heteroaliphatic, substituted or unsubstituted aryl, substituted or unsubstituted heteroaryl, —NH₂, —NO₂, —SH, or —OH;

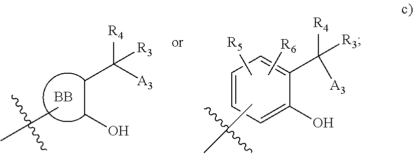

wherein
BB is a substituted or unsubstituted 5- or 6-membered cycloalkyl, heterocyclic, aryl, or heteroaryl moiety;
A₃, independently for each occurrence, is selected from the group consisting of —NHR′ or —OH;
R₃ and R₄ are independently selected from the group consisting of H, C₁₋₄alkyl, phenyl, or R₃ and R₄ taken together from a 3-6 membered ring;
R₅ and R₆ are independently selected from the group consisting of H, C₁₋₄alkyl optionally substituted by hydroxyl, amino, halogen, or thio; C₁₋₄alkoxy; halogen; —OH; —CN; —COOH; —CONHR′; or R₅ and R₆ taken together form phenyl or a 4-6 membered heterocycle; and
R′ is selected from the group consisting of hydrogen, halogen, substituted or unsubstituted aliphatic, substituted or unsubstituted heteroaliphatic, substituted or unsubstituted aryl, substituted or unsubstituted heteroaryl, —NH₂, —NO₂, —SH, or —OH;

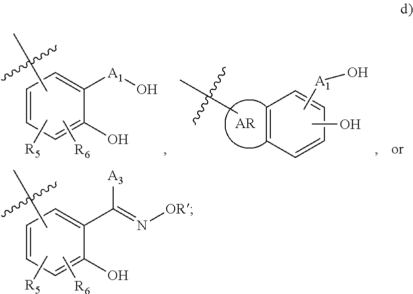

wherein
A₁ is (a) absent; or (b) selected from the group consisting of acyl, substituted or unsubstituted aliphatic, or substituted or unsubstituted heteroaliphatic;
A₃, independently for each occurrence, is selected from the group consisting of —NHR′ or —OH;
AR is a fused phenyl or 4-7 membered aromatic or partially aromatic heterocyclic ring, wherein AR is optionally substituted by oxo, C₁₋₄alkyl optionally substituted by hydroxyl, amino, halo, or thio; C₁₋₄alkoxy; —S—C₁₋₄alkyl; halogen; —OH; —CN; —COOH; —CONHR′; wherein the two substituents comprising —OH are ortho to each other;
R₅ and R₆ are independently selected from the group consisting of H, C₁₋₄alkyl optionally substituted by hydroxyl, amino, halo, or thio; C₁₋₄alkoxy; halogen; —OH; —CN; —COOH; CONHR′; and
R′ is selected from the group consisting of hydrogen, halogen, substituted or unsubstituted aliphatic, substituted or unsubstituted heteroaliphatic, substituted or unsubstituted aryl, substituted or unsubstituted heteroaryl, —NH₂, —NO₂, —SH, or —OH;

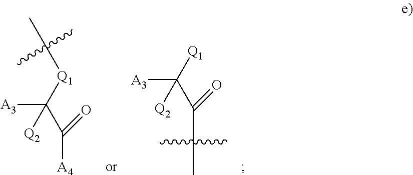

wherein
Q₁ is selected from the group consisting of C₁₋₄alkyl, alkylene, or a bond; C₁₋₆cycloalkyl; a 5-6 membered heterocyclic ring; or phenyl;
Q₂, independently for each occurrence, is selected from the group consisting of H, C₁₋₄alkyl, alkylene, or a bond; C₁₋₆cycloalkyl; a 5-6 membered heterocyclic ring; phenyl; substituted or unsubstituted aliphatic; substituted or unsubstituted heteroaliphatic; substituted or unsubstituted aryl; or substituted or unsubstituted heteroaryl;
A₃, independently for each occurrence, is selected from the group consisting of —NH₂ or —OH;
A₄, independently for each occurrence, is selected from the group consisting of —NH—NH₂; —NHOH, —NH—OR″, or —OH;
R″ is selected from the group consisting of H or C₁₋₄alkyl; and

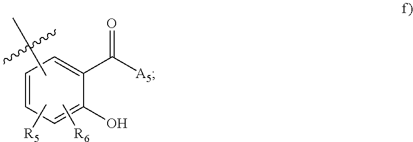

wherein
A₅ is selected from the group consisting of —OH, —NH₂, —SH, —NHR′″; R′″ is selected from —NH₂; —OH; and C₁₋₄alkoxy;
R₅ and R₆ are independently selected from the group consisting of H, C₁₋₄alkyl optionally substituted by hydroxyl, amino, halo, or thio; C₁₋₄alkoxy; halogen; —OH; —CN; —COOH; —CONHR′; or R₅ and R₆ taken together may form a 5-6 membered ring; and

the second monomer has a boronic acid or oxaborole moiety capable of binding with the Z₁ moiety of Formula I to form the multimer.

In some embodiments, A₁ may be selected from the group consisting of C₁-C₃alkylene optionally substituted with one, two, or three halogens, or —C(O)—.

In other embodiments, Z₁ may be

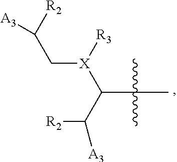

wherein R₂, independently for each occurrence, is selected from H, C₁₋₄ alkyl, or two R₁ moities taken together form a 5- or 6 membered cycloalkyl or heterocyclic ring, wherein R₃ is H, or

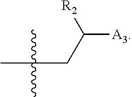

In certain embodiments, Z₁ may be

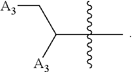

In some cases, Z₁ may be

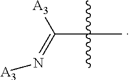

For example, in some instances, Z₁ may be

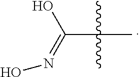 [SMILES: */C(O)=N/O]

In some embodiments, Z₁ may be a monosaccharide or a disaccharide.

In some cases, Z₁ may be selected from the group consisting of

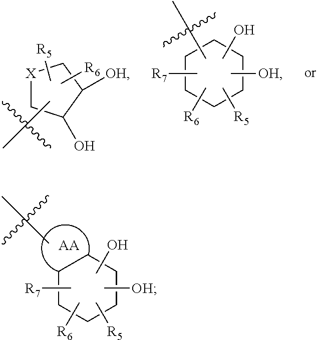

wherein

X is selected from O, S, CH, NR′, or when X is NR′, N may be covalently bonded to Y of formula I;

R′ is selected from the group consisting of H, C₁₋₄alkyl;

R₅, R₆, and R₇ are independently selected from the group consisting of H, C₁₋₄alkyl optionally substituted by hydroxyl, amino, halo, or thio; C₁₋₄alkoxy; halogen; —OH; —CN; —COOH; —CONHR′; or a mono- or bicyclic heterocyclic optionally substituted with amino, halo, hydroxyl, oxo, or cyano; and

AA is a 5-6 membered heterocyclic ring optionally substituted by C₁₋₄alkyl optionally substituted by hydroxyl, amino, halo, or thio; C₁₋₄alkoxy; halogen; —OH; —CN; —COOH; —CONHR′, or —S—C₁₋₄alkyl. For example, in some embodiments, Z₁ may be

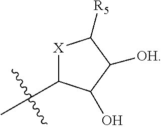

In some instances, Z₁ may be

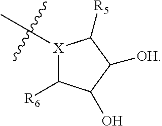

In certain cases, X may be nitrogen.

In some embodiments, Z₁ may be

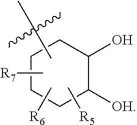

In other embodiments, Z₁ may be

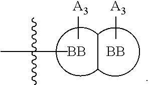

For example, in some cases, Z₁ may be

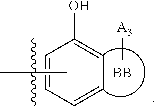

In other instances, Z₁ may be

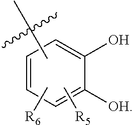

In some embodiments, Z₁ may be

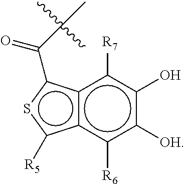

In some cases, Z₁ may be

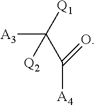

For example, Z₁ may be

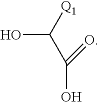

In other embodiments, Z₁ may be

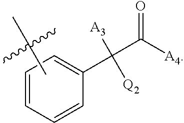

In some cases, Z₁ may be

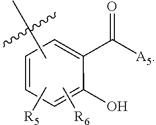

In some embodiments, Z₁ may be

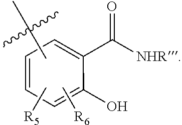

In some embodiments, Z₁ may be

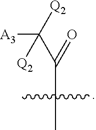

For example, Z₁ may be

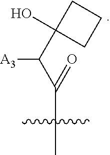

In certain embodiments, Z₁ may be

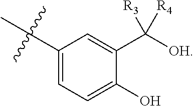

In other embodiments, Z₁ may be

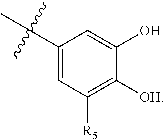

In some embodiments, the second monomer may be X₂—Y₂—Z₂ (Formula II), wherein Z₂ is the boronic acid or oxaborale moiety, and wherein X₂ is a second ligand capable of binding to a second target biomolecule segment (e.g. a segment of a fusion protein), and Y₂ is absent or is a connector moiety covalently bound to X₂ and Z₂. In some instances, X₁ and X₂ may be the same. In other instances, X₁ and X₂ may be different.

In some cases, the first target biomolecule and the second target biomolecule may be different. In other embodiments, the first target biomolecule and the second target biomolecule may be the same.

In some embodiments, Z₂ of the second monomer may be selected from the group consisting of:

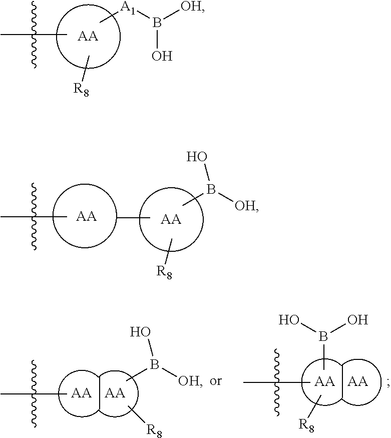

wherein

R₈ is selected from the group consisting of H, halogen, oxo, C₁₋₄alkyl optionally substituted by hydroxyl, amino, halo or thio; C₂₋₄alkenyl, C₁₋₄alkoxy; —S—C₁₋₄alkyl; —CN; —COOH; or —CONHR′;

A₁ is (a) absent; or (b) selected from the group consisting of acyl, substituted or unsubstituted aliphatic, or substituted or unsubstituted heteroaliphatic;

AA, independently for each occurrence, is phenyl, aryl, or a 5-7 membered heterocyclic or heteroaryl ring having one, two, or three heteroatoms, wherein AA is optionally substituted by one, two, or three sub stituents selected from the group consisting of halogen, C₁₋₄alkyl optionally substituted by hydroxyl, amino, halogen, or thio; C₂₋₄alkenyl, C₁₋₄alkoxy; —S—C₁₋₄alkyl; —CN; —COOH; —CONHR′; or two substituents together with the atoms to which they are attached form a fused 4-6 membered cycloalkyl or heterocyclic bicyclic ring system; and R′ is H or C₁₋₄alkyl.

In certain embodiments, R₈ and the substituent comprising boronic acid may be ortho to each other, and R₈ may be —CH₂NH₂. In some cases, Z₂ of the second monomer may be selected from the group consisting of:

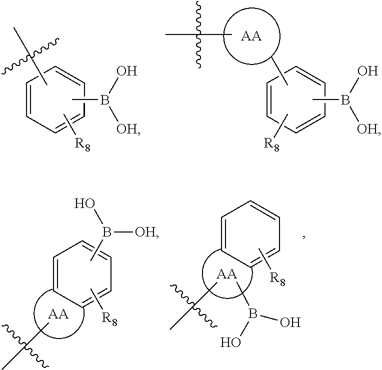

In some embodiments, Z₂ of the second monomer may be selected from the group consisting of

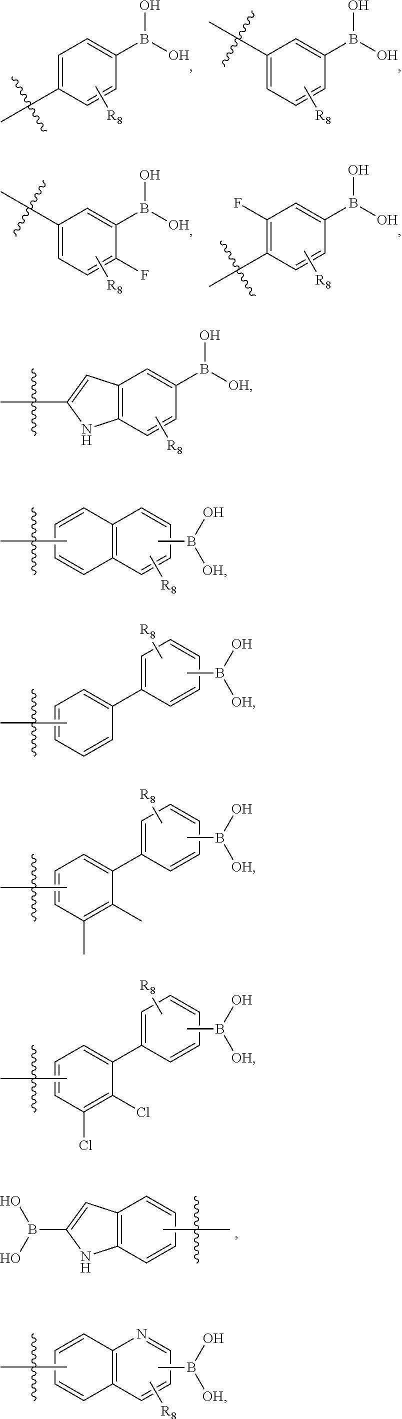

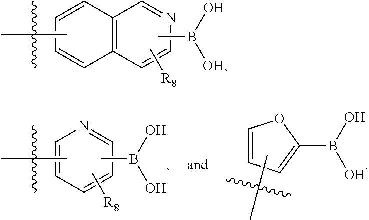

In some cases, Z₂ of the second monomer may be selected from the group consisting of:

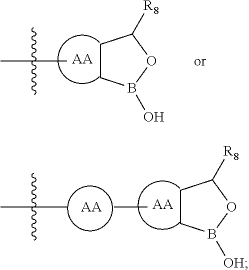

wherein

R₈ is selected from the group consisting of H, halogen, oxo, C₁₋₄alkyl optionally substituted by hydroxyl, amino, halo or thio; C₂₋₄alkenyl, C₁₋₄alkoxy; —S—C₁₋₄alkyl; —CN; —COOH; or —CONHR′;

AA, independently for each occurrence, is a 5-7 membered heterocyclic ring having one, two, or three heteroatoms, or phenyl, wherein AA is optionally substituted by one, two, or three substituents selected from the group consisting of halo, C₁₋₄alkyl optionally substituted by hydroxyl, amino, halo, or thio; C₂₋₄alkenyl, C₁₋₄alkoxy; —S—C₁₋₄alkyl; —CN; —COOH; —CONHR′; or two substituents together with the atoms to which they are attached form a fused 4-6 membered cycloalkyl or heterocyclic bicyclic ring system; and

R′ is H or C₁₋₄alkyl.

In some embodiments, a first monomer may be capable of forming a biologically useful dimer or multimer when in contact with a second monomer in vivo, wherein the first and second linkers are the same (e.g. forming a homodimer or homomultimer) wherein the first monomer is represented by the formula:

X₃—Y₃—Z₃ (Formula IV);

and pharmaceutically acceptable salts, stereoisomers, metabolites and hydrates thereof,

and the second monomer is represented by:

X₄—Y₄—Z₃ (Formula V)

and pharmaceutically acceptable salts, stereoisomers, metabolites and hydrates thereof,
wherein
X₃ is a first ligand capable of binding to a first target protein segment;
Y₃ is absent or is a connector moiety covalently bound to X₄ and Z₃;
X₄ is a second ligand capable of binding to a second target protein segment;
Y₄ is absent or is a connector moiety covalently bound to X₄ and Z₃;
Z₃ is selected from the group consisting of:

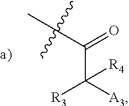

wherein
A₃ is —OH, —SH, or —NHR′;
R₃ is selected from the group consisting of H, halo, C₁₋₄alkyl, C₃₋₆cycloalkyl, and heterocycle, wherein C₁₋₄alkyl, C₃₋₆cycloalkyl, or heterocycle may be optionally substituted by one, two, or three substituents selected from the group consisting of halo, cyano, amino, or hydroxyl; and
R₄ is selected from the group consisting of H, halo, C₁₋₄alkyl, C₃₋₆cycloalkyl, and heterocycle, wherein C₁₋₄alkyl, C₃₋₆cycloalkyl, or heterocycle may be optionally substituted by one, two, or three substituents selected from the group consisting of halo, cyano, amino, or hydroxyl; and

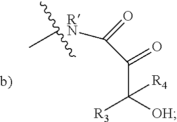

wherein
R′ is selected from C₁₋₄alkyl optionally substituted with hydroxyl; —NH₂; —OH; and C₁₋₄alkoxy;
R₃ is selected from the group consisting of H, halo, C₁₋₄alkyl, C₃₋₆cycloalkyl, and heterocycle, wherein C₁₋₄alkyl, C₃₋₆cycloalkyl, or heterocycle may be optionally substituted by one, two, or three substituents selected from the group consisting of halo, cyano, amino, or hydroxyl; and
R₄ is selected from the group consisting of H, halo, C₁₋₄alkyl, C₃₋₆cycloalkyl, and heterocycle, wherein C₁₋₄alkyl, C₃₋₆cycloalkyl, or heterocycle may be optionally substituted by one, two or three substituents selected from the group consisting of halo, cyano, amino, or hydroxyl.

In another embodiment, silyl monomers are contemplated that capable of forming a biologically useful multimer when in contact with one, two, three or more second silyl monomers in an aqueous media. The first and second silyl monomer can be represented by Formula IV or Formula V above, (e.g., X³—Y³—Z³), but wherein Z³ is independently selected from the group consisting of:

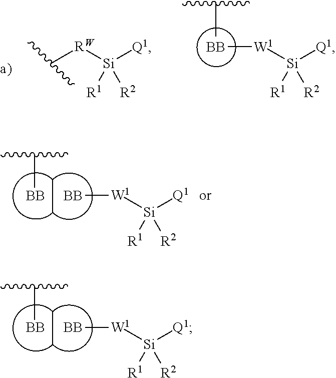

wherein

R^{W} is selected from the group consisting of —C₁₋₄alkyl-, —O—C₁₋₄alkyl-, —C₁₋₄alkyl-O—, —N(R^{a})—, —N(R^{a})—C₁₋₄alkyl-, —O—, —C(O)C₁₋₄alkyl-, —C(O)—O—C₁₋₄alkyl-, —C(O)—NR^{a}R^{b}—, —C₂₋₆alkenyl-, —C₂₋₆alkynyl-, —C₃₋₆cycloalkyl-, -phenyl- and -heterocycle-; wherein C₁₋₄alkyl, R^{a}, R^{b}, C₂₋₆alkenyl, C₂₋₆alkynyl, C₃₋₆cycloalkyl, phenyl and heteroaryl may be optionally substituted by one, two, three or more substituents selected from the group consisting of C₁₋₄alkyl, C₁₋₄alkoxy, —C(O)C₁₋₄alkyl, —C(O)—O—C₁₋₄alkyl, —C(O)—NR^{a}R^{b}, halogen, cyano, hydroxyl, phenyl, R^{a} and R^{b};

W¹, independently for each occurrence, is (a) absent; or (b) selected from the group consisting of —O—, —C₁₋₄alkyl-, —O—C₁₋₄alkyl-, —C₁₋₄alkyl-O—, —C(O)—C₁₋₄alkyl-, —N(R^{a})—, —N(R^{a})—C₁₋₄alkyl-, —C(O)—O—C₁₋₄alkyl-, —C(O)—NR′—, —C₂₋₆alkenyl-, —C₂₋₆alkynyl-, —C₃₋₆cycloalkyl-, -phenyl- or -heteroaryl-; wherein C₁₋₄alkyl, C₂₋₆alkenyl, C₂₋₆alkynyl, C₃₋₆cycloalkyl, R′, phenyl and heteroaryl are optionally substituted independently, for each occurrence, with one, two, three or more substituents selected from the group consisting of C₁₋₄alkyl, C₁₋₄alkoxy, —C(O)C₁₋₆alkyl, —C(O)—O—C₁₋₄alkyl, halogen, hydroxyl, nitro and cyano;

R′ is independently selected, for each occurrence, from the group consisting of hydrogen, substituted or unsubstituted aliphatic, and substituted or unsubstituted heteroaliphatic;

Q¹ is independently selected, for each occurrence, from the group consisting of —NHR′, —SH, —OH, —O—C₁₋₆alkyl, —S—C₁₋₆alkyl, —O-aryl, —S-aryl, heteroaryl, —O-heteroaryl, —S-heteroaryl, halogen and —O—C₁₋₆alkyl-NR^{a}R^{b};

R^{a} and R^{b} are independently selected, for each occurrence, from the group consisting of hydrogen and C₁₋₄alkyl; wherein C₁₋₄alkyl may be optionally substituted by one or more substituents selected from the group consisting of halogen, cyano, oxo and hydroxyl; or

R^{a} and R^{b}, together with the nitrogen to which they are attached, may form a 4-7 membered heterocyclic ring, which may have an additional heteroatom selected from O, S, or N; wherein the 4-7 membered heterocyclic ring may be optionally substituted by one or more substituents selected from the group consisting of halogen, cyano, oxo and hydroxyl;

R¹ and R² are selected independently, for each occurrence, from the group consisting of —OH, C₁₋₆alkyl, —O—C₁₋₆alkyl, C₂₋₆alkenyl, C₃₋₆cycloalkyl, —C₁₋₆alkyl-NR^{a}R^{b}, phenyl and heteroaryl; wherein C₁₋₆alkyl, C₂₋₆alkenyl, C₃₋₆cycloalkyl, R^{a}, R^{b}, phenyl and heteroaryl, independently selected, for each occurrence, may be optionally substituted by one or more substituents selected from the group consisting of halogen, cyano, hydroxyl, C₁₋₆alkyl, and phenyl;

BB, independently for each occurrence, is a 4-7-membered cycloalkyl, heterocyclic, aryl, or heteroaryl moiety, wherein the cycloalkyl, heterocyclic, aryl, or heteroaryl moiety is optionally substituted with one, two, three or more groups represented by R^{BB}; wherein R¹, independently for each occurrence, may be optionally bonded to BB;

each R^{BB} is independently selected, for each occurrence, from the group consisting of hydrogen, halogen, nitro, cyano, hydroxyl, amino, thio, —COOH, —CONHR′, substituted or unsubstituted aliphatic, and substituted or unsubstituted heteroaliphatic; or two R^{BB} together with the atoms to which they are attached form a fused 5- or 6-membered cycloalkyl or heterocyclic bicyclic ring system; and

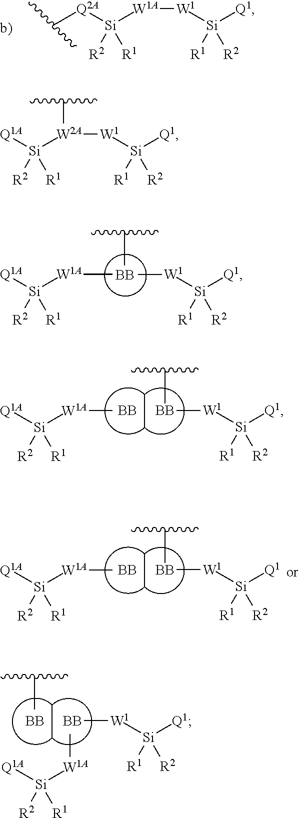

wherein

Q^{2A} is selected from the group consisting of —NH—, —S—, —O—, —O—C₁₋₆alkyl-, —C₁₋₆alkyl-O—, —N(R′)—C₁₋₆alkyl-, —C₁₋₆alkyl-N(R′)-, —S—C₁₋₆alkyl-, —C₁₋₆alkyl-S— and —O—C₁₋₆alkyl-NR^{a}—

W¹ and W^{1A}, independently for each occurrence, are (a) absent; or (b) selected from the group consisting of —O—, —C₁₋₄alkyl-, —O—C₁₋₄alkyl-, —C₁₋₄alkyl-O—, —N(R^{a})—, —N(R^{a})—C₁₋₄alkyl-, —C(O)C₁₋₄alkyl-, —C(O)—O—C₁₋₄alkyl-, —C(O)—NR′—, —C₂₋₆alkenyl-, —C₂₋₆alkynyl-, —C₃₋₆cycloalkyl-, -phenyl- and -heteroaryl-; wherein C₁₋₄alkyl, C₂₋₆alkenyl, C₂₋₆alkynyl, C₃₋₆cycloalkyl, R′, phenyl and heteroaryl may be optionally substituted independently, for each occurrence, with one, two, three or more substituents selected from the group consisting of C₁₋₄alkyl, C₁₋₄alkoxy, —C(O)C₁₋₆alkyl, —C(O)—O—C₁₋₄alkyl, halogen, hydroxyl, nitro and cyano;

R′ is independently selected, for each occurrence, from the group consisting of hydrogen, substituted or unsubstituted aliphatic, and substituted or unsubstituted heteroaliphatic;

Q¹ and Q^{1A} are independently selected, for each occurrence, from the group consisting of —NHR′, —SH, —OH, —O—C₁₋₆alkyl, —S—C₁₋₆alkyl, —O-aryl, —S-aryl, heteroaryl, —O-heteroaryl, —S-heteroaryl, halogen and —O—C₁₋₆alkyl-NR^{a}R^{b};

R^{a} and R^{b} are independently selected, for each occurrence, from the group consisting of hydrogen and C₁₋₄alkyl; wherein C₁₋₄alkyl may be optionally substituted by one or more substituents selected from the group consisting of halogen, cyano, oxo and hydroxyl; or

R^{a} and R^{b}, together with the nitrogen to which they are attached, may form a 4-7 membered heterocyclic ring, which may have an additional heteroatom selected from O, S, or N; wherein the 4-7 membered heterocyclic ring may be optionally substituted by one or more substituents selected from the group consisting of halogen, cyano, oxo and hydroxyl;

R¹ and R² are selected independently, for each occurrence, from the group consisting of —OH, C₁₋₆alkyl, —O—C₁₋₆alkyl, C₂₋₆alkenyl, C₃₋₆cycloalkyl, —C₁₋₆alkyl-NR^{a}R^{b}, phenyl and heteroaryl; wherein C₁₋₆alkyl, C₂₋₆alkenyl, C₃₋₆cycloalkyl, R^{a}, R^{b}, phenyl and heteroaryl, independently selected, for each occurrence, may be optionally substituted by one or more substituents selected from the group consisting of halogen, cyano, hydroxyl, C₁₋₆alkyl, and phenyl;

W^{2A} is selected from the group consisting of N and CR^{W2A}.

R^{W2A} is selected from the group consisting of hydrogen, C₁₋₄alkyl, —O—C₁₋₄alkyl, C₂₋₆alkenyl, C₂₋₆alkynyl, C₃₋₆cycloalkyl, phenyl and heteroaryl; wherein C₁₋₄alkyl, C₂₋₆alkenyl, C₂₋₆alkynyl, C₃₋₆cycloalkyl, phenyl and heteroaryl may be optionally substituted independently, for each occurrence, with one, two, three or more substituents selected from the group consisting of halogen, hydroxyl and cyano;

BB, independently for each occurrence, is a 4-7-membered cycloalkyl, heterocyclic, aryl, or heteroaryl moiety; wherein the cycloalkyl, heterocyclic, aryl, or heteroaryl moiety may be optionally substituted with one, two, three or more groups represented by R^{BB}; wherein R¹, independently for each occurrence, may be optionally bonded to BB;

each R^{BB} is independently selected, for each occurrence, from the group consisting of hydrogen, halogen, nitro, cyano, hydroxyl, amino, thio, —COOH, —CONHR′, substituted or unsubstituted aliphatic, substituted or unsubstituted heteroaliphatic; or two R^{BB} together with the atoms to which they are attached may form a fused 5- or 6-membered cycloalkyl or heterocyclic bicyclic ring system.

In another embodiment, provided here is a first monomer capable of forming a biologically useful multimer when in contact with one, two or more second monomers in an aqueous media, wherein the first monomer is represented by the formula:

X¹—Y¹—Z¹ (Formula I′″)

and pharmaceutically acceptable salts, stereoisomers, metabolites and hydrates thereof, wherein
X¹ is a first ligand moiety capable of binding to and modulating a first biomolecule (e.g. protein) segment;
Y¹ is absent or is a connector moiety covalently bound to X¹ and Z¹;
Z¹ is an activated n-moiety; and

the second monomer has a nucleophile moiety capable of binding with the Z¹ moiety of Formula I′″ to form the multimer. In an embodiment, the second monomer may be represented by Formula X²—Y²—Z² (Formula II′″), and pharmaceutically acceptable salts, stereoisomers, metabolites and hydrates thereof, wherein X² is a second ligand moiety capable of binding to and modulating a second biomolecule (e.g. protein) segment; Y² is absent or is a connector moiety covalently bound to X² and Z²; and Z² is the nucleophile moiety.

For example, Z¹ of Formula I′″ may be independently selected from the group consisting of:

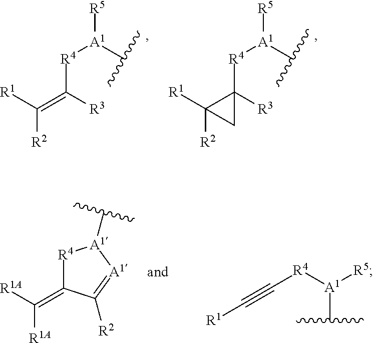

wherein

R¹ and R² are selected, independently for each occurrence, from the group consisting of hydrogen, halo, C₁₋₆alkyl, C₂₋₆alkenyl, C₂₋₆alkynyl, C₃₋₆cycloalkyl, phenyl and heteroaryl; wherein C₁₋₆alkyl, C₂₋₆alkenyl, C₂₋₆alkynyl, C₃₋₆cycloalkyl, phenyl and heteroaryl are optionally substituted with one, two, three or more substituents selected from R^{a};

R^{1A} is selected, independently for each occurrence, from the group consisting of hydrogen, halo, hydroxyl, C₁₋₆alkyl, —O—C₁₋₆alkyl, —NR³R³, C₂₋₆alkenyl, C₂₋₆alkynyl, C₃₋₆cycloalkyl, phenyl and heteroaryl; wherein C₁₋₆alkyl, C₂₋₆alkenyl, C₂₋₆alkynyl, C₃₋₆cycloalkyl, phenyl and heteroaryl are optionally substituted with one, two, three or more substituents selected from R^{a};

R^{a} is independently selected, for each occurrence, from the group consisting of halogen, hydroxyl, C₁₋₆alkyl, C₂₋₆alkenyl, C₃₋₆cycloalkyl, phenyl, heteroaryl, C₁₋₄alkoxy, C(O)C₁₋₆alkyl, C(O)C₁₋₄alkoxy, C(O)NR′R′, sulfonamide, nitro, carboxyl and cyano; wherein C₁₋₆alkyl, C₂₋₆alkenyl, C₃₋₆cycloalkyl, phenyl, heteroaryl, C₁₋₄alkoxy, C(O)C₁₋₆alkyl, C(O)C₁₋₄alkoxy and C(O)NR′R′ are optionally substituted independently, for each occurrence, with one, two, three or more substituents from the group consisting of halogen, hydroxyl, nitro and cyano;

R′ is independently selected, for each occurrence, from the group consisting of H, halogen, hydroxyl, cyano, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;

R³ is independently selected, for each occurrence, from the group consisting of hydrogen, and C₁₋₄alkyl; wherein R³ is optionally substituted with one or more substituents selected from R^{a}

R⁴ is independently selected, for each occurrence, from the group consisting of —C(O)—, —C(NR′)—, —SO₂— and —P(O)(OR′)—;

A¹ is independently selected, for each occurrence, from the group consisting of CH, N, and O;

A^{1′} is independently selected, for each occurrence, from the group consisting of CH and N;

R⁵ is independently selected, for each occurrence, from the group consisting of hydrogen and C₁₋₄alkyl; wherein if A¹ is O, there is no R⁵ substitution; or

R¹ and R⁵ may be taken with the atoms to which they are attached to form a 5-7 membered heterocycle; wherein the 5-7 membered heterocycle may optionally have 1 or 2 moieties from the group consisting of oxo, imino and sulfanylidene;

R³ and R⁵ may be taken together with the atoms to which they are attached to form a 4-7 membered heterocycle; wherein the 4-7 membered heterocycle may be substituted by one, two, three or more substituents from the group R^{a}; and wherein two

R^{a} substituents may be taken together with the atoms to which they are attached to form

a fused aliphatic or heteroaliphatic ring; and

the second monomer has said nucleophile moiety capable of binding with the Z¹ moiety of Formula I′″ to form the multimer.

Z² of Formula II′″ may be independently selected, for each occurrence, from the group consisting of:

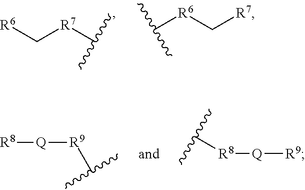

wherein
R⁶ is independently selected, for each occurrence, from the group consisting of hydrogen, C₁₋₄alkyl, phenyl, heteroaryl, C(O)NR^{b}R^{b}, and R⁷; wherein C₁₋₄alkyl, phenyl and heteroaryl are optionally substituted independently, for each occurrence, with R^{b}.
R^{b} is independently selected, for each occurrence, from the group consisting of H, halogen, hydroxyl, cyano, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
R⁷ is independently selected, for each occurrence, from the group consisting of C(O)—C₁₋₄alkyl, C(O)-phenyl, C(O)-heteroaryl, CO₂—C₁₋₄alkyl, CO₂-phenyl, CHO, cyano and nitro;
R⁸ and R⁹ are independently selected, for each occurrence, from the group consisting of hydrogen, C₁₋₄alkyl, phenyl, and heteroaryl; wherein C₁₋₄alkyl, phenyl and heteroaryl are optionally substituted independently, for each occurrence, with R_{b};
   Q is independently selected, for each occurrence, from the group consisting of —O—, —S—, and —NR^{b}—.

In another embodiment, provided herein is a first monomer capable of forming a biologically useful multimer when in contact with one, two or more second monomers in an aqueous media, wherein the first monomer is represented by the formula: X¹—Y¹—Z¹ (Formula I″″) and pharmaceutically acceptable salts, stereoisomers, metabolites and hydrates thereof, wherein X¹ is a first ligand moiety capable of binding to and modulating a first biomolecule (e.g. protein) segment; Y¹ is absent or is a connector moiety covalently bound to X¹ and Z¹; and Z¹ comprises one, two or more moieties from the group consisting of alkynyl, akenyl, oxo and imino; and the second monomer has a nucleophile moiety capable of binding with the Z¹ moiety of Formula I″″ to form the multimer In an embodiment, the second monomer may be represented by Formula X²—Y²—Z² (Formula II″″), and pharmaceutically acceptable salts, stereoisomers, metabolites and hydrates thereof, wherein X² is a second ligand moiety capable of binding to and modulating a second biomolecule (e.g. protein) segment; Y² is absent or is a connector moiety covalently bound to X² and Z²; and Z² is the nucleophile moiety.

For example, Z¹ may be independently selected from the group consisting of:

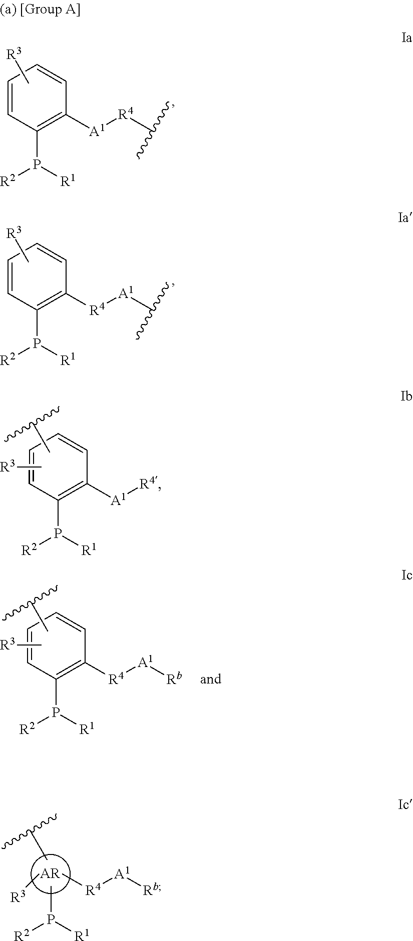

wherein
R¹ and R² are selected independently, for each occurrence, from the group consisting of C₁₋₆alkyl, C₂₋₆alkenyl, C₃₋₆cycloalkyl, phenyl and heteroaryl; wherein R¹ and R² are optionally substituted independently, for each occurrence, with one, two, three or more substituents selected from R^{a};
R^{a} is independently selected, for each occurrence, from the group consisting of halogen, hydroxyl, C₁₋₆alkyl, C₂₋₆alkenyl, C₃₋₆cycloalkyl, phenyl, heteroaryl, —O—C₁₋₆alkyl, —NR′R′, —C(O)C₁₋₆alkyl, —C(O)—O—C₁₋₆alkyl, —C(O)NR′R′, sulfonamide, nitro, carboxyl and cyano; wherein C₁₋₆alkyl, C₂₋₆alkenyl, C₃₋₆cycloalkyl, phenyl, heteroaryl, and R′ are optionally substituted independently, for each occurrence, with one, two, three or more substituents from the group consisting of halogen, hydroxyl, nitro and cyano;
R′ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
R³ is independently selected, for each occurrence, from the group consisting of hydrogen and R^{a};
A¹ is independently selected, for each occurrence, from the group consisting of —NH—, —NR′—, —S— and —O—;
R⁴ is independently selected, for each occurrence, from the group consisting of —C(O)—, —C(NR′)—, —C(S)— and —SO₂—;
R^{4′} is independently selected, for each occurrence, from the group consisting of C(O)R′, C(NR′)R′, C(S)R′ and SO₂R′;
R^{b} is independently selected, for each occurrence, selected from the group consisting of H and C₁₋₄alkyl; wherein C₁₋₄alkyl is optionally substituted independently, for each occurrence, with one, two, three or more substituents from the group consisting of halogen, hydroxyl, nitro, cyano, C₁₋₄alkyl, C₂₋₆alkenyl and phenyl;
AR is a 5- or 6-membered aromatic, heteroaromatic, or partially aromatic heterocyclic ring; wherein the phosphorus and R⁴ substitutents have 1, 2 positions on the ring; wherein the heteroaromatic and partially aromatic heterocyclic rings may optionally have 1, 2 or more heteroatoms selected from O, S, or N; wherein the aromatic, heteroaromatic, or partially aromatic heterocyclic rings may be optionally substituted with one, two, three or more groups represented by R^{AR};
each R^{AR} is independently selected, for each occurrence, from the group consisting of hydrogen, halogen, nitro, cyano, hydroxyl, oxo, amino, thio, —COOH, —CONHR′, substituted or unsubstituted aliphatic, and substituted or unsubstituted heteroaliphatic; or two R^{AR} together with the atoms to which they are attached form a fused 5- or 6-membered cycloalkyl or heterocyclic bicyclic ring system, optionally substituted independently, for each occurrence, with one, two, three or more substituents from R′; and

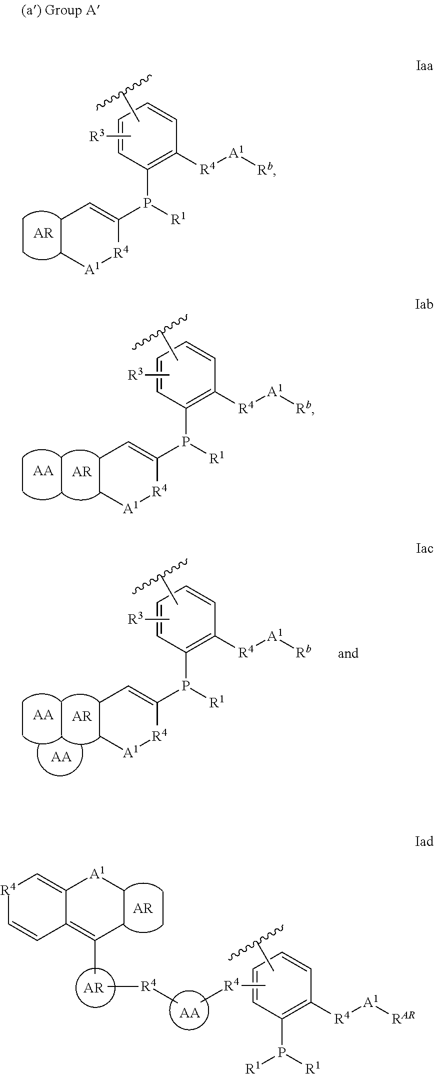

wherein
R¹ is selected independently, for each occurrence, from the group consisting of C₁₋₆alkyl, C₂₋₆alkenyl, C₃₋₆cycloalkyl, phenyl and heteroaryl; wherein R¹ is optionally substituted independently, for each occurrence, with one, two, three or more substituents selected from R^{a};
R^{a} is independently selected, for each occurrence, from the group consisting of halogen, hydroxyl, C₁₋₆alkyl, C₂₋₆alkenyl, C₃₋₆cycloalkyl, phenyl, heteroaryl, —O—C₁₋₆alkyl, —NR′R′, —C(O)C₁₋₆alkyl, —C(O)—O—C₁₋₆alkyl, —C(O)NR′R′, sulfonamide, nitro, carboxyl and cyano; wherein C₁₋₆alkyl, C₂₋₆alkenyl, C₃₋₆cycloalkyl, phenyl, heteroaryl, and R′ are optionally substituted independently, for each occurrence, with one, two, three or more substituents from the group consisting of halogen, hydroxyl, nitro and cyano;
R′ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
R³ is independently selected, for each occurrence, from the group consisting of hydrogen and R^{a};
A¹ is independently selected, for each occurrence, from the group consisting of —NH—, —NR′—, —S— and —O—;
R⁴ is independently selected, for each occurrence, from the group consisting of —C(O)—, —C(NR′)—, —C(S)— and —SO₂—;
R^{b} is independently selected, for each occurrence, selected from the group consisting of H and C₁₋₄alkyl; wherein C₁₋₄alkyl is optionally substituted independently, for each occurrence, with one, two, three or more substituents from the group consisting of halogen, hydroxyl, nitro, cyano, C₁₋₄alkyl, C₂₋₆alkenyl and phenyl;
AR is a 5- or 6-membered aromatic, heteroaromatic, or partially aromatic heterocyclic ring; wherein the heteroaromatic and partially aromatic heterocyclic rings may optionally have 1, 2 or more heteroatoms selected from O, S, or N; wherein the aromatic, heteroaromatic, or partially aromatic heterocyclic rings may be optionally substituted with one, two, three or more groups represented by R^{AR};
R^{AR} is independently selected, for each occurrence, from the group consisting of hydrogen, halogen, nitro, cyano, hydroxyl, oxo, amino, thio, —COOH, —CONHR′, substituted or unsubstituted aliphatic, and substituted or unsubstituted heteroaliphatic; or two R^{AR} together with the atoms to which they are attached form a fused 5- or 6-membered cycloalkyl or heterocyclic bicyclic ring system, optionally substituted independently, for each occurrence, with one, two, three or more substituents from R′;
AA is a 5- or 6-membered aliphatic, heteroaliphatic, aromatic, heteroaromatic, or partially aromatic heterocyclic ring; wherein AA may optionally have 1, 2 or more heteroatoms selected from O, S, or N; and wherein AA may be optionally substituted with one, two, three or more groups represented by R^{AR}; and

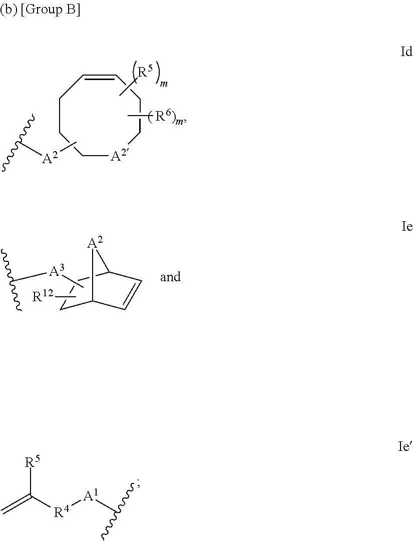

wherein
R⁵, R⁶ and R¹² are selected independently, for each occurrence, from the group consisting of hydrogen, halogen, hydroxyl, C₁₋₄alkyl, C₃₋₆cycloalkyl, phenyl, heteroaryl, —O—C₁₋₄alkyl, —C(O)C₁₋₄alkyl, —C(O)—O—C₁₋₄alkyl, —C(O)NR″R″, sulfonamide, nitro, carboxyl and cyano; wherein C₁₋₄alkyl is optimally substituted with one, two, three, or more halogens; wherein C₁₋₄alkyl, C₃₋₆cycloalkyl, phenyl, heteroaryl and R′ are optionally substituted independently, for each occurrence, with one, two, three or more substituents from the group consisting of halogen, hydroxyl, nitro and cyano; and wherein R⁵ and R⁶ may be taken together with the atoms to which they are attached to form a fused phenyl, 5-7 membered heteroaliphatic ring system, or 5-7 membered heteroaryl ring system;
m is 0, 1, 2, 3 or more;
R⁴ is independently selected, for each occurrence, from the group consisting of —C(O)—, —C(NR″)—, —C(S)— and —SO₂—;
A¹, independently for each occurrence, is (a) absent or (b) selected from the group consisting of —NH—, —NR″— and —O—; wherein A¹ and R⁵ may be taken together with the atoms to which they are attached to form a 5-7 membered heterocyclic ring system;
A² and A²′ are independently selected, for each occurrence, from the group consisting of —CH₂—, —CHR′—, —CR′R′—, —NH—, —NR″— and —O—;
R′ is independently selected, for each occurrence, from the group consisting of H, halogen, hydroxyl, cyano, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
R″ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
A³ is independently selected, for each occurrence, from the group consisting of —CH₂C(O)NH—, —CH₂SO₂NH—, and A²; and

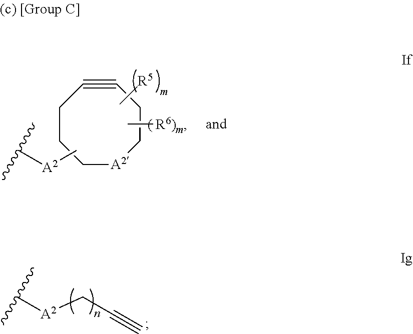

wherein
R⁵ and R⁶ are selected independently, for each occurrence, from the group consisting of hydrogen, halogen, hydroxyl, C₁₋₄alkyl, C₃₋₆cycloalkyl, phenyl, heteroaryl, —O—C₁₋₄alkyl, —C(O)C₁₋₄alkyl, —C(O)—O—C₁₋₄alkyl, —C(O)NR″R″, sulfonamide, nitro, carboxyl and cyano; wherein C₁₋₄alkyl is optimally substituted with one, two, three, or more halogens; wherein C₁₋₄alkyl, C₃₋₆cycloalkyl, phenyl, heteroaryl and R″ are optionally substituted independently, for each occurrence, with one, two, three or more substituents from the group consisting of halogen, hydroxyl, nitro and cyano; and wherein R⁵ and R⁶ may be taken together with the atoms to which they are attached to form a fused phenyl, 5-7 membered heteroaliphatic ring system, or 5-7 membered heteroaryl ring system;
m is 0, 1, 2, 3 or more;
A² and A²′ are independently selected, for each occurrence, from the group consisting of —CH₂—, —CHR′—, —CR′R′—, —NH—, —NR″— and —O—;
R′ is independently selected, for each occurrence, from the group consisting of H, halogen, hydroxyl, cyano, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
R″ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
n is independently selected from 0, 1, 2, 3, 4, 5 or 6; and

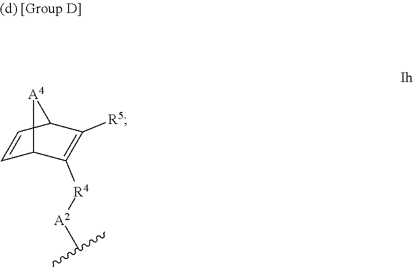

wherein
A⁴ is independently selected, for each occurrence, from the group consisting of —CH₂— and —O—;
R⁵ is selected from the group consisting of hydrogen, halogen, hydroxyl, C₁₋₄alkyl, C₃₋₆cycloalkyl, phenyl, heteroaryl, —O—C₁₋₄alkyl, —C(O)C₁₋₄alkyl, —C(O)—O—C₁₋₄alkyl, —C(O)NR″R″, sulfonamide, nitro, carboxyl and cyano; wherein C₁₋₄alkyl is optimally substituted with one, two, three, or more halogens; wherein C₁₋₄alkyl, C₃₋₆cycloalkyl, phenyl, heteroaryl and R″ are optionally substituted independently, for each occurrence, with one, two, three or more substituents from the group consisting of halogen, hydroxyl, nitro and cyano;
A² is independently selected, for each occurrence, from the group consisting of —CH₂—, —CHR′—, —CR′R′—, —NH—, —NR″— and —O—;
R′ is independently selected, for each occurrence, from the group consisting of H, halogen, hydroxyl, cyano, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;

R″ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
R⁴ is independently selected, for each occurrence, from the group consisting of —C(O)—, —C(NR″)—, —C(S)— and —SO₂—; and

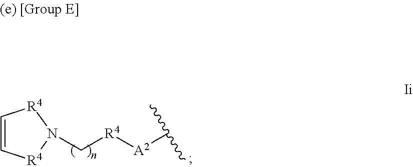

wherein
R⁴ is independently selected, for each occurrence, from the group consisting of —C(O)—, —C(NR″)—, —C(S)— and —SO₂—;
n is 0, 1, 2, 3, 4, 5, 6 or more;
A² is independently selected, for each occurrence, from the group consisting of —CH₂—, —CHR′—, —CR′R′—, —NH—, —NR″— and —O—;
R′ is independently selected, for each occurrence, from the group consisting of H, halogen, hydroxyl, cyano, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
R″ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl; and

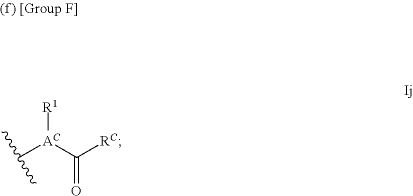

wherein
R^{C} is selected from the group consisting of hydrogen and C₁₋₄alkyl; wherein C₁₋₄alkyl is optionally substituted independently, for each occurrence, with one, two, three or more substituents from the group consisting of halogen, hydroxyl, nitro, cyano, C₁₋₄alkyl, —O—C₁₋₄alkyl, —NH₂, —NH(C₁₋₄alkyl), —N(C₁₋₄alkyl)₂, phenyl and heterocycle;
A^{C} is selected from the group consisting of N and CH;
R¹ is selected from the group consisting of C₁₋₆alkyl, C₂₋₆alkenyl, C₃₋₆cycloalkyl, phenyl and heteroaryl; wherein R¹ is optionally substituted independently, for each occurrence, with one, two, three or more substituents selected from R^{a};
R^{a} is independently selected, for each occurrence, from the group consisting of halogen, hydroxyl, C₁₋₆alkyl, C₂₋₆alkenyl, C₃₋₆cycloalkyl, phenyl, heteroaryl, C₁₋₆alkyl, C(O)C₁₋₆alkyl, C(O)—O—C₁₋₆alkyl, C(O)NR′R′, sulfonamide, nitro, carboxyl and cyano; wherein C₁₋₆alkyl, C₂₋₆alkenyl, C₃₋₆cycloalkyl, phenyl, heteroaryl and R′ are optionally substituted independently, for each occurrence, with one, two, three or more substituents from the group consisting of halogen, hydroxyl, nitro and cyano;
R′ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl; and

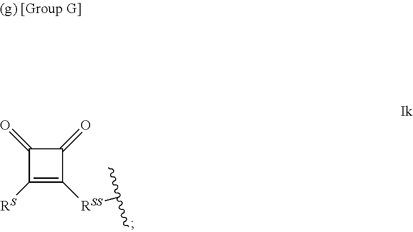

wherein
R^{S} is independently selected, for each occurrence, from the group consisting of hydroxyl, C₁₋₄alkyl, phenyl, heteroaryl, —O—C₁₋₄alkyl, C(O)—C₁₋₄alkyl, C(O)—O—C₁₋₄alkyl, nitro, carboxyl and cyano; wherein C₁₋₄alkyl, phenyl and heteroaryl are optionally substituted independently, for each occurrence, with one, two, three or more substituents from the group consisting of halogen, hydroxyl and cyano;

R^{SS} is independently selected, for each occurrence, from the group consisting of —O—, —NH—, —N(C₁₋₄alkyl)-, —C₁₋₄alkyl-, -phenyl-, -heteroaryl-, —O—C₁₋₄alkyl-, —C(O)—C₁₋₄alkyl-, and —C(O)—O—C₁₋₄alkyl-; wherein C₁₋₄alkyl, phenyl and heteroaryl are optionally substituted independently, for each occurrence, with one, two, three or more substituents from the group consisting of halogen, hydroxyl and cyano; and the second monomer independently, for each occurrence, has an aza moiety or oxime moiety capable of binding with the Z¹ moiety of Formula I″″ to form the multimer.

Wherein Z² may be independently selected, for each occurrence, from the group consisting of:

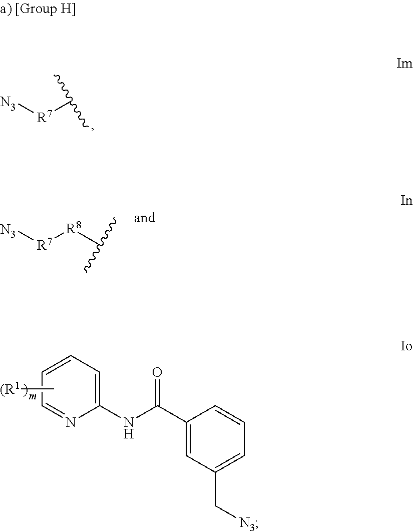

wherein
R⁷ is independently selected, for each occurrence, from the group consisting of C₁₋₄alkyl, C₃₋₆cyclo alkyl, phenyl, heteroaryl, —C(O)—, —SO₂—, —P(O)—, —C(O)NR^{c}—, —PR^{s}—, and —SiR^{c}R^{c}—; wherein C₁₋₄alkyl may be optionally substituted by C₁₋₆alkyl-CO₂R^{c}; wherein C₁₋₄alkyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
R^{c} is independently selected, for each occurrence, from the group consisting of H, halogen, hydroxyl, cyano, C₁₋₄alkyl, C₂₋₆alkenyl, cycloalkyl, cycloalkenyl, phenyl and heteroaryl;
R⁸ is independently selected, for each occurrence, from the group consisting of O, S, NR^{c}, CO₂, and C(O)NR^{c};
R¹ is selected independently, for each occurrence, from the group consisting of C₁₋₆alkyl, C₂₋₆alkenyl, C₃₋₆cycloalkyl, phenyl and heteroaryl; wherein R¹ is optionally substituted independently, for each occurrence, with one, two, three or more substituents selected from R^{a};
R^{a} is independently selected, for each occurrence, from the group consisting of halogen, hydroxyl, C₁₋₆alkyl, C₂₋₆alkenyl, C₃₋₆cycloalkyl, phenyl, heteroaryl, C₁₋₄alkoxy, C(O)C₁₋₆alkyl, C(O)C₁₋₄alkoxy, C(O)NR′R′, sulfonamide, nitro, carboxyl and cyano; wherein C₁₋₆alkyl, C₂₋₆alkenyl, C₃₋₆cycloalkyl, phenyl, heteroaryl, C₁₋₄alkoxy, C(O)C₁₋₆alkyl, C(O)C₁₋₄alkoxy and C(O)NR′R′ are optionally substituted independently, for each occurrence, with one, two, three or more substituents from the group consisting of halogen, hydroxyl, nitro and cyano;
R′ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl; and

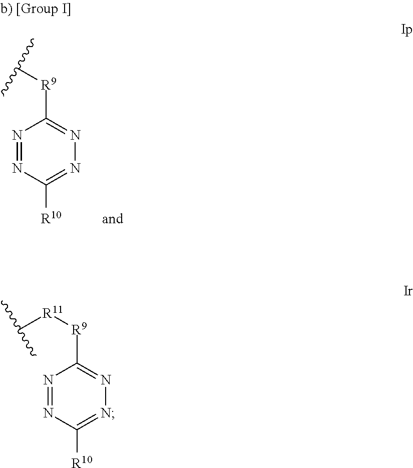

wherein
R⁹ is independently selected, for each occurrence, from the group consisting of C₁₋₆alkyl, C₃₋₆cycloalkyl, phenyl, heteroaryl, C₁₋₄alkoxy, C(O)C₁₋₆alkyl, C(O)C₁₋₄alkoxy, C(O)NR″R″ and sulfonamide; wherein C₁₋₆alkyl, C₃₋₆cycloalkyl, phenyl, heteroaryl, C₁₋₄alkoxy, and R″ are optionally substituted independently, for each occurrence, with one, two, three or more substituents from the group consisting of halogen, hydroxyl, nitro and cyano;
R″ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
R¹⁰ is independently selected, for each occurrence, from the group consisting of hydrogen and R⁹;
R¹¹ is independently selected, for each occurrence, from the group consisting of —CH₂—, —CHR′—, —CR′R′—, —NH—, —NR″— and —O—;
R′ is independently selected, for each occurrence, from the group consisting of H, halogen, cyano, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl; and

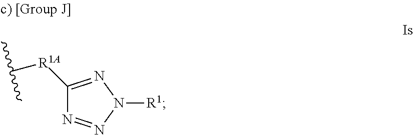

wherein
R¹ is selected from the group consisting of C₁₋₆alkyl, C₂₋₆alkenyl, C₃₋₆cycloalkyl, phenyl and heteroaryl; wherein R¹ is optionally substituted independently, for each occurrence, with one, two, three or more substituents selected from R^{a};
R^{1A} is selected from the group consisting of —C₁₋₆alkyl-, —C₂₋₆alkenyl-, —C₃₋₆cycloalkyl-, -phenyl- and -heteroaryl-; wherein R^{1A} is optionally substituted independently, for each occurrence, with one, two, three or more substituents selected from R^{a};
R^{a} is independently selected, for each occurrence, from the group consisting of halogen, hydroxyl, C₁₋₆alkyl, C₂₋₆alkenyl, C₃₋₆cycloalkyl, phenyl, heteroaryl, —O—C₁₋₆alkyl, C(O)C₁₋₆alkyl, C(O)—O—C₁₋₆alkyl, C(O)NR′R′, sulfonamide, nitro, carboxyl and cyano; wherein C₁₋₆alkyl, C₂₋₆alkenyl, C₃₋₆cycloalkyl, phenyl, heteroaryl and R′ are optionally substituted independently, for each occurrence, with one, two, three or more substituents from the group consisting of halogen, hydroxyl, nitro and cyano;
R′ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl; and

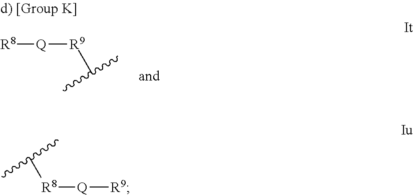

wherein
R⁸ and R⁹ are independently selected, for each occurrence, from the group consisting of hydrogen, C₁₋₄alkyl, phenyl, and heteroaryl; wherein C₁₋₄alkyl, phenyl and heteroaryl are optionally substituted independently, for each occurrence, with R^{b};
R^{b} is independently selected, for each occurrence, from the group consisting of H, halogen, hydroxyl, cyano, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
Q is independently selected, for each occurrence, from the group consisting of —O—, —S—, and —NR^{b}′—;
R^{b′} is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl; and

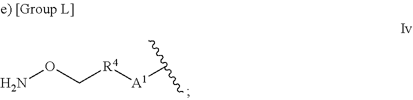

wherein
A¹ is independently selected, for each occurrence, from the group consisting of —NH—, —NR′— and —O—;
R⁴ is independently selected, for each occurrence, from the group consisting of —C(O)—, —C(NR′)—, —C(S)— and —SO₂—;
R′ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl; and

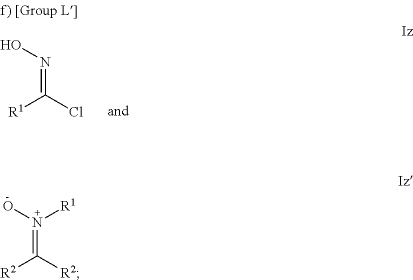

wherein
R¹ is independently selected, for each occurrence, from the group consisting of C₁₋₆alkyl, C₂₋₆alkenyl, C₃₋₆cycloalkyl, phenyl and heteroaryl; wherein R¹ is optionally substituted independently, for each occurrence, with one, two, three or more substituents selected from R^{a};
R² is independently selected, for each occurrence, from the group consisting of hydrogen, C₁₋₆alkyl, C₂₋₆alkenyl, C₃₋₆cycloalkyl, phenyl and heteroaryl; wherein C₁₋₆alkyl, C₂₋₆alkenyl, C₃₋₆cycloalkyl, phenyl and heteroaryl are optionally substituted independently, for each occurrence, with one, two, three or more substituents selected from R^{a};
R^{a} is independently selected, for each occurrence, from the group consisting of halogen, hydroxyl, C₁₋₆alkyl, C₂₋₆alkenyl, C₃₋₆cycloalkyl, phenyl, heteroaryl, C₁₋₄alkoxy, C(O)C₁₋₆alkyl, C(O)C₁₋₄alkoxy, C(O)NR′R′, sulfonamide, nitro, carboxyl and cyano; wherein C₁₋₆alkyl, C₂₋₆alkenyl, C₃₋₆cycloalkyl, phenyl, heteroaryl, C₁₋₄alkoxy, C(O)C₁₋₆alkyl, C(O)C₁₋₄alkoxy and C(O)NR′R′ are optionally substituted independently, for each occurrence, with one, two, three or more substituents from the group consisting of halogen, hydroxyl, nitro and cyano; R′ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl.
Z² of Formula II″″ be independently selected, for each occurrence, from the group consisting of:

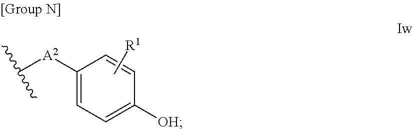

wherein
R¹ is selected from the group consisting of C₁₋₆alkyl, C₂₋₆alkenyl, C₃₋₆cycloalkyl, phenyl and heteroaryl; wherein R¹ is optionally substituted independently, for each occurrence, with one, two, three or more substituents selected from R^{a};
R^{a} is independently selected, for each occurrence, from the group consisting of halogen, hydroxyl, C₁₋₆alkyl, C₂₋₆alkenyl, C₃₋₆cycloalkyl, phenyl, heteroaryl, C₁₋₄alkoxy, C(O)C₁₋₆alkyl, C(O)C₁₋₄alkoxy, C(O)NR″R″, sulfonamide, nitro, carboxyl and cyano; wherein C₁₋₆alkyl, C₂₋₆alkenyl, C₃₋₆cycloalkyl, phenyl, heteroaryl, C₁₋₄alkoxy and R″ are optionally substituted independently, for each occurrence, with one, two, three or more substituents from the group consisting of halogen, hydroxyl, nitro and cyano;
R″ is independently selected, for each occurrence, from the group consisting of H, hydroxyl, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl;
A² is independently selected, for each occurrence, from the group consisting of —CH₂—, —CHR′—, —CR′R′—, —NH—, —NR″— and —O—;
R′ is independently selected, for each occurrence, from the group consisting of H, halogen, hydroxyl, cyano, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl are optionally substituted independently, for each occurrence, with one, two, three or more substituents from the group consisting of halogen, hydroxyl, nitro, cyano, C₁₋₄alkyl, C₂₋₆alkenyl and phenyl; and

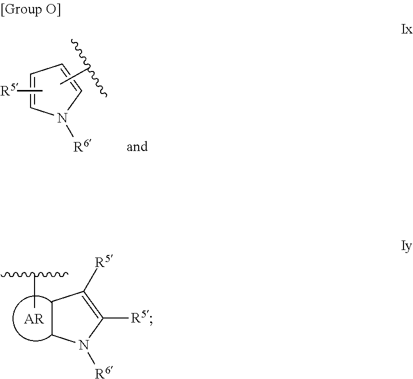

wherein
R^{5′} and R^{6′} are independently selected, for each occurrence, from the group consisting of hydrogen and C₁₋₄alkyl; wherein C₁₋₄alkyl is optionally substituted independently, for each occurrence, with one, two, three or more substituents from the group consisting of halogen, hydroxyl, C₁₋₄alkyl, C₁₋₄alkoxy, amino, oxo, C₂₋₆alkenyl and phenyl; and wherein the pyrrole ring may be optionally substituted independently, for each occurrence, with one, two or three groups represented by R^{5′};
AR is a fused 5- or 6-membered aromatic, heteroaromatic, or partially aromatic heterocyclic ring; wherein the heteroaromatic and partially aromatic heterocyclic rings may optionally have 1, 2 or more heteroatoms selected from O, S, or N; wherein the aromatic, heteroaromatic, or partially aromatic heterocyclic rings may be optionally substituted with one, two, three or more groups represented by R^{AR};
Each R^{AR} is independently selected, for each occurrence, from the group consisting of hydrogen, halogen, nitro, cyano, hydroxyl, oxo, amino, thio, —COOH, —CONHR′, substituted or unsubstituted aliphatic, and substituted or unsubstituted heteroaliphatic; or two R^{AR} together with the atoms to which they are attached form a fused 5- or 6-membered cycloalkyl or heterocyclic bicyclic ring system, optionally substituted independently, for each occurrence, with one, two, three or more substituents from R′; and

R′ is independently selected, for each occurrence, from the group consisting of hydrogen, halogen, hydroxyl, cyano, C₁₋₄alkyl, C₂₋₆alkenyl, C₃₋₆cycloalkyl, phenyl and heteroaryl; wherein C₁₋₄alkyl, C₂₋₆alkenyl, C₃₋₆cycloalkyl, phenyl and heteroaryl may be optionally substituted independently, for each occurrence, with one, two, three or more substituents from the group consisting of halogen, hydroxyl, nitro, cyano, C₁₋₄alkyl, C₂₋₆alkenyl and phenyl.

In some embodiments, a first monomer may be capable of forming a biologically useful trimer when in contact with a second monomer and a third monomer in an aqueous media, wherein the first monomer is represented by the formula: X₂—Y₂—Z₂ (Formula II) and pharmaceutically acceptable salts, stereoisomers, metabolites, and hydrates thereof, wherein
X₂ is a first ligand capable of binding to a first target biomolecule or protein segment;
Y₂ is absent or is a connector moiety covalently bound to X₂ and Z₂;
Z₂ is a first linker selected from the group consisting of:

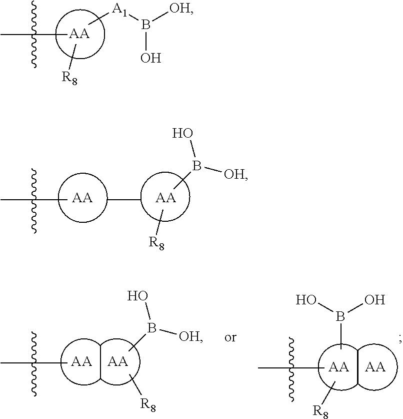

wherein
R₈ is selected from the group consisting of H, halogen, oxo, C₁₋₄alkyl optionally substituted by hydroxyl, amino, halo, or thio; C₂₋₄alkenyl, C₁₋₄alkoxy; —S—C₁₋₄alkyl; —CN; —COOH; or —CONHR′;
R′ is H or C₁₋₄alkyl;
A₁ is (a) absent; or (b) selected from the group consisting of acyl, substituted or unsubstituted aliphatic, or substituted or unsubstituted heteroaliphatic;
AA, independently for each occurrence, is phenyl, aryl, or a 5-7 membered heterocyclic or heteroaryl ring having one, two, or three heteroatoms, wherein AA is optionally substituted by one, two, or three substituents selected from the group consisting of halogen, C₁₋₄alkyl optionally substituted by hydroxyl, amino, halogen, or thio; C₂₋₄alkenyl, C₁₋₄alkoxy; —S—C₁₋₄alkyl; —CN; —COOH; —CONHR′; or two substituents together with the atoms to which they are attached form a fused 4-6 membered cycloalkyl or heterocyclic bicyclic ring system; and

the second monomer and the third monomer each have a boronic acid or oxaborole moiety capable of binding with the Z₂ moiety of Formula II to form the trimer.

In some embodiments, R₈ and the substituent comprising boronic acid may be ortho to each other, and R₈ may be —CH₂NH₂.

In some instances, Z₂ of the first monomer may be selected from the group consisting of:

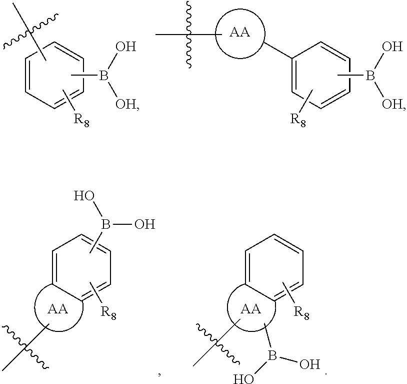

In certain instances, Z₂ of the first monomer may be selected from the group consisting of:

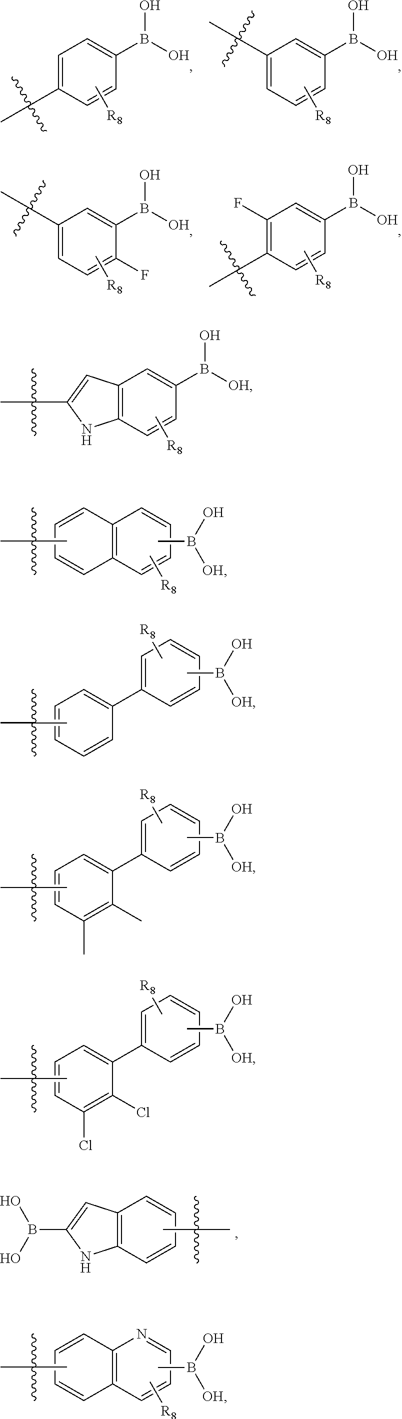

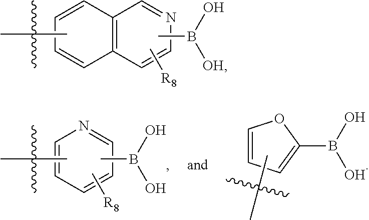

As discussed above, a monomer may be capable of reacting with one or more other monomers to form a multimer e.g., in an aqueous media, for example, in vivo. In some embodiments, a first monomer may react with a second monomer to form a dimer. In other embodiments, a first monomer may react with a second monomer and a third monomer to form a trimer. In still other embodiments, a first monomer may react with a second monomer, a third monomer, and a fourth monomer to form a tetramer. In some embodiments, each of the monomers that form a multimer may be essentially the same. In some embodiments, each of the monomers that form a multimer may be substantially different. In certain embodiments, at least some of the monomers that form a multimer may be essentially the same or may be substantially different.

In some embodiments, the linker element of a first monomer and the linker element of a second monomer may be substantially different. In other embodiments, the connector element of a first monomer and the connector element of a second monomer may be substantially different. In still other embodiments, the functional element (e.g., pharmacophore) of a first monomer and the functional element (e.g. pharmacophore) of the second monomer may be substantially different.

In some cases, formation of a multimer from a plurality of monomers may be irreversible. In some embodiments, formation of a multimer from a plurality of monomers may be reversible. For example, in some embodiments, the multimer may have an oligomer or dimer dissociation constant between 10 mM and 1 nM, in some embodiments between 1 mM and 100 nM, in some embodiments between 1 mM and 1 μM, and in some embodiments between 500 mM and 1 μM. In certain embodiments, the multimer may have a dissociation constant of less than 10 mM, in some embodiments less than 1 mM, in some embodiments less than 500 μM, in some embodiments less than 100 μM, in some embodiments less than 50 μM, in some embodiments less than 1 μM, in some embodiments less than 100 nM, and in some embodiments less than 1 nM.

### Connectors

The term “connector” is used herein to refer to an atom or a collection of atoms optionally used to link interconnecting moieties, such as a disclosed linker and a pharmacophore. Contemplated connectors are generally hydrolytically stable under aqueous conditions. In some embodiments, such connectors do not have significant binding or other affinity to an intended target.

In some embodiments, a monomer may comprise a connector that joins the functional element (e.g. pharmacophore) with the linker element. In some instances, such connectors do not have significant binding or other affinity to an intended target. However, in certain embodiments, a connector may contribute to the affinity of a functional element to a target.

In some embodiments, a connector element may be used to connect the linker element to the functional element. In some instances, the connector element may be used to adjust spacing between the linker element and the functional element. In some cases, the connector element may be used to adjust the orientation of the linker element and the functional element. In certain embodiments, the spacing and/or orientation the linker element relative to the functional element can affect the binding affinity of the functional element (e.g., a pharmacophore) to a target. In some cases, connectors with restricted degrees of freedom are preferred to reduce the entropic losses incurred upon the binding of a multimer to its biomolecular target and to promote cellular permeability of the monomer.

In some embodiments, the connector element may be used for modular assembly of monomers. For example, in some instances, a connector element may comprise a functional group formed from reaction of a first and second molecule. In some cases, a series of functional elements may be provided, where each functional element comprises a common functional group that can participate in a reaction with a compatible functional group on a linker element. In some embodiments, the connector element may comprise a spacer having a first functional group that forms a bond with a functional element and a second functional group that forms a bond with a linker element.

Contemplated connectors may be any acceptable, e.g. pharmaceutically and/or chemically acceptable bivalent connector that e.g., does not interfere with multimerization of the disclosed monomers. For example, such linkers may be or include C₁-C₁₀ alkylene, substituted alkylene, cycloalkylene, substituted cycloalkylene, aryl, and substituted aryl, heteroaryl, or substituted heteroaryl. For example, contemplated connectors may be a covalent bond or a bivalent C₁₋₁₀ saturated or unsaturated, straight or branched, hydrocarbon chain, wherein one, two, or three methylene units of the bivalent C₁₋₁₀ are are optionally and independently replaced by cyclopropylene, aryl (e.g. phenyl), heteroaryl, heterocyclic, —NR—, —N(R)C(O)—, —C(O)N(R)—, —N(R)SO₂—, —SO₇N(R)—, —O—, —C(O)—, —OC(O)—, —C(O)O—, —SO—, —SO₂—, —C(═S)—, —C(═NR)—, or —N═N—,

Contemplated connectors may include polymeric connectors, such a polyethylene glycol or other pharmaceutically acceptable polymers.

In some embodiments, a connector may be from about 7 atoms to about 13 atoms in length, or about 8 atoms to about 12 atoms, or about 9 atoms to about 11 atoms in length. For purposes of counting connector length when a ring is present in the connector group, the ring is counted as three atoms from one end to the other. In another embodiment, a connector group is from about 6 Å to about 12 Å in length. In some embodiments, a spacer group is from about 5 Å to about 11 Å in length. In some embodiments, a spacer group is from about 6 Å to about 9 Å in length. In some cases, connectors with restricted degrees of freedom are preferred to reduce the entropic losses incurred upon the binding of a multimer to its biomolecular target and to promote cellular permeability of the monomer.

### Pharmacophores

A pharmacophore is typically an arrangement of the substituents of a moiety that confers biochemical or pharmacological effects. Typically, identification of a pharmacophore requires that the structure of the ligand in association with a target macromolecule be known or that significant SAR has been established or both.

### Methods

In certain embodiments, a disclosed monomer, dimer, or multimer utilized by one or more of the foregoing methods may be one of the generic, subgeneric, or specific compounds described herein. It will be appreciated that a disclosed monomer can be administered in a composition that includes another monomer or monomers such that when combined in an aqueous media (e.g., under certain conditions, e.g. physiological conditions or in vivo) the monomer or monomers are capable of forming a multimer (e.g. a multimer that binds to two or more domains on a biomolecule, or to one domain on one biomolecule and one domain on another biomolecule.

For example, provided herein is a method of treating a hematologic malignancy in a patient in need thereof comprising: administering to said patient a first monomer and a second monomer, wherein the first monomer is represented by:

X₁—Y₁—Z₁ (Formula I)
and pharmaceutically acceptable salts, stereoisomers, metabolites and hydrates thereof, wherein
X₁ is a first non-peptidyl pharmacophore capable of binding to a first target protein segment on the N-terminal portion of an oncology fusion protein;
Y₁ is absent or is a connector moiety covalently bound to X₁ and Z₁;
Z₁ is a first linker capable of binding to a second monomer; and
   the second monomer is represented by:

X₂—Y₂—Z₂ (Formula II),

wherein

X₂ is a second non-peptidyl pharmacophore capable of binding to a second target protein segment on the C-terminal portion of an oncology fusion protein,
Y₂ is absent or is a connector moiety covalently bound to X₂ and Z₂
Z₂ is a first linker capable of binding to the first monomer through Z₁;

wherein upon administration, said first monomer and said second monomer forms a multimer in vivo that binds to the first target protein domain and the second target protein domain.

For example, the first monomer and the second monomer may be administered substantially sequentially, or may be administered substantially simultaneously. In some embodiments, the monomer may be administered, sequentially or simultaneously, by different routes of administration. Contemplated hematologic malignancy include those selected from the group consisting of chronic myeloid leukemia, acute myeloid leukemia, acute lymphoblastic leukemia, acute promyelocytic leukemia, mantle cell lymphoma, Burkitt's lymphoma, anaplastic large T-cell lymphoma, diffuse large B-Cell lymphoma, small lymphatic lymphoma, acute megakaryoblastic leukemia, and multiple myeloma. Contemplated first target binding domain and/or the second target binding domain include a tyrosine kinase protein domain selected from the group consisting of ABL1, ABL2, ROS1, PDGFR-A, PDGFR-B, PDGFR-C, PDGFR-D, NTRK, SYK, BRAF, REF, ALK, hepatocyte growth factor receptor, JAK2, JAK3, JAK1, and fibroblast growth factor receptor. In another embodiment, the oncology fusion protein includes a CBP or p300 protein portion, and the first target binding domain or the second target binding domain is selected from the group consisting of nuclear receptor interaction domain, KIX domain, CH1, CH2, IBiD, PAT, HAT, CCND1, and bromo domain.

For example, contemplated herein is a method of treating a patient in need thereof for lymphoma, as described above, wherein oncology fusion protein includes a protein portion selected from the group consisting of ALK, API2, MALT1, for example, wherein the oncology fusion protein is API2-MALT1. In another embodiment, the hematologic malignancy is chronic myeloid leukemia, and the oncology fusion protein is BCR-ABL1. In yet another embodiment, the hematologic malignancy is acute megakaryoblastic leukemia, and the oncology fusion protein is RBM15-MKL1. Also contemplated is a method for treating a patient suffering from large T-cell lymphoma leukemia, wherein oncology fusion protein is NPM1-ALK. Another exemplary hematologic malignancy is Burkitt lymphoma, wherein the oncology fusion gene is IGH@-MYC, acute myeloid leukemia wherein oncology fusion protein is RUNX1-RUNX1T1, multiple myeloma, wherein oncology fusion gene is IGH@-MAF, or acute promyelocytic leukemia wherein oncology fusion protein is PML-RARA.

In another embodiment, provided herein is a method of treating a solid tumor cancer in a patient in need thereof, comprising administering to said patient a first monomer represented by:
X₁ is a first non-peptidyl pharmacophore capable of binding to a first target protein segment on the N-terminal portion of an oncology fusion protein;
Y₁ is absent or is a connector moiety covalently bound to X₁ and Z₁;
Z₁ is a first linker capable of binding to a second monomer; and the second monomer is represented by:

X₂—Y₂—Z₂ (Formula II),
wherein
X₂ is a second non-peptidyl pharmacophore capable of binding to a second target protein segment on the C-terminal portion of an oncology fusion protein,
Y₂ is absent or is a connector moiety covalently bound to X₂ and Z₂
Z₂ is a first linker capable of binding to the first monomer through Z₁;
   wherein upon administration, said first monomer and said second monomer forms a multimer in vivo that binds to the first target protein domain and the second target protein domain. For example, the solid tumor cancer may be prostate cancer, and the oncologic protein is expressed by the gene fusion TMPRSS2-ERG, TMPRSS2-ETV1, XLC45A3-ERG, or NDRG1-ERG; or the solid tumor cancer is Ewing's Sarcoma, chrondrosarcoma, or soft tissue sarcoma, and the oncology fusion protein is EWSR1-NR4A3, EWSR1-WT1, or EWSR1-FLI1, or the solid tumor cancer is kidney cancer, and the oncology fusion protein is TFE3-PRCC, or the solid tumor cancer is poorly differentiated carcinoma or midline carcinoma, and the oncology fusion protein is BRD4-NUT, or the solid tumor cancer is thyroid cancer, and the oncology fusion protein is a RET fusion protein. Contemplated fusion protein may include e.g., HOOK3-RET, RET-PTC3, RET-PTC2, RET-PTC1, RET-NCOA4.

Also contemplated herein is a method for treating a solid tumor cancer such as glioblastoma, in a patient in need thereof, as described above, wherein the oncology fusion protein is GOPC-ROS 1, or treating non small cell lung cancer wherein oncology fusion protein is TFE3-PRCC.

In another embodiment, a method of treating a solid tumor cancer or a hematologic malignancy a patient in need thereof, is provided, comprising: a) identifying the presence of an oncology fusion protein in said patient, wherein said oncology fusion protein has a first segment and a second segment; and b) administering to said patient a first monomer capable of binding a first protein domain in said first segment; and a second monomer capable of binding a second protein domain in said second segment, wherein said first monomer and second monomer form a multimer that binds to said fusion protein and thus modulating or repressing function of the oncology fusion protein. Such identifying may include providing one or more first monomers having a first ligand capable of binding to the fusion protein, and a first linker element; providing one or more second monomers having a second ligand and a second linker element, wherein the second linker element is capable of reversibly associating with the first linker element to form a multimer having a distinct fluorescence signal when the first monomer and the second monomer bind to the fusion protein, contacting an aqueous sample of the patient's with the first and second monomers; detecting a fluorescence signal from the multimer indicating the presence of the fusion protein.

Also provided herein is a method of treating a patient having a cancer treatable by boron neutron capture therapy comprising administering to said patient a first monomer and a second monomer, wherein the first monomer is represented by:

X₁—Y₁—Z₁ (Formula I)
and pharmaceutically acceptable salts, stereoisomers, metabolites and hydrates thereof, wherein
X₁ is a first non-peptidyl pharmacophore capable of binding to a first target biomolecule segment;
Y₁ is absent or is a connector moiety covalently bound to X₁ and Z₁;
Z₁ is a first linker capable of binding to a second monomer; and the second monomer is represented by:

X₂—Y₂—Z₂ (Formula II)
wherein
X₂ is a second non-peptidyl pharmacophore capable of binding to a second target biomolecule segment;
Y₂ is absent or is a connector moiety covalently bound to X₂ and Z₂
Z₂ is a first linker is a boronic acid or oxaborole moiety having a ¹⁰B isotope, and capable of binding with the Z₁ moiety of Formula I;

wherein upon administration, said first monomer and said second monomer forms a multimer in vivo that binds to the first target protein domain and the second target protein domain; and

administering a neutron beam to the patient thereby interacting a thermal neutron with the ¹⁰B isotope.

It will be appreciated that a composition including one type of monomer may be administered together (e.g. simultaneously or sequentially) with a composition that includes another type of monomer capable of binding in aqueous media (e.g. at a physiological pH (pH 5 to about 10, e.g. 6 to 10, e.g., 7 to 9) to the monomers in the first composition. For example, physiological conditions may be, in some embodiments, the aqueous conditions inside the body or the cell, for example, with a temperature range of about 35-40° C., a pH range of about 5.5-8, a glucose concentration range of about 1-20 mM, and/or an ionic strength range of about 110 mM to about 260 mM.

Also contemplated herein, in some embodiments, is a composition comprising a disclosed multimer, which in some embodiments may be administered to a patient in need thereof. In other embodiments, it will be appreciated that the monomers will be administered substantially before any multimerization, with most multimerization taking place in vivo.

Disclosed compositions may be administered to patients (animals and humans) in need of such treatment in dosages that will provide optimal pharmaceutical efficacy. It will be appreciated that the dose required for use in any particular application will vary from patient to patient, not only with the particular compound or composition selected, but also with the route of administration, the nature of the condition being treated, the age and condition of the patient, concurrent medication or special diets then being followed by the patient, and other factors which those skilled in the art will recognize, with the appropriate dosage ultimately being at the discretion of the attendant physician. For treating clinical conditions and diseases noted above, a compound may be administered orally, subcutaneously, topically, parenterally, by inhalation spray or rectally in dosage unit formulations containing conventional non-toxic pharmaceutically acceptable carriers, adjuvants, and vehicles. Parenteral administration may include subcutaneous injections, intravenous or intramuscular injections, or infusion techniques.

Treatment can be continued for as long or as short a period as desired. The compositions may be administered on a regimen of, for example, one to four or more times per day. A suitable treatment period can be, for example, at least about one week, at least about two weeks, at least about one month, at least about six months, at least about 1 year, or indefinitely. A treatment period can terminate when a desired result, for example a partial or total alleviation of symptoms, is achieved.

In another aspect, pharmaceutical compositions comprising monomers, dimers, and/or multimers as disclosed herein formulated together with a pharmaceutically acceptable carrier provided. In particular, the present disclosure provides pharmaceutical compositions comprising monomers, dimers, and/or multimers as disclosed herein formulated together with one or more pharmaceutically acceptable carriers. These formulations include those suitable for oral, rectal, topical, buccal, parenteral (e.g., subcutaneous, intramuscular, intradermal, or intravenous) rectal, vaginal, or aerosol administration, although the most suitable form of administration in any given case will depend on the degree and severity of the condition being treated and on the nature of the particular compound being used. For example, disclosed compositions may be formulated as a unit dose, and/or may be formulated for oral or subcutaneous administration.

Exemplary pharmaceutical compositions may be used in the form of a pharmaceutical preparation, for example, in solid, semisolid, or liquid form, which contains one or more of the compounds, as an active ingredient, in admixture with an organic or inorganic carrier or excipient suitable for external, enteral, or parenteral applications. The active ingredient may be compounded, for example, with the usual non-toxic, pharmaceutically acceptable carriers for tablets, pellets, capsules, suppositories, solutions, emulsions, suspensions, and any other form suitable for use. The active object compound is included in the pharmaceutical composition in an amount sufficient to produce the desired effect upon the process or condition of the disease.

For preparing solid compositions such as tablets, the principal active ingredient may be mixed with a pharmaceutical carrier, e.g., conventional tableting ingredients such as corn starch, lactose, sucrose, sorbitol, talc, stearic acid, magnesium stearate, dicalcium phosphate or gums, and other pharmaceutical diluents, e.g., water, to form a solid preformulation composition containing a homogeneous mixture of a compound, or a non-toxic pharmaceutically acceptable salt thereof. When referring to these preformulation compositions as homogeneous, it is meant that the active ingredient is dispersed evenly throughout the composition so that the composition may be readily subdivided into equally effective unit dosage forms such as tablets, pills and capsules.

In solid dosage forms for oral administration (capsules, tablets, pills, dragees, powders, granules and the like), the subject composition is mixed with one or more pharmaceutically acceptable carriers, such as sodium citrate or dicalcium phosphate, and/or any of the following: (1) fillers or extenders, such as starches, lactose, sucrose, glucose, mannitol, and/or silicic acid; (2) binders, such as, for example, carboxymethylcellulose, alginates, gelatin, polyvinyl pyrrolidone, sucrose and/or acacia; (3) humectants, such as glycerol; (4) disintegrating agents, such as agar-agar, calcium carbonate, potato or tapioca starch, alginic acid, certain silicates, and sodium carbonate; (5) solution retarding agents, such as paraffin; (6) absorption accelerators, such as quaternary ammonium compounds; (7) wetting agents, such as, for example, acetyl alcohol and glycerol monostearate; (8) absorbents, such as kaolin and bentonite clay; (9) lubricants, such a talc, calcium stearate, magnesium stearate, solid polyethylene glycols, sodium lauryl sulfate, and mixtures thereof; and (10) coloring agents. In the case of capsules, tablets and pills, the compositions may also comprise buffering agents. Solid compositions of a similar type may also be employed as fillers in soft and hard-filled gelatin capsules using such excipients as lactose or milk sugars, as well as high molecular weight polyethylene glycols and the like.

A tablet may be made by compression or molding, optionally with one or more accessory ingredients. Compressed tablets may be prepared using binder (for example, gelatin or hydroxypropylmethyl cellulose), lubricant, inert diluent, preservative, disintegrant (for example, sodium starch glycolate or cross-linked sodium carboxymethyl cellulose), surface-active or dispersing agent. Molded tablets may be made by molding in a suitable machine a mixture of the subject composition moistened with an inert liquid diluent. Tablets, and other solid dosage forms, such as dragees, capsules, pills and granules, may optionally be scored or prepared with coatings and shells, such as enteric coatings and other coatings well known in the pharmaceutical-formulating art.

Compositions for inhalation or insufflation include solutions and suspensions in pharmaceutically acceptable, aqueous or organic solvents, or mixtures thereof, and powders. Liquid dosage forms for oral administration include pharmaceutically acceptable emulsions, microemulsions, solutions, suspensions, syrups and elixirs. In addition to the subject composition, the liquid dosage forms may contain inert diluents commonly used in the art, such as, for example, water or other solvents, solubilizing agents and emulsifiers, such as ethyl alcohol, isopropyl alcohol, ethyl carbonate, ethyl acetate, benzyl alcohol, benzyl benzoate, propylene glycol, 1,3-butylene glycol, oils (in particular, cottonseed, groundnut, corn, germ, olive, castor and sesame oils), glycerol, tetrahydrofuryl alcohol, polyethylene glycols and fatty acid esters of sorbitan, cyclodextrins and mixtures thereof.

Suspensions, in addition to the subject composition, may contain suspending agents as, for example, ethoxylated isostearyl alcohols, polyoxyethylene sorbitol and sorbitan esters, microcrystalline cellulose, aluminum metahydroxide, bentonite, agar-agar and tragacanth, and mixtures thereof.

Formulations for rectal or vaginal administration may be presented as a suppository, which may be prepared by mixing a subject composition with one or more suitable non-irritating excipients or carriers comprising, for example, cocoa butter, polyethylene glycol, a suppository wax or a salicylate, and which is solid at room temperature, but liquid at body temperature and, therefore, will melt in the body cavity and release the active agent.

Dosage forms for transdermal administration of a subject composition includes powders, sprays, ointments, pastes, creams, lotions, gels, solutions, patches and inhalants. The active component may be mixed under sterile conditions with a pharmaceutically acceptable carrier, and with any preservatives, buffers, or propellants which may be required.

The ointments, pastes, creams and gels may contain, in addition to a subject composition, excipients, such as animal and vegetable fats, oils, waxes, paraffins, starch, tragacanth, cellulose derivatives, polyethylene glycols, silicones, bentonites, silicic acid, talc and zinc oxide, or mixtures thereof.

Powders and sprays may contain, in addition to a subject composition, excipients such as lactose, talc, silicic acid, aluminum hydroxide, calcium silicates and polyamide powder, or mixtures of these substances. Sprays may additionally contain customary propellants, such as chlorofluorohydrocarbons and volatile unsubstituted hydrocarbons, such as butane and propane.

Compositions and compounds may alternatively be administered by aerosol. This is accomplished by preparing an aqueous aerosol, liposomal preparation or solid particles containing the compound. A non-aqueous (e.g., fluorocarbon propellant) suspension could be used. Sonic nebulizers may be used because they minimize exposing the agent to shear, which may result in degradation of the compounds contained in the subject compositions. Ordinarily, an aqueous aerosol is made by formulating an aqueous solution or suspension of a subject composition together with conventional pharmaceutically acceptable carriers and stabilizers. The carriers and stabilizers vary with the requirements of the particular subject composition, but typically include non-ionic surfactants (Tweens, Pluronics, or polyethylene glycol), innocuous proteins like serum albumin, sorbitan esters, oleic acid, lecithin, amino acids such as glycine, buffers, salts, sugars, or sugar alcohols. Aerosols generally are prepared from isotonic solutions.

Pharmaceutical compositions suitable for parenteral administration comprise a subject composition in combination with one or more pharmaceutically-acceptable sterile isotonic aqueous or non-aqueous solutions, dispersions, suspensions or emulsions, or sterile powders which may be reconstituted into sterile injectable solutions or dispersions just prior to use, which may contain antioxidants, buffers, bacteriostats, solutes which render the formulation isotonic with the blood of the intended recipient or suspending or thickening agents.

Examples of suitable aqueous and non-aqueous carriers which may be employed in the pharmaceutical compositions include water, ethanol, polyols (such as glycerol, propylene glycol, polyethylene glycol, and the like), and suitable mixtures thereof, vegetable oils, such as olive oil, and injectable organic esters, such as ethyl oleate and cyclodextrins. Proper fluidity may be maintained, for example, by the use of coating materials, such as lecithin, by the maintenance of the required particle size in the case of dispersions, and by the use of surfactants

In another aspect, enteral pharmaceutical formulations including a disclosed pharmaceutical composition comprising monomers, dimers, and/or multimers, an enteric material; and a pharmaceutically acceptable carrier or excipient thereof are provided. Enteric materials refer to polymers that are substantially insoluble in the acidic environment of the stomach, and that are predominantly soluble in intestinal fluids at specific pHs. The small intestine is the part of the gastrointestinal tract (gut) between the stomach and the large intestine, and includes the duodenum, jejunum, and ileum. The pH of the duodenum is about 5.5, the pH of the jejunum is about 6.5 and the pH of the distal ileum is about 7.5. Accordingly, enteric materials are not soluble, for example, until a pH of about 5.0, of about 5.2, of about 5.4, of about 5.6, of about 5.8, of about 6.0, of about 6.2, of about 6.4, of about 6.6, of about 6.8, of about 7.0, of about 7.2, of about 7.4, of about 7.6, of about 7.8, of about 8.0, of about 8.2, of about 8.4, of about 8.6, of about 8.8, of about 9.0, of about 9.2, of about 9.4, of about 9.6, of about 9.8, or of about 10.0. Exemplary enteric materials include cellulose acetate phthalate (CAP), hydroxypropyl methylcellulose phthalate (HPMCP), polyvinyl acetate phthalate (PVAP), hydroxypropyl methylcellulose acetate succinate (HPMCAS), cellulose acetate trimellitate, hydroxypropyl methylcellulose succinate, cellulose acetate succinate, cellulose acetate hexahydrophthalate, cellulose propionate phthalate, cellulose acetate maleat, cellulose acetate butyrate, cellulose acetate propionate, copolymer of methylmethacrylic acid and methyl methacrylate, copolymer of methyl acrylate, methylmethacrylate and methacrylic acid, copolymer of methylvinyl ether and maleic anhydride (Gantrez ES series), ethyl methyacrylate-methylmethacrylate-chlorotrimethylammonium ethyl acrylate copolymer, natural resins such as zein, shellac and copal collophorium, and several commercially available enteric dispersion systems (e.g., Eudragit L30D55, Eudragit FS30D, Eudragit L100, Eudragit S100, Kollicoat EMM30D, Estacryl 30D, Coateric, and Aquateric). The solubility of each of the above materials is either known or is readily determinable in vitro. The foregoing is a list of possible materials, but one of skill in the art with the benefit of the disclosure would recognize that it is not comprehensive and that there are other enteric materials that may be used.

Advantageously, kits are provided containing one or more compositions each including the same or different monomers. Such kits include a suitable dosage form such as those described above and instructions describing the method of using such dosage form to treat a disease or condition. The instructions would direct the consumer or medical personnel to administer the dosage form according to administration modes known to those skilled in the art. Such kits could advantageously be packaged and sold in single or multiple kit units. An example of such a kit is a so-called blister pack. Blister packs are well known in the packaging industry and are being widely used for the packaging of pharmaceutical unit dosage forms (tablets, capsules, and the like). Blister packs generally consist of a sheet of relatively stiff material covered with a foil of a preferably transparent plastic material. During the packaging process recesses are formed in the plastic foil. The recesses have the size and shape of the tablets or capsules to be packed. Next, the tablets or capsules are placed in the recesses and the sheet of relatively stiff material is sealed against the plastic foil at the face of the foil which is opposite from the direction in which the recesses were formed. As a result, the tablets or capsules are sealed in the recesses between the plastic foil and the sheet. Preferably the strength of the sheet is such that the tablets or capsules can be removed from the blister pack by manually applying pressure on the recesses whereby an opening is formed in the sheet at the place of the recess. The tablet or capsule can then be removed via said opening.

It may be desirable to provide a memory aid on the kit, e.g., in the form of numbers next to the tablets or capsules whereby the numbers correspond with the days of the regimen which the tablets or capsules so specified should be ingested. Another example of such a memory aid is a calendar printed on the card, e.g., as follows “First Week, Monday, Tuesday, . . . etc. . . . Second Week, Monday, Tuesday, . . . ” etc. Other variations of memory aids will be readily apparent. A “daily dose” can be a single tablet or capsule or several pills or capsules to be taken on a given day. Also, a daily dose of a first compound can consist of one tablet or capsule while a daily dose of the second compound can consist of several tablets or capsules and vice versa. The memory aid should reflect this.

Also contemplated herein are methods and compositions that include an independent active agent, or administering an independent active agent.

Certain terms employed in the specification, examples, and appended claims are collected here. These definitions should be read in light of the entirety of the disclosure and understood as by a person of skill in the art. Unless defined otherwise, all technical and scientific terms used herein have the same meaning as commonly understood by a person of ordinary skill in the art.

### DEFINITIONS

A “segment” as it relates herein refers to a portion of a biomolecule (e.g., a protein) and generally means a set of amino acids or nucleic acids (or a combination of both) with a surface area less than 1000 Å² capable of binding a small molecule with at least a 500 μM affinity. An exemplary biomolecule segment is a protein domain.

In some embodiments, the compounds, as described herein, may be substituted with any number of substituents or functional moieties. In general, the term “substituted” whether preceded by the term “optionally” or not, and substituents contained in formulas, refer to the replacement of hydrogen radicals in a given structure with the radical of a specified substituent.

In some instances, when more than one position in any given structure may be substituted with more than one substituent selected from a specified group, the substituent may be either the same or different at every position.

As used herein, the term “substituted” is contemplated to include all permissible substituents of organic compounds. In a broad aspect, the permissible substituents include acyclic and cyclic, branched and unbranched, carbocyclic and heterocyclic, aromatic and non-aromatic substituents of organic compounds. In some embodiments, heteroatoms such as nitrogen may have hydrogen substituents and/or any permissible substituents of organic compounds described herein which satisfy the valencies of the heteroatoms. Non-limiting examples of substituents include acyl; aliphatic; heteroaliphatic; aryl; heteroaryl; arylalkyl; heteroarylalkyl; alkoxy; cycloalkoxy; heterocyclylalkoxy; heterocyclyloxy; heterocyclyloxyalkyl; alkenyloxy; alkynyloxy; aryloxy; heteroalkoxy; heteroaryloxy; alkylthio; arylthio; heteroalkylthio; heteroarylthio; oxo; —F; —Cl; —Br; —I; —OH; —NO₂; —CN; —SCN; —SRₓ; —CF₃; —CH₂CF₃; —CHCl₂; —CH₂OH; —CH₂CH₂OH; —CH₂NH₂; —CH₂SO₂CH₃; —ORₓ, —C(O)Rₓ; —CO₂(Rₓ); —C(O)N(Rₓ)₂; —OC(O)Rₓ; —OCO₂Rₓ; —OC(O)N(Rₓ)₂; —N(Rₓ)₂; —SORₓ; —S(O)₂Rₓ; —NRₓC(O)Rₓ; or —C(Rₓ)₃; wherein each occurrence of Rₓ independently includes, but is not limited to, hydrogen, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Furthermore, the compounds described herein are not intended to be limited in any manner by the permissible substituents of organic compounds. In some embodiments, combinations of substituents and variables described herein may be preferably those that result in the formation of stable compounds. The term “stable,” as used herein, refers to compounds which possess stability sufficient to allow manufacture and which maintain the integrity of the compound for a sufficient period of time to be detected and preferably for a sufficient period of time to be useful for the purposes detailed herein.

The term “acyl,” as used herein, refers to a moiety that includes a carbonyl group. In some embodiments, an acyl group may have a general formula selected from —C(O)R_{R}; —CO₂(Rₓ); —C(O)N(Rₓ)₂; —OC(O)Rₓ; —OCO₂Rₓ; and —OC(O)N(Rₓ)₂; wherein each occurrence of Rₓ independently includes, but is not limited to, hydrogen, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted.

The term “aliphatic,” as used herein, includes both saturated and unsaturated, straight chain (i.e., unbranched), branched, acyclic, cyclic, or polycyclic aliphatic hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. The term “heteroaliphatic,” as used herein, refers to aliphatic moieties that contain one or more oxygen, sulfur, nitrogen, phosphorus, or silicon atoms, e.g., in place of carbon atoms. Heteroaliphatic moieties may be branched, unbranched, cyclic or acyclic and include saturated and unsaturated heterocycles such as morpholino, pyrrolidinyl, etc. In certain embodiments, heteroaliphatic moieties are substituted by independent replacement of one or more of the hydrogen atoms thereon with one or more moieties including, but not limited to acyl; aliphatic; heteroaliphatic; aryl; heteroaryl; arylalkyl; heteroarylalkyl; alkoxy; cycloalkoxy; heterocyclylalkoxy; heterocyclyloxy; heterocyclyloxyalkyl; alkenyloxy; alkynyloxy; aryloxy; heteroalkoxy; heteroaryloxy; alkylthio; arylthio; heteroalkylthio; heteroarylthio; oxo; —F; —Cl; —Br; —I; —OH; —NO₂; —CN; —SCN; —SR_{R}; —CF₃; —CH₂CF₃; —CHCl₂; —CH₂OH; —CH₂CH₂OH; —CH₂NH₂; —CH₂SO₂CH₃; —ORₓ, —C(O)Rₓ; —OC₂(Rₓ); —C(O)N(Rₓ)₂; —OC(O)Rₓ; —OCO₂Rₓ; —OC(O)N(Rₓ)₂; —N(Rₓ)₂; —SORₓ; —S(O)₂Rₓ; —NRₓC(O)Rₓ; or —C(Rₓ)₃; wherein each occurrence of Rₓ independently includes, but is not limited to, hydrogen, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted.

In general, the terms “aryl” and “heteroaryl,” as used herein, refer to stable mono- or polycyclic, heterocyclic, polycyclic, and polyheterocyclic unsaturated moieties having preferably 3-14 carbon atoms, each of which may be substituted or unsubstituted. Substituents include, but are not limited to, any of the previously mentioned substituents, i.e., the substituents recited for aliphatic moieties, or for other moieties as disclosed herein, resulting in the formation of a stable compound. In certain embodiments, aryl refers to a mono- or bicyclic carbocyclic ring system having one or two aromatic rings including, but not limited to, phenyl, naphthyl, tetrahydronaphthyl, indanyl, indenyl, and the like. In certain embodiments, the term heteroaryl, as used herein, refers to a cyclic aromatic radical having from five to ten ring atoms of which one ring atom is selected from the group consisting of S, O, and N; zero, one, or two ring atoms are additional heteroatoms independently selected from the group consisting of S, O, and N; and the remaining ring atoms are carbon, the radical being joined to the rest of the molecule via any of the ring atoms, such as, for example, pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, and the like.

It will be appreciated that aryl and heteroaryl groups can be unsubstituted or substituted, wherein substitution includes replacement of one, two, three, or more of the hydrogen atoms thereon independently with any one or more of the following moieties including, but not limited to: aliphatic; heteroaliphatic; aryl; heteroaryl; arylalkyl; heteroarylalkyl; alkoxy; cycloalkoxy; heterocyclylalkoxy; heterocyclyloxy; heterocyclyloxyalkyl; alkenyloxy; alkynyloxy; aryloxy; heteroalkoxy; heteroaryloxy; alkylthio; arylthio; heteroalkylthio; heteroarylthio; oxo; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)R_{R}; —OCO₂Rₓ; —OCON(Rₓ)₂; —N(Rₓ)₂; —S(O)₂Rₓ; —NR_{R}(CO)R_{R}, wherein each occurrence of Rₓ independently includes, but is not limited to, hydrogen, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The term “heterocyclic,” as used herein, refers to an aromatic or non-aromatic, partially unsaturated or fully saturated, 3- to 10-membered ring system, which includes single rings of 3 to 8 atoms in size and bi- and tri-cyclic ring systems which may include aromatic five- or six-membered aryl or aromatic heterocyclic groups fused to a non-aromatic ring. These heterocyclic rings include those having from one to three heteroatoms independently selected from the group consisting of oxygen, sulfur, and nitrogen, in which the nitrogen and sulfur heteroatoms may optionally be oxidized and the nitrogen heteroatom may optionally be quaternized. In certain embodiments, the term heterocyclic refers to a non-aromatic 5-, 6-, or 7-membered ring or a polycyclic group wherein at least one ring atom is a heteroatom selected from the group consisting of O, S, and N (wherein the nitrogen and sulfur heteroatoms may be optionally oxidized), including, but not limited to, a b1- or tr1-cyclic group, comprising fused six-membered rings having between one and three heteroatoms independently selected from the group consisting of the oxygen, sulfur, and nitrogen, wherein (i) each 5-membered ring has 0 to 2 double bonds, each 6-membered ring has 0 to 2 double bonds, and each 7-membered ring has 0 to 3 double bonds, (ii) the nitrogen and sulfur heteroatoms may be optionally oxidized, (iii) the nitrogen heteroatom may optionally be quaternized, and (iv) any of the above heterocyclic rings may be fused to an aryl or heteroaryl ring.

The term “alkenyl” as used herein refers to an unsaturated straight or branched hydrocarbon having at least one carbon-carbon double bond, such as a straight or branched group of 2-6 or 3-4 carbon atoms, referred to herein for example as C₂₋₆alkenyl, and C₃₋₄alkenyl, respectively. Exemplary alkenyl groups include, but are not limited to, vinyl, allyl, butenyl, pentenyl, etc.

The term “alkenyloxy” used herein refers to a straight or branched alkenyl group attached to an oxygen (alkenyl-O). Exemplary alkenoxy groups include, but are not limited to, groups with an alkenyl group of 3-6 carbon atoms referred to herein as C₃₋₆alkenyloxy. Exemplary “alkenyloxy” groups include, but are not limited to allyloxy, butenyloxy, etc.

The term “alkoxy” as used herein refers to a straight or branched alkyl group attached to an oxygen (alkyl-O—). Exemplary alkoxy groups include, but are not limited to, groups with an alkyl group of 1-6 or 2-6 carbon atoms, referred to herein as C₁₋₆alkoxy, and C₂-C₆alkoxy, respectively. Exemplary alkoxy groups include, but are not limited to methoxy, ethoxy, isopropoxy, etc.

The term “alkoxycarbonyl” as used herein refers to a straight or branched alkyl group attached to oxygen, attached to a carbonyl group (alkyl-O—C(O)—). Exemplary alkoxycarbonyl groups include, but are not limited to, alkoxycarbonyl groups of 1-6 carbon atoms, referred to herein as C₁₋₆alkoxycarbonyl. Exemplary alkoxycarbonyl groups include, but are not limited to, methoxycarbonyl, ethoxycarbonyl, t-butoxycarbonyl, etc.

The term “alkynyloxy” used herein refers to a straight or branched alkynyl group attached to an oxygen (alkynyl-O)). Exemplary alkynyloxy groups include, but are not limited to, propynyloxy.

The term “alkyl” as used herein refers to a saturated straight or branched hydrocarbon, for example, such as a straight or branched group of 1-6, 1-4, or 1-3 carbon atoms, referred to herein as C₁₋₆alkyl, C₁₋₄alkyl, and C₁₋₃alkyl, respectively. Exemplary alkyl groups include, but are not limited to, methyl, ethyl, propyl, isopropyl, 2-methyl-1-propyl, 2-methyl-2-propyl, 2-methyl-1-butyl, 3-methyl-1-butyl, 3-methyl-2-butyl, 2,2-dimethyl-1-propyl, 2-methyl-1-pentyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, butyl, isobutyl, t-butyl, pentyl, isopentyl, neopentyl, hexyl, etc.

The term “alkylcarbonyl” as used herein refers to a straight or branched alkyl group attached to a carbonyl group (alkyl-C(O)—). Exemplary alkylcarbonyl groups include, but are not limited to, alkylcarbonyl groups of 1-6 atoms, referred to herein as C₁₋₆alkylcarbonyl groups. Exemplary alkylcarbonyl groups include, but are not limited to, acetyl, propanoyl, isopropanoyl, butanoyl, etc.

The term “alkynyl” as used herein refers to an unsaturated straight or branched hydrocarbon having at least one carbon-carbon triple bond, such as a straight or branched group of 2-6, or 3-6 carbon atoms, referred to herein as C₂₋₆alkynyl, and C₃₋₆alkynyl, respectively. Exemplary alkynyl groups include, but are not limited to, ethynyl, propynyl, butynyl, pentynyl, hexynyl, methylpropynyl, etc.

The term “carbonyl” as used herein refers to the radical —C(O)—.

The term “carboxylic acid” as used herein refers to a group of formula —CO₂H.

The term “cyano” as used herein refers to the radical —CN.

The term “cycloalkoxy” as used herein refers to a cycloalkyl group attached to an oxygen (cycloalkyl-O—).

The term “cycloalkyl” as used herein refers to a monocyclic saturated or partially unsaturated hydrocarbon group of for example 3-6, or 4-6 carbons, referred to herein, e.g., as C₃₋₆cycloalkyl or C₄₋₆cycloalkyl and derived from a cycloalkane. Exemplary cycloalkyl groups include, but are not limited to, cyclohexyl, cyclohexenyl, cyclopentyl, cyclobutyl or, cyclopropyl.

The terms “halo” or “halogen” as used herein refer to F, Cl, Br, or I.

The term “heterocyclylalkoxy” as used herein refers to a heterocyclyl-alkyl-O-group.

The term “heterocyclyloxyalkyl” refers to a heterocyclyl-O-alkyl-group.

The term “heterocyclyloxy” refers to a heterocyclyl-O— group.

The term “heteroaryloxy” refers to a heteroaryl-O— group.

The terms “hydroxy” and “hydroxyl” as used herein refers to the radical —OH.

The term “oxo” as used herein refers to the radical ═O.

“Treating” includes any effect, e.g., lessening, reducing, modulating, or eliminating, that results in the improvement of the condition, disease, disorder and the like.

“Pharmaceutically or pharmacologically acceptable” include molecular entities and compositions that do not produce an adverse, allergic, or other untoward reaction when administered to an animal, or a human, as appropriate. For human administration, preparations should meet sterility, pyrogenicity, general safety and purity standards as required by FDA Office of Biologics standards.

The term “pharmaceutically acceptable carrier” or “pharmaceutically acceptable excipient” as used herein refers to any and all solvents, dispersion media, coatings, isotonic and absorption delaying agents, and the like, that are compatible with pharmaceutical administration. The use of such media and agents for pharmaceutically active substances is well known in the art. The compositions may also contain other active compounds providing supplemental, additional, or enhanced therapeutic functions.

The term “pharmaceutical composition” as used herein refers to a composition comprising at least one compound as disclosed herein formulated together with one or more pharmaceutically acceptable carriers.

“Individual,” “patient,” or “subject” are used interchangeably and include any animal, including mammals, preferably mice, rats, other rodents, rabbits, dogs, cats, swine, cattle, sheep, horses, or primates, and most preferably humans. The compounds can be administered to a mammal, such as a human, but can also be administered to other mammals such as an animal in need of veterinary treatment, e.g., domestic animals (e.g., dogs, cats, and the like), farm animals (e.g., cows, sheep, pigs, horses, and the like) and laboratory animals (e.g., rats, mice, guinea pigs, and the like). The mammal treated is desirably a mammal in which treatment of obesity, or weight loss is desired. “Modulation” includes antagonism (e.g., inhibition), agonism, partial antagonism and/or partial agonism.

In the present specification, the term “therapeutically effective amount” means the amount of the subject compound that will elicit the biological or medical response of a tissue, system, animal, or human that is being sought by the researcher, veterinarian, medical doctor, or other clinician. The compounds are administered in therapeutically effective amounts to treat a disease. Alternatively, a therapeutically effective amount of a compound is the quantity required to achieve a desired therapeutic and/or prophylactic effect, such as an amount which results in weight loss.

The term “pharmaceutically acceptable salt(s)” as used herein refers to salts of acidic or basic groups that may be present in compounds used in the present compositions. Compounds included in the present compositions that are basic in nature are capable of forming a wide variety of salts with various inorganic and organic acids. The acids that may be used to prepare pharmaceutically acceptable acid addition salts of such basic compounds are those that form non-toxic acid addition salts, i.e., salts containing pharmacologically acceptable anions, including but not limited to malate, oxalate, chloride, bromide, iodide, nitrate, sulfate, bisulfate, phosphate, acid phosphate, isonicotinate, acetate, lactate, salicylate, citrate, tartrate, oleate, tannate, pantothenate, bitartrate, ascorbate, succinate, maleate, gentisinate, fumarate, gluconate, glucaronate, saccharate, formate, benzoate, glutamate, methanesulfonate, ethanesulfonate, benzenesulfonate, p-toluenesulfonate and pamoate (i.e., 1,1′-methylene-bis-(2-hydroxy-3-naphthoate)) salts. Compounds included in the present compositions that are acidic in nature are capable of forming base salts with various pharmacologically acceptable cations. Examples of such salts include alkali metal or alkaline earth metal salts and, particularly, calcium, magnesium, sodium, lithium, zinc, potassium, and iron salts. Compounds included in the present compositions that include a basic or acidic moiety may also form pharmaceutically acceptable salts with various amino acids. The compounds of the disclosure may contain both acidic and basic groups; for example, one amino and one carboxylic acid group. In such a case, the compound can exist as an acid addition salt, a zwitterion, or a base salt.

The compounds of the disclosure may contain one or more chiral centers and/or double bonds and, therefore, exist as stereoisomers, such as geometric isomers, enantiomers or diastereomers. The term “stereoisomers” when used herein consist of all geometric isomers, enantiomers or diastereomers. These compounds may be designated by the symbols “R” or “S,” depending on the configuration of substituents around the stereogenic carbon atom.

Various stereoisomers of these compounds and mixtures thereof are encompassed by this disclosure. Stereoisomers include enantiomers and diastereomers. Mixtures of enantiomers or diastereomers may be designated “(±)” in nomenclature, but the skilled artisan will recognize that a structure may denote a chiral center implicitly.

The compounds of the disclosure may contain one or more chiral centers and/or double bonds and, therefore, exist as geometric isomers, enantiomers or diastereomers. The enantiomers and diastereomers may be designated by the symbols “(+),” “(−).” “R” or “S,” depending on the configuration of substituents around the stereogenic carbon atom, but the skilled artisan will recognize that a structure may denote a chiral center implicitly. Geometric isomers, resulting from the arrangement of substituents around a carbon-carbon double bond or arrangement of substituents around a cycloalkyl or heterocyclic ring, can also exist in the compounds. The symbol [symbol] denotes a bond that may be a single, double or triple bond as described herein. Substituents around a carbon-carbon double bond are designated as being in the “Z” or “E” configuration wherein the terms “Z” and “E” are used in accordance with IUPAC standards. Unless otherwise specified, structures depicting double bonds encompass both the “E” and “Z” isomers. Substituents around a carbon-carbon double bond alternatively can be referred to as “cis” or “trans,” where “cis” represents substituents on the same side of the double bond and “trans” represents substituents on opposite sides of the double bond. The arrangement of substituents around a carbocyclic ring can also be designated as “cis” or “trans.” The term “cis” represents substituents on the same side of the plane of the ring and the term “trans” represents substituents on opposite sides of the plane of the ring. Mixtures of compounds wherein the substituents are disposed on both the same and opposite sides of plane of the ring are designated “cis/trans.”

The term “stereoisomers” when used herein consist of all geometric isomers, enantiomers or diastereomers. Various stereoisomers of these compounds and mixtures thereof are encompassed by this disclosure.

Individual enantiomers and diasteriomers of the compounds can be prepared synthetically from commercially available starting materials that contain asymmetric or stereogenic centers, or by preparation of racemic mixtures followed by resolution methods well known to those of ordinary skill in the art. These methods of resolution are exemplified by (1) attachment of a mixture of enantiomers to a chiral auxiliary, separation of the resulting mixture of diastereomers by recrystallization or chromatography and liberation of the optically pure product from the auxiliary, (2) salt formation employing an optically active resolving agent, (3) direct separation of the mixture of optical enantiomers on chiral liquid chromatographic columns or (4) kinetic resolution using steroselective chemical or enzymatic reagents. Racemic mixtures can also be resolved into their component enantiomers by well known methods, such as chiral-phase gas chromatography or crystallizing the compound in a chiral solvent. Stereoselective syntheses, a chemical or enzymatic reaction in which a single reactant forms an unequal mixture of stereoisomers during the creation of a new stereocenter or during the transformation of a pre-existing one, are well known in the art. Stereoselective syntheses encompass both enantio- and diastereoselective transformations. For examples, see Carreira and Kvaerno, Classics in Stereoselective Synthesis, Wiley-VCH: Weinheim, 2009.

The compounds disclosed herein can exist in solvated as well as unsolvated forms with pharmaceutically acceptable solvents such as water, ethanol, and the like.

Also embraced are isotopically labeled compounds which are identical to those recited herein, except that one or more atoms are replaced by an atom having an atomic mass or mass number different from the atomic mass or mass number usually found in nature. Examples of isotopes that can be incorporated into the compounds include isotopes of hydrogen, carbon, nitrogen, oxygen, phosphorus, sulfur, fluorine and chlorine, such as ²H, ³H, ¹³C, ¹⁴C, ¹⁵N, ¹⁸O, ¹⁰B, ¹⁷O, ³¹P, ³²P, ³⁵S, ¹⁸F, and ³⁶Cl, respectively. For example, a compound may have one or more H atom replaced with deuterium.

Certain isotopically-labeled disclosed compounds (e.g., those labeled with ³H and ¹⁴C) are useful in compound and/or substrate tissue distribution assays. Tritiated (i.e., ³H) and carbon-14 (i.e., ¹⁴C) isotopes are particularly preferred for their ease of preparation and detectability. Further, substitution with heavier isotopes such as deuterium (i.e., ²H) may afford certain therapeutic advantages resulting from greater metabolic stability (e.g., increased in vivo half-life or reduced dosage requirements) and hence may be preferred in some circumstances. Isotopically labeled compounds can generally be prepared by following procedures analogous to those disclosed in the Examples herein by substituting an isotopically labeled reagent for a non-isotopically labeled reagent.

The term “prodrug” refers to compounds that are transformed in vivo to yield a disclosed compound or a pharmaceutically acceptable salt, hydrate or solvate of the compound. The transformation may occur by various mechanisms (such as by esterase, amidase, phosphatase, oxidative and or reductive metabolism) in various locations (such as in the intestinal lumen or upon transit of the intestine, blood, or liver). Prodrugs are well known in the art (for example, see Rautio, Kumpulainen, et al, Nature Reviews Drug Discovery 2008, 7, 255). For example, if a compound or a pharmaceutically acceptable salt, hydrate, or solvate of the compound contains a carboxylic acid functional group, a prodrug can comprise an ester formed by the replacement of the hydrogen atom of the acid group with a group such as (C₁₋₈)alkyl, (C₂₋₁₂)alkanoyloxymethyl, 1-(alkanoyloxy)ethyl having from 4 to 9 carbon atoms, 1-methyl-1-(alkanoyloxy)-ethyl having from 5 to 10 carbon atoms, alkoxycarbonyloxymethyl having from 3 to 6 carbon atoms, 1-(alkoxycarbonyloxy)ethyl having from 4 to 7 carbon atoms, 1-methyl-1-(alkoxycarbonyloxy)ethyl having from 5 to 8 carbon atoms, N-(alkoxycarbonyl)aminomethyl having from 3 to 9 carbon atoms, 1-(N-(alkoxycarbonyl)amino)ethyl having from 4 to 10 carbon atoms, 3-phthalidyl, 4-crotonolactonyl, gamma-butyrolacton-4-yl, d1-N,N—(C₁-C₂)alkylamino(C₂-C₃)alkyl (such as β-dimethylaminoethyl), carbamoyl-(C₁-C₂)alkyl, N,N-di(C₁-C₂)alkylcarbamoyl-(C₁-C₂)alkyl and piperidino-, pyrrolidino- or morpholino(C₂-C₃)alkyl.

Similarly, if a compound contains an alcohol functional group, a prodrug can be formed by the replacement of the hydrogen atom of the alcohol group with a group such as (C₁₋₆)alkanoyloxymethyl, 1-((C₁₋₆)alkanoyloxy)ethyl, 1-methyl-1-((C₁₋₆)alkanoyloxy)ethyl(C₁₋₆)alkoxycarbonyloxymethyl, N—(C₁₋₆)alkoxycarbonylaminomethyl, succinoyl, (C₁₋₆)alkanoyl, α-amino(C₁₋₄)alkanoyl, arylacyl and α-aminoacyl, or α-aminoacyl-α-aminoacyl, where each sa-aminoacyl group is independently selected from the naturally occurring L-amino acids, P(O)(OH)₂, —P(O)(O(C₁₋₆)alkyl)₂ or glycosyl (the radical resulting from the removal of a hydroxyl group of the hemiacetal form of a carbohydrate).

If a compound incorporates an amine functional group, a prodrug can be formed, for example, by creation of an amide or carbamate, an N-acyloxyakyl derivative, an (oxodioxolenyl)methyl derivative, an N-Mannich base, imine, or enamine. In addition, a secondary amine can be metabolically cleaved to generate a bioactive primary amine, or a tertiary amine can be metabolically cleaved to generate a bioactive primary or secondary amine. For examples, see Simplicio, et al., Molecules 2008, 13, 519 and references therein.

### INCORPORATION BY REFERENCE

All publications and patents mentioned herein, including those items listed below, are hereby incorporated by reference in their entirety for all purposes as if each individual publication or patent was specifically and individually incorporated by reference. In case of conflict, the present application, including any definitions herein, will control.

### EXAMPLES

### Example 1

The BRD4-NUT fusion protein (GenBank Accession No. AA022237.1) includes tandem bromo domains, where each bromo domain may be considered as a separate segment on the protein fusion.

Each bromo domain has a small cleft into which a small molecule may bind [Nature. 2010 Dec. 23; 468(7327):1067-73; Nature. 2010 Dec. 23; 468(7327):1119-23, both incorporated herein]. The pocket features certain pharmacophores essential for binding. These include the hydrophobic cleft generated by W370, P371, F372, V376, Y386, and V435; the hydrogen bond from the side-chain amide nitrogen of N429; and the aromatic contacts possible with W370; all in the second bromo domain. In the first domain, the elements include the hydrophobic cleft generated by W81, P82, F83, V87, L92, Y97, and 1146; the hydrogen bond from the side-chain amide nitrogen of N140; and the aromatic contacts possible with W81. The ligands described in the above referenced papers (hereby incorporated by reference) satisfy these constraints and have a variety of positions which are not critical to the pharmacophore and from which connectors and linkers could be grown. For example, the molecules feature either an ester or an amide, neither of which is making a critical contact. Extensions from either the amide or ester could connect the pharmacophoric elements to the linker element on both molecules, in this case creating a homodimer. Extensions from other positions on one of these molecules would lead to potential heterodimers.

### EQUIVALENTS

While specific embodiments have been discussed, the above specification is illustrative and not restrictive. Many variations will become apparent to those skilled in the art upon review of this specification. The full scope of the embodiments should be determined by reference to the claims, along with their full scope of equivalents, and the specification, along with such variations.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained.

What is claimed is:

1. A method of modulating a fusion gene product having a first segment, and a second segment and optionally an interface section, comprising:
contacting an aqueous composition comprising said fusion gene product with:
a first monomer capable of binding to the first segment; and
a second monomer capable of binding to the second segment or capable of binding to the interface segment if present; wherein said first monomer and second monomer form a multimer that binds to said gene fusion product.

2. The method of claim 1, wherein the contacting further comprises contacting the aqueous composition with a plurality of monomers each capable of binding to a protein domain containing first segment or second segment, or to the interface segment in the fusion protein, and wherein the plurality of monomers form a multimer that binds to two, three, or more segments of said fusion protein.

3. The method of claim 1, wherein the first monomer represented by:
X₁—Y₁—Z₁ (Formula I)
and pharmaceutically acceptable salts, stereoisomers, metabolites and hydrates thereof, wherein
X₁ is a first non-peptidyl pharmacophore capable of binding to the first segment;
Y₁ is absent or is a connector moiety covalently bound to X₁ and Z₁;
Z₁ is a first linker capable of binding to the second monomer; and
the second monomer is represented by:
X₂—Y₂—Z₂ (Formula II)
wherein
X₂ is a second non-peptidyl pharmacophore capable of binding to the second segment;
Y₂ is absent or is a connector moiety covalently bound to X₂ and Z₂.
Z₂ is a first linker capable of binding to the first monomer through Z₁;
wherein upon contact with the aqueous composition, said first monomer and said second monomer forms a multimer that binds to the fusion gene product.

4. The method of claim 1, wherein the fusion gene product is an oncology fusion protein.

5. The method of claim 4, wherein the oncology fusion protein is expressed by a fused gene from a chromosomal translocation, inversion, or interstitial deletion.

6. The method of claim 4, wherein the oncology fusion protein comprises a tyrosine kinase domain.

7. The method of claim 4, wherein the oncology fusion protein comprises a phosphorylation motif, a tyrosine kinase domain, and a disordered region.

8. The method of claim 4, wherein the oncology fusion protein comprises an dimerization domain, a tyrosine kinase domain, and a disordered region.

9. The method of claim 4, wherein the oncology fusion protein comprises a DNA binding element, and a transactivator domain.

10. The method of claim 4, wherein X₁ binds to a tyrosine kinase protein domain in a protein selected from the group consisting of ABL1, ABL2, ALK, hepatocyte growth factor receptor, JAK2, JAK3, JAK1, ROS1, PDGFR, NTRK, SYK, BRAF, RET, and fibroblast growth factor receptor.

11. The method of claim 4, wherein X₂ binds to a dimerization domain in a protein selected from the group consisting of protein selected from the group consisting of BCR, NPM, EML4, TPR, TEL, AFT1, EWS, FLI1, MLL, CBP, p300, ENL, FGFR1OP2, ETS, BIRC3, MALT1, FOXO1a, GOPC, PAX, ECPT1, NCOA1, FUS, NUP98, RARA, BRD, AML1, AF9, AF4, ETO, NUT, CEP1, TFE3, WT1, PRCC, CCDC6, KIAA14549, HOX, PML, and RUNX1.

12. The method of claim 4, wherein the oncology fusion protein is selected from the group consisting of BCR-ABL, NPM-ALK, EML4-ALK, TRP-MET, TFG-ALK, TEL-JAK2, EWS-ATF1, MLL-CBP, MLL-ENL, IRC3-MALT1, CD74-ROS1, EWS-ETS, TEL-NTRK3, TEL-RUNX1, FGFR1-ZNF198, FOXO1A-PAX3, GOPC-ROS1, CEP1-FGFR1, NCOA1-PAX3, MLL-p300, MLL-AF9, MLL-AF4, EWS-FLI1, FUS-ATF1, FUS-ERG, BRD-NUT, TFE3-PRCC, AML1-ETO, EWS-WT1, CCDC6-RET, BRAF-KIAA1549, NUP98-HOX, and RARA-PML.

13. The method of claim 10, wherein the oncology fusion protein is BCR-ABL, X₁ binds to a Tyr-kinase phosphorylation motif of BCR, and X₂ binds to a tyr kinase domain of ABL.

14.-19. (canceled)

20. The method of claim 4, wherein the first or second segment of the oncology fusion protein is selected from the group consisting of ABL1, ABL2, ACSL3, ADRBK2, AF15Q14, AF1Q, AF3p21, AF5q31, AKAP9, AKT1, AKT2, ALDH2, ALK, ALO17, APC, ARHGEF12, ARHH, ARID1A, ARNT, ASPSCR1, ASXL1, ATFL, ATIC, ATM, ATRX, BAP1, BCL10, BCL11A, BCL11B, BCL2, BCL3, BCL5, BCL6, BCL7A, BCL9, BCR, BHD, BIRC3, BLM, BMPR1A, BRAF, BRCA1, BRCA2, BRD3, BRD4, BRIP1, BTG1, BUB1B, C11orf95, C12 or 19, C15orf21, C15orf55, C16orf75, CAMTA1, CANT1, CARD11, CARS, CBFA2T1, CBFA2T3, CBFB, CBL, CBLB, CBLC, CCNB11P1, CCND1, CCND2, CCND3, CD273, CD274, CD74, CD79A, CD79B, CDH1, CDH11, CDK4, CDK6, CDKN2A-p16(INK4a), CDKN2A-pl4ARF, CDKN2C, CDX2, CEBPA, CEP1, CEP110, CHCHD7, CHEK2, CHIC2, CHN1, CIC, CIITA, CLTC, CLTCL1, CMKOR1, COL1A1, COPEB, COX⁶C, CREB1, CREB3L1, CREB3L2, CREBBP, CRLF2, CRTC3, CTNNB1, CYLD, D10S170, DAXX, DDB2, DDIT3, DDX10, DDX5, DDX6, DEK, DICER1, DNMT3A, DUX4, EBF1, EGFR, EIF4A2, ELF4, ELK4, ELKS, ELL, ELN, EML4, EP300, EPS15, ERBB2, ERCC2, ERCC3, ERCC4, ERCC5, ERG, ETV1, ETV2, ETV4, ETV5, ETV6, EVI1, EWSR1, EXT1, EXT2, EZH2, FACL6, FAM22, FANCA, FANCC, FANCD2, FANCE, FANCF, FANCG, FBXW7, FCGR2B, FEV, FGFR1, FGFR10P, FGFR2, FGFR3, FH, FHIT, FIP1L1, FKHR, FLI1, FLJ27352, FLT3, FNBP1, FOXL2, FOXO1A, FOXO3A, FOXP1, FSTL3, FUS, FVT1, FWS-CHOP, GAS7, GATA1, GATA2, GATA3, GMPS, GNA11, GNAQ, GNAS, GOLGA5, GOPC, GPC3, GPHN, GRAF, GSDNB, HCMOGT-1, HEAB, HEI10, HERPUD1, HIP1, HIST1H4I, HLF, HLXB9, HMGA1, HMGA2, HNRNPA2B1, HOOK3, HOXA11, HOXA13, HOXA9, HOXC11, HOXC13, HOXD11, HOXD13, HRAS, HRPT2, HSPCA, HSPCB, IDH1, IDH2, IGH@, IGK@, IGL@, IKZFl, IKZF3, IL2, IL21R, IL6ST, IRF4, IRTA1, ITK, JAK1, JAK2, JAK3, JARIDA1, JAZFl, JUN, KCNMA1, KDM5A, KDM5C, KDM6A, KDR, KIAA1524, KIAA1549, KIF5B, KIT, KLK2, KRAS, KTN1, LAF4, LASP1, LCK, LCP1, LCX, LHFP, LIFR, LMO1, LMO2, LPP, LYL1, MADH4, MAF, MAFB, MALT1, MAML2, MAP2K4, MDM2, MDM4, MDS1, MDS2, MECT1, MEN1, MET, MGEA5, MHC2TA, MITF, MKL1, MKL2, MLF1, MLH1, MLL, MLL2, MLL3, MLLT1, MLLT10, MLLT2, MLLT3, MLLT4, MLLT6, MLLT7, MN1, MPL, MSF, MSH2, MSH6, MSI2, MSN, MTCP1, MUC1, MUTYH, MYB, MYC, MYCL1, MYCN, MYD88, MYH11, MYH9, MYST4, NACA, NBS1, NCOA1, NCOA2, NCOA4, NF1, NF2, NFE2L2, NFIB, NFKB2, NIN, NKX2-1, NONO, NOTCH1, NOTCH2, NPM1, NR4A3, NRAS, NSD1, NTRK1, NTRK3, NUMA1, NUP214, NUP98, NUT, OLIG2, OMD, P2RY8, PAFAH1B2, PALB2, PAX3, PAX5, PAX7, PAX8, PBRM1, PBX1, PCM1, PCSK7, PDE4DIP, PDGFB, PDGFRA, PDGFRB, PER1, PHOX2B, PICALM, PIK3CA, PIK3R1, PIM1, PLAG1, PLZF, PML, PMS1, PMS2, PMX1, PNUTL1, POU2AF1, POU5F1, PPARG, PPP2R1A, PRCC, PRDM1, PRDM16, PRF1, PRKAR1A, PRO1073, PSIP2, PTCH, PTEN, PTPN11, RAB5EP, RAD51L1, RAFT, RALGDS, RANBP17, RAP1GDS1, RARA, RB1, RBM15, RECQL4, REL, RET, ROS1, RPL22, RPN1, RUNDC2A, RUNX1, RUNXBP2, SBDS, SDH5, SDHB, SDHC, SDHD, SEPT2, SEPT5, SEPT6, SEPT9, SEPT11, SET, SETD2, SFPQ, SFRS3, SFRS14, SH3GL1, SIL, SLC45A3, SMARCA4, SMARCA5, SMARCB1, SMO, SOCS1, SOX2, SRGAP3, SS18, SS18L1, SSH3BP1, SSX1, SSX2, SSX4, STK11, STL, SUFU, SUZ12, SYK, SYT, TAF15, TAL1, TAL2, TATDN1, TCEA1, TCF1, TCF7L2, TCF12, TCF3, TCL1A, TCL6, TET2, TFE3, TFEB, TFG, TFPT, TFRC, TGFBR3, THRAP3, TIF1, TLS, TLX1, TLX3, TMPRSS2, TNFAIP3, TNFRSF14, TNFRSF17, TNFRSF6, TOP1, TP53, TPM3, TPM4, TPR, TRA@, TRB@, TRD@, TRIM27, TRIM33, TRIP11, TSC1, TSC2, TSHR, TTL, USP6, USP42, VAPB, VHL, VTI1A, WAS, WHSC1, WHSC1L1, WIF1, WRN, WT1, WTX, WWC1, WWTR1, XPA, XPC, YWHAE, ZNF145, ZNF198, ZNF278, ZNF331, ZNF384, ZNF521, ZNF9, and ZNFN1A1.

21. The method of claim 1, where the fusion gene product is selected from the group consisting of: ABL1-BCR, ETV6, NUP214; ABL2-ETV6; ACSL3-ETV1; AF15Q14-MLL; AF1Q-MLL; AF3p21-MLL; AF5q31-MLL; AKAP9-BRAF; ALDH2-HMGA2; ALK-NPM1, TPM3, TFG, TPM4, ATIC, CLTC, MSN, ALO17, CARS, EML4; ALO17-ALK; ARHGEF12-MLL; ARHH-BCL6; ARNT-ETV6; ASPSCR1-TFE3; ATF1-EWSR1, FUS; ATIC-ALK; BCL10-IGH@; BCL11A-IGH@; BCL11B-TLX3; BCL2-IGH@; BCL3-IGH@; BCL5-MYC; BCL6-IG loci, ZNFN1A1, LCP1, PIM1, TFRC, MHC2TA, NACA, HSPCB, HSPCA, HIST1H4I, IL21R, POU2AF1, ARHH, EIF4A2, SFRS3; BCL7A-MYC; BCL9-IGH@, IGL@; BCR-ABL1, FGFR1, JAK2; BIRC3-MALT1; BRAF-AKAP9, KIAA1549; BRD3-NUT, C15orf55; BRD4-NUT, C15orf55; BTG1-MYC; C12orf9-LPP; C15orf21-ETV1; C15orf55-BRD3, BRD4; C16orf75-CIITA; CANT1-ETV4; CARS-ALK; CBFA2T1-MLL, RUNX1; CBFA2T3-RUNX1; CBFB-MYH11; CBL-MLL; CCNB11P1-HMGA2; CCND1-IGH@, FSTL3; CCND2-IGL@; CCND3-IGH@; CD273-CIITA; CD274-CIITA; CD74-ROS1; CDH11-USP6; CDK6-MLLT10; CDX2-ETV6; CEP1-FGFR1; CHCHD7-PLAG1; CHIC2-ETV6; CHN1-TAF15; CIC-DUX4; CIITA-FLJ27352, CD274, CD273, RALGDS, RUNDC2A, C16orf75; CLTC-ALK, TFE3; CMKOR1-HMGA2; COL1A1-PDGFB, USP6; COX6C-HMGA2; CREB1-EWSR1; CREB3L1-FUS; CREB3L2-FUS; CREBBP-MLL, MORF, RUNXBP2; CRLF2-P2RY8, IGH@; CRTC3-MAML2; CTNNB1-PLAG1; D10S170-RET, PDGFRB; DDIT3-FUS; DDX10-NUP98; DDX5-ETV4; DDX6-IGH@; DEK-NUP214; DUX4-CIC; EBF1-HMGA2; EIF4A2-BCL6; ELF4-ERG; ELK4-SLC45A3; ELKS-RET; ELL-MLL; ELN-PAX5; EML4-ALK; EP300-MLL, RUNXBP2; EPS15-MLL; ERG-EWSR1, TMPRSS2, ELF4, FUS, HERPUD1; ETV1-EWSR1, TMPRSS2, SLC45A3, C15orf21, HNRNPA2B1. ACSL3; ETV4-EWSR1, TMPRSS2, DDX5, KLK2, CANT1; ETV5-TMPRSS2, SCL45A3; ETV6-NTRK3, RUNX1, PDGFRB, ABL1, MN1, ABL2, FACL6, CHIC2, ARNT, JAK2, EVI1, CDX2, STL, HLXB9, MDS2, PER1, SYK, TTL, FGFR3, PAX5; EVIL-RUNX1, ETV6, PRDM16, RPN1; EWSR1-FLI1, ERG, ZNF278, NR4A3, FEV, ATFL, ETV1, ETV4, WT1, ZNF384, CREB1, POU5F1, PBX1; FACL6-ETV6; FEV-EWSR1, FUS; FGFR1-BCR, FOP, ZNF198, CEP1; FGFR10P-FGFR1; FGFR3-IGH@, ETV6; FHIT-HMGA2; FIP1L1-PDGFRA; FLI1-EWSR1; FLJ27352-CIITA; FNBP1-MLL; FOXO1A-PAX3; FOXO3A-MLL; FOXP1-PAX5; FSTL3-CCND1; FUS-DDIT3, ERG, FEV, ATF1, CREB3L2, CREB3L1; FVT1-IGK@; GAS7-MLL; GMPS-MLL; GOLGA5-RET; GOPC-ROS1; GPHN-MLL; GRAF-MLL; HCMOGT-1-PDGFRB; HEAB-MLL; HEI10-HMGA2; HERPUD1-ERG; HIP1-PDGFRB; HIST1H4I-BCL6; HLF-TCF3; HLXB9-ETV6; HMGA2-LHFP, RAD51 L1, LPP, HEI10, COX6C, CMKOR1, NFIB, ALDH2, CCNB11P1, EBF1, WIF1, FHIT; HNRNPA2B1-ETV1; HOOK3-RET; HOXA11-NUP98; HOXA13-NUP98; HOXA9-NUP98, MSI2; HOXC11-NUP98; HOXC13-NUP98; HOXD11-NUP98; HOXD13-NUP98; HSPCA-BCL6; HSPCB-BCL6; IGH@-MYC, FGFR3, PAX5, IRTA1, IRF4, CCND1, BCL9, BCL8, BCL6, BCL2, BCL3, BCL10, BCL11A. LHX4, DDX6, NFKB2, PAFAH1B2, PCSK7, CRLF2; IGK@-MYC, FVT1; IGL@-BCL9, MYC, CCND2; IL2-TNFRSF17; IL21R-BCL6; IRF4-IGH@; IRTA1-IGH@; ITK-SYK; JAK2-ETV6, PCM1, BCR; JAZFl-SUZ12; KDM5A-NUP98; KIAA1549-BRAF; KLK2-ETV4; KTN1-RET; LAF4-MLL, RUNX1; LASP1-MLL; LCK-TRB@; LCP1-BCL6; LCX-MLL; LHFP-HMGA2; LIFR-PLAG1; LMO1-TRD@; LMO2-TRD@; LPP-HMGA2, MLL, C12orf9; LYL1-TRB@; MAF-IGH@; MAFB-IGH@; MALT1-BIRC3; MAML2-MECT1, CRTC3; MDS1-RUNX1; MDS2-ETV6; MECT1-MAML2; MHC2TA-BCL6; MKL1-RBM15; MLF1-NPM1; MLL-MLL, MLLT1, MLLT2, MLLT3, MLLT4, MLLT7, MLLT10, MLLT6, ELL, EPS15, AF1Q, CREBBP, SH3GL1, FNBP1, PNUTL1, MSF, GPHN, GMPS, SSH3BP1, ARHGEF12, GAS7, FOXO3A, LAF4, LCX, SEPT6, LPP, CBFA2T1, GRAF, EP300, PICALM, HEAB; MLLT1-MLL; MLLT10-MLL, PICALM, CDK6; MLLT2-MLL; MLLT3-MLL; MLLT4-MLL; MLLT6-MLL; MLLT7-MLL; MN1-ETV6; MSF-MLL; MSI2-HOXA9; MSN-ALK; MTCP1-TRA@; MUC1-IGH@; MYB-NFIB; MYC-IGK@, BCL5, BCL7A, BTG1, TRA@, IGH@; MYH11-CBFB; MYH9-ALK; MYST4-CREBBP; NACA-BCL6; NCOA1-PAX3; NCOA2-RUNXBP2; NCOA4-RET; NFIB-MYB, HGMA2; NFKB2-IGH@; NIN-PDGFRB; NONO-TFE3; NOTCH1-TRB@; NPM1-ALK, RARA, MLF1; NR4A3-EWSR1; NSD1-NUP98; NTRK1-TPM3, TPR, TFG; NTRK3-ETV6; NUMA1-RARA; NUP214-DEK, SET, ABL1; NUP98-HOXA9, NSD1, WHSC1L1, DDX10, TOP1, HOXD13, PMX1, HOXA13, HOXD11, HOXA11, RAP1GDS1, HOXC11; NUT-BRD4, BRD3; OLIG2-TRA@; OMD-USP6; P2RY8-CRLF2; PAFAH1B2-IGH@; PAX3-FOXO1A, NCOA1; PAX5-IGH@, ETV6, PML, FOXP1, ZNF521, ELN; PAX7-FOXO1A; PAX8-PPARG; PBX1-TCF3, EWSR1; PCM1-RET, JAK2; PCSK7-IGH@; PDE4DIP-PDGFRB; PDGFB-COL1A1; PDGFRA-FIP1L1; PDGFRB-ETV6, TRIP11, HIP1, RAB5EP, H4, NIN, HCMOGT-1, PDE4DIP; PER1-ETV6; PICALM-MLLT10, MLL; PIM1-BCL6; PLAG1-TCEA1, LIFR, CTNNB1, CHCHD7; PML-RARA, PAX5; PMX1-NUP98; PNUTL1-MLL; POU2AF1-BCL6; POU5F1-EWSR1; PPARG-PAX8; PRCC-TFE3; PRDM16-EVIL; PRKAR1A-RET; PRO1073-TFEB; PSIP2-NUP98; RAB5EP-PDGFRB; RAD51L1-HMGA2; RAF1-SRGAP3; RALGDS-CIITA; RANBP17-TRD@; RAP1GDS1-NUP98; RARA-PML, ZNF145, TIF1, NUMA1, NPM1; RBM15-MKL1; RET-H4, PRKAR1A, NCOA4, PCM1, GOLGA5, TRIM33, KTN1, TRIM27, HOOK3; ROS1-GOPC, ROS1; RPL22-RUNX1; RPN1-EVIL; RUNDC2A-CIITA; RUNX1-RPL22, MDS1, EVI1, CBFA2T3, CBFA2T1, ETV6, LAF4; RUNXBP2-CREBBP, NCOA2, EP300; SEPT6-MLL; SET-NUP214; SFPQ-TFE3; SFRS3-BCL6; SH3GL1-MLL; SIL-TAL1; SLC45A3-ETV1, ETV5, ELK4, ERG; SRGAP3-RAF1; SS18-SSX1, SSX2; SS18L1-SSX1; SSH3BP1-MLL; SSX1-SS18; SSX2-SS18; SSX4-SS18; STL-ETV6; SUZ12-JAZFl; SYK-ETV6, ITK; TAF15-TEC, CHN1, ZNF384; TAL1-TRD@, SIL; TAL2-TRB@; TCEA1-PLAG1; TCF12-TEC; TCF3-PBX1, HLF, TFPT; TCL1A-TRA@; TCL6-TRA@; TFE3-SFPQ, ASPSCR1, PRCC, NONO, CLTC; TFEB-ALPHA; TFG-NTRK1, ALK; TFPT-TCF3; TFRC-BCL6; THRAP3-USP6; TIF1-RARA; TLX1-TRB@, TRD@; TLX3-BCL11B; TMPRSS2-ERG, ETV1, ETV4, ETV5; TNFRSF17-IL2; TOP1-NUP98; TPM3-NTRK1, ALK; TPM4-ALK; TPR-NTRK1; TRA@-ATL, OLIG2, MYC, TCL1A, TCL6, MTCP1, TCL6; TRB@-HOX11, LCK, NOTCH1, TAL2, LYLl; TRD@-TAL1, HOX11, TLX1, LMO1, LMO2, RANBP17; TRIM27-RET; TRIM33-RET; TRIP11-PDGFRB; TTL-ETV6; USP6-COL1A1, CDH11, ZNF9, OMD; WHSC1-IGH@; WHSC1L1-NUP98; WIF1-HMGA2; WT1-EWSR1; ZNF145-RARA; ZNF198-FGFR1; ZNF278-EWSR1; ZNF384-EWSR1, TAF15; ZNF521-PAX5; ZNF9-USP6; and ZNFN1A1-BCL6.

22.-23. (canceled)

24. The method of claim 3, wherein Z₁ and Z₂ are different.

25. The method of claim 3, wherein Z₁ and Z₂ are represented by a moiety each selected from the group consisting of: 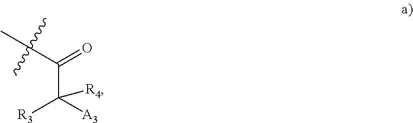
wherein
A₃ is —OH, —SH, or —NHR′;
R₃ is selected from the group consisting of H, halo, C₁₋₄alkyl, C₃₋₆cycloalkyl, and heterocycle, wherein C₁₋₄alkyl, C₃₋₆cycloalkyl, or heterocycle may be optionally substituted by one, two, or three substituents selected from the group consisting of halo, cyano, amino, or hydroxyl; and
R₄ is selected from the group consisting of H, halo, C₁₋₄alkyl, C₃₋₆cycloalkyl, and heterocycle, wherein C₁₋₄alkyl, C₃₋₆cycloalkyl, or heterocycle may be optionally substituted by one, two, or three substituents selected from the group consisting of halo, cyano, amino, or hydroxyl; and 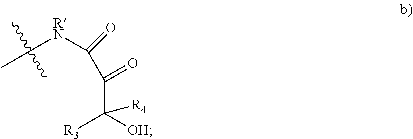
wherein
R′ is selected from C₁₋₄alkyl optionally substituted with hydroxyl; —NH₂; —OH; and C₁₋₄alkoxy;
R₃ is selected from the group consisting of H, halo, C₁₋₄alkyl, C₃₋₆cycloalkyl, and heterocycle, wherein C₁₋₄alkyl, C₃₋₆cycloalkyl, or heterocycle may be optionally substituted by one, two, or three substituents selected from the group consisting of halo, cyano, amino, or hydroxyl; and
R₄ is selected from the group consisting of H, halo, C₁₋₄alkyl, C₃₋₆cycloalkyl, and heterocycle, wherein C₁₋₄alkyl, C₃₋₆cycloalkyl, or heterocycle may be optionally substituted by one, two or three substituents selected from the group consisting of halo, cyano, amino, or hydroxyl′; 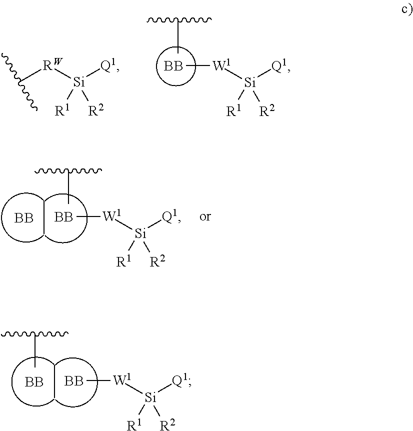
wherein
R^{W} is selected from the group consisting of —C₁₋₄alkyl-, —O—C₁₋₄alkyl-, —C₁₋₄alkyl-O—, —N(R^{a})—, —N(R^{a})—C₁₋₄alkyl-, —O—, —C(O)C₁₋₄alkyl-, —C(O)—O—C₁₋₄ alkyl-, —C(O)—NR^{a}R^{b}—, —C₂₋₆ alkenyl-, —C₂₋₆alkynyl-, —C₃₋₆cycloalkyl-, -phenyl- and -heterocycle-; wherein C₁₋₄alkyl, R^{a}, R^{b}, C₂₋₆alkenyl, C₂₋₆alkynyl, C₃₋₆cycloalkyl, phenyl and heteroaryl may be optionally substituted by one, two, three or more substituents selected from the group consisting of C₁₋₄alkyl, C₁₋₄alkoxy, —C(O)C₁₋₄alkyl, —C(O)—O—C₁₋₄alkyl, —C(O)—NR^{a}R^{b}, halogen, cyano, hydroxyl, phenyl, R^{a} and R^{b};
W¹, independently for each occurrence, is (a) absent; or (b) selected from the group consisting of —O—, —C₁₋₄ alkyl-, —O—C₁₋₄ alkyl-, —C₁₋₄alkyl-O—, —C(O)—C₁₋₄ alkyl-, —N(R^{a})—, —N(R^{a})—C₁₋₄alkyl-, —C(O)—O—C₁₋₄alkyl-, —C(O)—NR′—, —C₂₋₆alkenyl-, —C₂₋₆alkynyl-, —C₃₋₆cycloalkyl-, -phenyl- or -heteroaryl-; wherein C₁₋₄alkyl, C₂₋₆alkenyl, C₂₋₆alkynyl, C₃₋₆cycloalkyl, R′, phenyl and heteroaryl are optionally substituted independently, for each occurrence, with one, two, three or more substituents selected from the group consisting of C₁₋₄alkyl, C₁₋₄alkoxy, —C(O)C₁₋₆alkyl, —C(O)—O—C₁₋₄alkyl, halogen, hydroxyl, nitro and cyano;
R′ is independently selected, for each occurrence, from the group consisting of hydrogen, substituted or unsubstituted aliphatic, and substituted or unsubstituted heteroaliphatic;
Q¹ is independently selected, for each occurrence, from the group consisting of —NHR′, —SH, —OH, —O—C₁₋₆ alkyl, —S—C₁₋₆ alkyl, —O-aryl, —S-aryl, heteroaryl, —O-heteroaryl, —S-heteroaryl, halogen and —O—C₁₋₆alkyl-NR^{a}R^{b};
R^{a} and R^{b} are independently selected, for each occurrence, from the group consisting of hydrogen and C₁₋₄alkyl; wherein C₁₋₄alkyl may be optionally substituted by one or more substituents selected from the group consisting of halogen, cyano, oxo and hydroxyl; or
R^{a} and R^{b}, together with the nitrogen to which they are attached, may form a 4-7 membered heterocyclic ring, which may have an additional heteroatom selected from O, S, or N; wherein the 4-7 membered heterocyclic ring may be optionally substituted by one or more substituents selected from the group consisting of halogen, cyano, oxo and hydroxyl;
R¹ and R² are selected independently, for each occurrence, from the group consisting of —OH, C₁₋₆alkyl, —O—C₁₋₆alkyl, C₂₋₆alkenyl, C₃₋₆cycloalkyl, —C₁₋₆alkyl-NR^{a}R^{b}, phenyl and heteroaryl; wherein C₁₋₆alkyl, C₂₋₆alkenyl, C₃₋₆cycloalkyl, R^{a}, R^{b}, phenyl and heteroaryl, independently selected, for each occurrence, may be optionally substituted by one or more substituents selected from the group consisting of halogen, cyano, hydroxyl, C₁₋₆alkyl, and phenyl;
BB, independently for each occurrence, is a 4-7-membered cycloalkyl, heterocyclic, aryl, or heteroaryl moiety, wherein the cycloalkyl, heterocyclic, aryl, or heteroaryl moiety is optionally substituted with one, two, three or more groups represented by R^{BB}; wherein R′, independently for each occurrence, may be optionally bonded to BB;
each R^{BB} is independently selected, for each occurrence, from the group consisting of hydrogen, halogen, nitro, cyano, hydroxyl, amino, thio, —COOH, —CONHR′, substituted or unsubstituted aliphatic, and substituted or unsubstituted heteroaliphatic; or two R^{BB} together with the atoms to which they are attached form a fused 5- or 6-membered cycloalkyl or heterocyclic bicyclic ring system; and 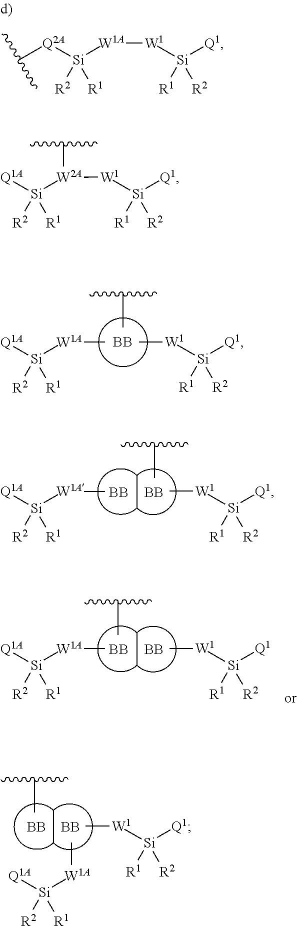
wherein
Q^{2A} is selected from the group consisting of —NH—, —S—, —O—, —O—C₁₋₆alkyl-, —C₁₋₆alkyl-O—, —N(R′)—C₁₋₆ alkyl-, —C₁₋₆alkyl-N(R)—, —S—C₁₋₆alkyl-, —C₁₋₆ alkyl-S— and —O—C₁₋₆alkyl-NR^{a}—
W¹ and W^{1A}, independently for each occurrence, are (a) absent; or (b) selected from the group consisting of —O—, —C₁₋₄alkyl-, —O—C₁₋₄ alkyl-, —C₁₋₄alkyl-O—, —N(R^{a})—, —N(R^{a})—C₁₋₄alkyl-, —C(O)C₁₋₄alkyl-, —C(O)—O—C₁₋₄alkyl-, —C(O)—NR′—, —C₂₋₆alkenyl-, —C₂₋₆alkynyl-, —C₃₋₆cycloalkyl-, -phenyl- and -heteroaryl-; wherein C₁₋₄alkyl, C₂₋₆alkenyl, C₂₋₆alkynyl, C₃₋₆cycloalkyl, R′, phenyl and heteroaryl may be optionally substituted independently, for each occurrence, with one, two, three or more substituents selected from the group consisting of C₁₋₄alkyl, C₁₋₄alkoxy, —C(O)C₁₋₆alkyl, —C(O)—O—C₁₋₄alkyl, halogen, hydroxyl, nitro and cyano;
R′ is independently selected, for each occurrence, from the group consisting of hydrogen, substituted or unsubstituted aliphatic, and substituted or unsubstituted heteroaliphatic;
Q¹ and Q^{1A} are independently selected, for each occurrence, from the group consisting of —NHR′, —SH, —OH, —O—C₁₋₆ alkyl, —S—C₁₋₆alkyl, —O-aryl, —S-aryl, heteroaryl, —O-heteroaryl, —S— heteroaryl, halogen and —O—C₁₋₆alkyl-NR^{a}R^{b};
R^{a} and R^{b} are independently selected, for each occurrence, from the group consisting of hydrogen and C₁₋₄alkyl; wherein C₁₋₄alkyl may be optionally substituted by one or more substituents selected from the group consisting of halogen, cyano, oxo and hydroxyl; or
R^{a} and R^{b}, together with the nitrogen to which they are attached, may form a 4-7 membered heterocyclic ring, which may have an additional heteroatom selected from O, S, or N; wherein the 4-7 membered heterocyclic ring may be optionally substituted by one or more substituents selected from the group consisting of halogen, cyano, oxo and hydroxyl;
R¹ and R² are selected independently, for each occurrence, from the group consisting of —OH, C₁₋₆alkyl, —O—C₁₋₆alkyl, C₂₋₆alkenyl, C₃₋₆cycloalkyl, —C₁₋₆alkyl-NR^{a}R^{b}, phenyl and heteroaryl;
wherein C₁₋₆alkyl, C₂₋₆alkenyl, C₃₋₆cycloalkyl, R^{a}, R^{b}, phenyl and heteroaryl, independently selected, for each occurrence, may be optionally substituted by one or more substituents selected from the group consisting of halogen, cyano, hydroxyl, C₁₋₆alkyl, and phenyl;
W^{2A} is selected from the group consisting of N and CR^{W2A}.
R^{W2A} is selected from the group consisting of hydrogen, C₁₋₄alkyl, —O—C₁₋₄alkyl, C₂₋₆alkenyl, C₂₋₆alkynyl, C₃₋₆cycloalkyl, phenyl and heteroaryl; wherein C₁₋₄alkyl, C₂₋₆alkenyl, C₂₋₆alkynyl, C₃₋₆cycloalkyl, phenyl and heteroaryl may be optionally substituted independently, for each occurrence, with one, two, three or more substituents selected from the group consisting of halogen, hydroxyl and cyano;
BB, independently for each occurrence, is a 4-7-membered cycloalkyl, heterocyclic, aryl, or heteroaryl moiety; wherein the cycloalkyl, heterocyclic, aryl, or heteroaryl moiety may be optionally substituted with one, two, three or more groups represented by R^{BB}; wherein R¹, independently for each occurrence, may be optionally bonded to BB;
each R^{BB} is independently selected, for each occurrence, from the group consisting of hydrogen, halogen, nitro, cyano, hydroxyl, amino, thio, —COOH, —CONHR′, substituted or unsubstituted aliphatic, substituted or unsubstituted heteroaliphatic; or two R^{BB} together with the atoms to which they are attached may form a fused 5- or 6-membered cycloalkyl or heterocyclic bicyclic ring system.

26. The method of claim 3, wherein Z₁ is selected from the group consisting of: 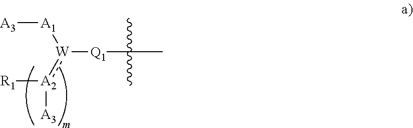
wherein
A₁ is (a) absent; or (b) selected from the group consisting of acyl, substituted or unsubstituted aliphatic, or substituted or unsubstituted heteroaliphatic;
A₂, independently for each occurrence, is (a) absent; or (b) selected from the group consisting of —N—, acyl, substituted or unsubstituted aliphatic, or substituted or unsubstituted heteroaliphatic, provided that at least one of A₁ and A₂ is present; or
A₁ and A₂, together with the atoms to which they are attached, form a substituted or unsubstituted 4-8 membered cycloalkyl or heterocyclic ring;
A₃ is selected from the group consisting of —NHR′, —SH, or —OH;
W is CR′ or N;
R′ is selected from the group consisting of hydrogen, halogen, substituted or unsubstituted aliphatic, substituted or unsubstituted heteroaliphatic, substituted or unsubstituted aryl, substituted or unsubstituted heteroaryl, —NH₂, —NO₂, —SH, or —OH;
m is 1-6; [symbol]
represents a single or double bond; and
R₁ is (a) absent; or (b) selected from the group consisting of hydrogen, halogen, substituted or unsubstituted aliphatic, or substituted or unsubstituted heteroaliphatic, substituted or unsubstituted aryl, substituted or unsubstituted heteroaryl, —NH₂, —NO₂, —SH, or —OH;
Q₁ is (a) absent; or (b) selected from the group consisting of substituted or unsubstituted aliphatic or substituted or unsubstituted heteroaliphatic; or
R₁ and Q₁ together with the atoms to which they are attached form a substituted or unsubstituted 4-8 membered cycloalkyl or heterocyclic ring; 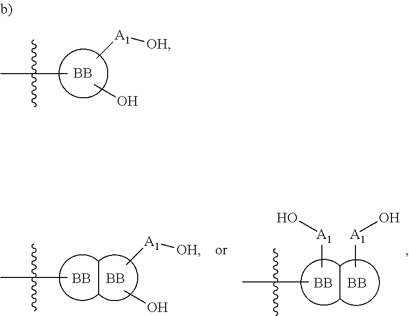
wherein
BB, independently for each occurrence, is a 4-8 membered cycloalkyl, heterocyclic, aryl, or heteroaryl moiety, wherein the cycloalkyl, heterocyclic, aryl, or heteroaryl moiety is optionally substituted with one or more groups represented by R₂, wherein the two substituents comprising —OH have a 1, 2 or 1,3 configuration;
each R₂ is independently selected from hydrogen, halogen, oxo, sulfonate, —NO₂, —CN, —OH, —NH₂₅—SH, —COOH, —CONHR′, substituted or unsubstituted aliphatic, substituted or unsubstituted heteroaliphatic, or two R₂ together with the atoms to which they are attached form a fused substituted or unsubstituted 4-6 membered cycloalkyl or heterocyclic bicyclic ring system;
A₁, independently for each occurrence, is (a) absent; or (b) selected from the group consisting of acyl, substituted or unsubstituted aliphatic, or substituted or unsubstituted heteroaliphatic;
R′ is selected from the group consisting of hydrogen, halogen, substituted or unsubstituted aliphatic, substituted or unsubstituted heteroaliphatic, substituted or unsubstituted aryl, substituted or unsubstituted heteroaryl, —NH₂, —NO₂, —SH, or —OH; 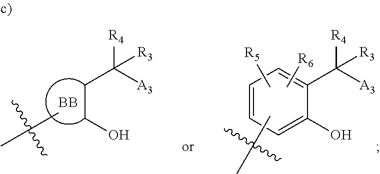
wherein
BB is a substituted or unsubstituted 5- or 6-membered cycloalkyl, heterocyclic, aryl, or heteroaryl moiety;
A₃, independently for each occurrence, is selected from the group consisting of —NHR′ or —OH;
R₃ and R₄ are independently selected from the group consisting of H, C₁₋₄alkyl, phenyl, or R₃ and R₄ taken together from a 3-6 membered ring;
R₅ and R₆ are independently selected from the group consisting of H, C₁₋₄alkyl optionally substituted by hydroxyl, amino, halogen, or thio; C₁₋₄alkoxy; halogen; —OH; —CN; —COOH; —CONHR′; or R₅ and R₆ taken together form phenyl or a 4-6 membered heterocycle; and
R′ is selected from the group consisting of hydrogen, halogen, substituted or unsubstituted aliphatic, substituted or unsubstituted heteroaliphatic, substituted or unsubstituted aryl, substituted or unsubstituted heteroaryl, —NH₂, —NO₂, —SH, or —OH; 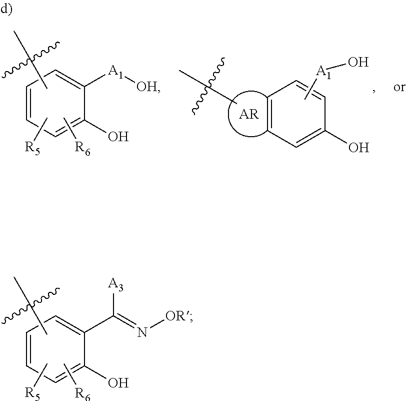
wherein
A₁ is (a) absent; or (b) selected from the group consisting of acyl, substituted or unsubstituted aliphatic, or substituted or unsubstituted heteroaliphatic;
A₃, independently for each occurrence, is selected from the group consisting of —NHR′ or —OH;
AR is a fused phenyl or 4-7 membered aromatic or partially aromatic heterocyclic ring, wherein AR is optionally substituted by oxo, C₁₋₄alkyl optionally substituted by hydroxyl, amino, halo, or thio; C₁₋₄alkoxy; —S—C₁₋₄alkyl; halogen; —OH; —CN; —COOH; —CONHR′; wherein the two substituents comprising —OH are ortho to each other;
R₅ and R₆ are independently selected from the group consisting of H, C₁₋₄alkyl optionally substituted by hydroxyl, amino, halo, or thio; C₁₋₄alkoxy; halogen; —OH; —CN; —COOH; CONHR′; and
R′ is selected from the group consisting of hydrogen, halogen, substituted or unsubstituted aliphatic, substituted or unsubstituted heteroaliphatic, substituted or unsubstituted aryl, substituted or unsubstituted heteroaryl, —NH₂, —NO₂, —SH, or —OH; 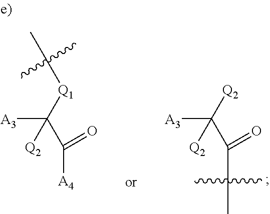
wherein
Q₁ is selected from the group consisting of C₁₋₄alkyl, alkylene, or a bond; C₁₋₆cycloalkyl; a 5-6 membered heterocyclic ring; or phenyl;
Q₂, independently for each occurrence, is selected from the group consisting of H, C₁₋₄alkyl, alkylene, or a bond; C₁₋₆cycloalkyl; a 5-6 membered heterocyclic ring; phenyl; substituted or unsubstituted aliphatic; substituted or unsubstituted heteroaliphatic; substituted or unsubstituted aryl; or substituted or unsubstituted heteroaryl;
A₃, independently for each occurrence, is selected from the group consisting of —NH₂ or —OH;
A₄, independently for each occurrence, is selected from the group consisting of —NH—NH₂; —NHOH, —NH—OR″, or —OH;
R″ is selected from the group consisting of H or C₁₋₄alkyl; and 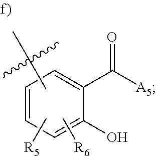
wherein
A₅ is selected from the group consisting of —OH, —NH₂, —SH, —NHR′″; R′″ is selected from —NH₂; —OH; and C₁₋₄alkoxy;
R₅ and R₆ are independently selected from the group consisting of H, C₁₋₄alkyl optionally substituted by hydroxyl, amino, halo, or thio; C₁₋₄alkoxy; halogen; —OH; —CN; —COOH; —CONHR′; or R₅ and R₆ taken together may form a 5-6 membered ring; and Z² a boronic acid or oxaborole moiety capable of binding with the Z¹ moiety of Formula I to form the multimer.

27. A method of treating a hematologic malignancy in a patient in need thereof comprising:
administering to said patient a first monomer and a second monomer, wherein the first monomer is represented by:
X₁—Y₁—Z₁ (Formula I)
and pharmaceutically acceptable salts, stereoisomers, metabolites and hydrates thereof, wherein
X₁ is a first non-peptidyl pharmacophore capable of binding to a first target protein segment on the N-terminal portion of an oncology fusion protein;
Y₁ is absent or is a connector moiety covalently bound to X₁ and Z₁;
Z₁ is a first linker capable of binding to a second monomer; and
the second monomer is represented by:
X₂—Y₂—Z₂ (Formula II)
wherein
X₂ is a second non-peptidyl pharmacophore capable of binding to a second target protein segment on the C-terminal portion of an oncology fusion protein;
Y₂ is absent or is a connector moiety covalently bound to X₂ and Z₂
Z₂ is a first linker capable of binding to the first monomer through Z₁;
wherein upon administration, said first monomer and said second monomer forms a multimer in vivo that binds to the first target protein domain and the second target protein domain.

28.-53. (canceled)

54. A first monomer, a second monomer and bridge monomer capable of forming a biologically useful multimer having at least three segments when the first monomer is in contact with the bridge monomer and when the bridge monomer is in contact with the second monomer in an aqueous media, wherein the first monomer is represented by:
X₁—Y₁—Z₁ (Formula I)
and pharmaceutically acceptable salts, stereoisomers, metabolites and hydrates thereof, wherein
X₁ is a first non-peptidyl pharmacophore;
Y₁ is absent or is a connector moiety covalently bound to X₁ and Z₁;
Z₁ is a first linker capable of binding to the bridge monomer;
the bridge monomer is represented by:
W₁—Y₃—W₂ (Formula II)
wherein
W₁ is a second linker capable of binding to the first monomer through the Z₁ segment;
Y₃ is absent or is a connector moiety covalently bound to W₁ and W₂.
W₂ is a third linker capable of binding to the second monomer; and
the second monomer is represented by:
X₂—Y₂—Z₂ (Formula II)
wherein
X₂ is a second non-peptidyl pharmacophore;
Y₂ is absent or is a connector moiety covalently bound to X₂ and Z₂.
Z₂ is a fourth linker capable of binding to the bridge monomer through W₂; and
wherein upon contact with the aqueous composition, said first monomer, second monomer and bridge monomer all form a multimer and bind to a target biomolecule or biomolecules.

55.-57. (canceled)
